(19) United States
(12) Patent Application Publication
(10) Pub. No.: US 2009/0222867 A1
(43) Pub. Date: Sep. 3, 2009

(54) Broadcast receiving apparatus, video storing apparatus, and multimedia delivering system

(76) Inventor: Toshihiko Munetsugu, Osaka (JP)

Correspondence Address: GREENBLUM & BERNSTEIN, P.L.C., 1950 ROLAND CLARKE PLACE, RESTON, VA, 20191, US

(21) Appl. No.: 11/990,344

(22) PCT Filed: Nov. 30, 2006
(86) PCT No.: PCT/JP2006/324014

§ 371 Date: Feb. 12, 2008

(30) Foreign Application Priority Data
Dec. 22, 2005 (JP) 2005-370923
Dec. 22, 2005 (JP) 2005-370924

(51) Int. Cl. H04N 7/173

(52) U.S. Cl. 725/100; 725/134

(57) ABSTRACT

An apparatus is provided which supplies cached data in a house which does not require a large-space storage device, is a broadcast receiving apparatus that is connected to a network and that receives multimedia data including at least one of video and audio, from a device installed in a broadcast station. The apparatus includes a data receiving unit that receives the multimedia data from the device installed in the broadcast station, a selecting unit that selects one of the video storing apparatuses each of which stores multimedia data, an information communicating unit that transmits a request for storing multimedia data to the video storing apparatus selected by the selecting unit, and a data output unit that outputs the multimedia data received by the data receiving unit to the video storing apparatus selected by the selecting unit via the network.

### TECHNICAL FIELD

The present invention relates to a use of an apparatus connected to a home network for a digital broadcast and for a Video On Demand (VoD) service that are provided from a cable television and the like.

### BACKGROUND ART

In recent years, digital broadcasting such as BS digital broadcasting, CS 110-degree digital broadcasting, and digital terrestrial broadcasting has commenced. Furthermore, HDD recorders, Digital Versatile Disc (DVD) recorders, and the like are becoming widely available. With these, digitalized multimedia contents that can be used in households are increasing.

Meanwhile, with the development of the broadband environment, internet access from households is becoming widespread. Accordingly, the spread of the so-called home network, in which rooms in a house are connected by an IP network, is also advancing.

With the spread of digital contents and home networks, a digital broadcast received by a digital broadcast receiving apparatus in a house or a digital content stored in a recorder has been viewed in another room, using a home network.

Furthermore, the cable television and the like provides the VoD service with which a particular content, such as a movie, can always be viewed according to a request from a user. In the VoD service, a user operates a Set Top Box that is a receiving terminal and selects a content provided by the VoD service so as to request the cable broadcaster to transmit data of the content. In recent years, the contents provided by the VoD service are the aforementioned digital contents. Thus, needs have grown in which the VoD service is used by plural terminal apparatuses connected to a home network.

In the VoD service provided by the cable television, it is necessary to communicate multimedia data besides a broadcast, and thus to provide a bandwidth for communicating the multimedia data between broadcast facilities and each house.

Furthermore, since there are possibilities that a large volume of requests occur concurrently at the broadcast facilities side, it is necessary to provide a system that can handle the processing load.

In order to support these situations, a process known as data caching is conventionally performed for temporarily storing multimedia data provided from the VoD service, in a transmitting apparatus of a broadcast station or in a storage device set in a house. Using the stored multimedia data, the bandwidth consumption and the processing load have been reduced (for example, refer to Patent Document 1).

Furthermore, a broadcast known as a Near VoD service has been performed through a cable television network, a satellite broadcast network, or the like. The Near VoD service is to broadcast a TV-program, such as a movie program, for several times at slightly different times, so that the user can view the program at his/her convenient time. Since the Near VoD service provides a service close to that of the VoD service, it is referred to as the “Near VoD service”.

The multimedia data used in a digital broadcast is coded data referred to as Motion Picture Expert Group Phase2 Transport Stream (MPEG2-TS). Plural TV-programs can be concurrently stored in one MPEG2-TS. A broadcast receiving apparatus has a structure of extracting data related to one TV-program from the one MPEG2-TS, and reproduces the data. Plural MPEG2-Transport Streams that are further allocated for each frequency are transmitted in digital broadcasting. Then, a tuner of the broadcast receiving apparatus has a structure of extracting one MPEG2-Transport Stream by tuning the frequency, taking a predetermined TV-program out of the stream, and reproducing the program.

It becomes possible to concurrently view a TV-program by plural broadcast receiving apparatuses, using a home network. However, since generally, an inexpensive broadcast receiving apparatus is not equipped with a tuner, the user can obtain, via a network, and view the multimedia data received only by the broadcast receiving apparatus including a tuner. When it is desired to concurrently view another TV-program from plural terminals and the TV-program is stored in another MPEG-TS, it is not possible to receive the data using one tuner. Thus, even in a Near VoD service, the user sometimes can not view the data at his/her convenient time. Conventionally, tuners as many as the number of terminals are provided as a way to prevent such a case.

Furthermore, as described above, in the VoD service provided by the cable television, it is necessary to communicate multimedia data besides a broadcast, and to reduce a bandwidth for communicating between the broadcast facilities and each house. For this, a process known as data caching has been performed by providing a storage device in a broadcast transmitting apparatus, for temporarily storing, in the storage device, multimedia data provided from the VoD service. It is conceivable to use the process in the Near VoD service as a way to prevent the aforementioned case (for example, refer to Patent Document 1). Patent Document 1: Japanese Unexamined Patent Application Publication (Translation of PCT Application) No. 2002.540684

### DISCLOSURE OF INVENTION

### Problem that Invention is to Solve

However, in the aforementioned conventional technique, since multimedia data and supply processing on the data are concentrated on a single device, there is a problem that the cost on the device increases.

First, although data caching is performed, in the VoD service, on multimedia data by a broadcast station or by a storage device set in a broadcast station, with the spread of home networks, multiple types of contents are concurrently required in an environment in which plural VoD services are performed in a house.

In this case, in order to reduce the bandwidth consumption between the broadcast facilities and each house, it is necessary to provide a storage device having a large space in which multiple data are cached in each house, which increases the cost. Furthermore, since a cache memory device in a house functions as a server in a home network, a high-performance device for concurrently supplying data to plural terminals as a server is required, which increases the cost.

Furthermore, when tuners as many as the number of terminals are provided in the Near VoD service, it increases the cost.

Furthermore, with the spread of home networks, multiple types of contents are required in each house, in an environment in which plural TV-programs are concurrently viewed. In this case, in the conventional technique in which multimedia data caching is performed in a storage device set in a broadcast receiving apparatus, a storage device having a capacity large enough to cache multiple TV-programs in a house is required as required in a VoD service, which increases the cost. Furthermore, since a cache memory device in a house functions as a server in a home network, a high-performance device for concurrently supplying data to plural terminals as a server is required, which increases the cost.

The present invention is for solving the aforementioned problem, and the object of the present invention is to provide a broadcast receiving apparatus, a video storing apparatus, and a multimedia delivering system each of which can reduce bandwidth consumption between the broadcast facilities and each house and loads in each device, by appropriately distributing data to be cached using plural video storing apparatuses connected to home networks.

### Means to Solve the Problem

In order to solve the aforementioned problem, the broadcast receiving apparatus according to the present invention is a broadcast receiving apparatus that is connected to a network and that receives multimedia data from a device installed in a broadcast station, the multimedia data including at least one of video and audio, and includes: a data receiving unit that receives the multimedia data from the device installed in the broadcast station; an information communicating unit that communicates, via the network, with plural video storing apparatuses each of which stores multimedia data; a selecting unit that selects one of the video storing apparatuses; and a data output unit that outputs, via the network, the multimedia data received by the data receiving unit, wherein the information communicating unit transmits, to the video storing apparatus selected by the selecting unit, a request for storing the multimedia data, and the data output unit outputs, to the video storing apparatus selected by the selecting unit, the multimedia data received by the data receiving unit.

With this configuration, when receiving multimedia data from the device installed in the broadcast station, it is possible to distribute data to be cached by selecting a video storing apparatus that caches the data.

Preferably, the selecting unit selects a video storing apparatus based on attributes of the multimedia data. An attribute of multimedia data is, for example, a genre of a content of multimedia data. Furthermore, an attribute of multimedia data may be a data amount of multimedia data, or time for which the multimedia data is to be broadcast.

With this configuration, it becomes possible to distribute data under more appropriate conditions, by distributing data to be cached based on such attribute of multimedia data. Furthermore, it is preferable that the information communicating unit further receives attributes of the video storing apparatus connected to the network, and the selecting unit selects the video storing apparatus based on the attributes of the video storing apparatus received by the information communicating unit. An attribute of a video storing apparatus is, for example, use frequency information indicating a frequency with which the video storing apparatus is used. Furthermore, an attribute of a video storing apparatus may be a genre associated with the video storing apparatus, a free space of a storage medium provided with the video storing apparatus, or the like.

With this configuration, for example, it becomes possible to cause each video storing apparatus to evenly cache data, and to distribute data under more appropriate conditions. Furthermore, it is preferable that the information communicating unit further receives attributes of the video storing apparatus connected to the network, and the selecting unit selects the video storing apparatus based on the attribute of the video storing apparatus received by the information communicating unit and the attribute of the multimedia data. The attribute of the multimedia data and the attribute of the video storing apparatus are, for example, use frequency information indicating a frequency with which a genre of a content of the multimedia data is used and a frequency with which each of the video storing apparatuses per genre is used.

With this configuration, for example, it becomes possible to perform control, such as causing a video storing apparatus, having a high use frequency of movies, to cache data, in the case where certain multimedia data is a movie. Thus, it becomes possible to distribute data to be cached, in consideration of load distribution when using the multimedia data and bandwidth consumption of a network.

Further, it is preferable that the broadcast receiving apparatus further includes: a storage unit that stores multimedia data; and a writing unit that writes data in the storage unit, wherein the selecting unit selects one of the storage unit and the plural video storing apparatuses connected to the network, and the writing unit writes the multimedia data in the storage unit, when the selecting unit selects the storage unit.

With this configuration, it becomes possible to distribute data to be cached to apparatuses including the broadcast receiving apparatus.

Furthermore, it is preferable that the broadcast receiving apparatus further includes a Java execution unit that executes a Java application program, the Java (trademark) execution unit outputs an identifier of multimedia data, the data receiving unit accepts the identifier of the multimedia data, and the selecting unit selects the video storing apparatus upon accepting the identifier of the multimedia data.

With this configuration, when the video storing apparatus that executes the Java application program receives multimedia data from the broadcast station, it becomes possible to distribute data to be cached by selecting a video storing apparatus that caches the data. Furthermore, the selecting unit may select a video storing apparatus that caches data based on attributes of the received multimedia data that includes at least one of a genre, a data amount of multimedia data, and time for which the multimedia data is to be broadcast.

Preferably, the selecting unit selects a video storing apparatus based on attributes of the multimedia data. An attribute of multimedia data includes, for example, at least one of a genre of a content of multimedia data, a data amount of the multimedia data, and time for which the multimedia data is to be broadcast.

With this configuration, it becomes possible to distribute data under more appropriate conditions, by distributing data to be cached based on such attributes of multimedia data.

With this configuration, it becomes possible to distribute data under more appropriate conditions, by issuing a request through the Java application program and distributing data to be cached according to a type of multimedia data and the like.

Furthermore, it is preferable that the information communicating unit further receives attributes of the video storing apparatus connected to the network, and the selecting unit selects the video storing apparatus based on the attributes of the video storing apparatus received by the information communicating unit. An attribute of a video storing apparatus is, for example, use frequency information indicating a frequency with which the video storing apparatus is used. Furthermore, an attribute of a video storing apparatus may be a genre associated with the video storing apparatus.

With this configuration, for example, it becomes possible to cause each video storing apparatus to evenly cache data, and to distribute data under more appropriate conditions.

Furthermore, it is preferable that the information communicating unit further receives attributes of the video storing apparatus connected to the network, and the selecting unit selects the video storing apparatus based on the attributes of the video storing apparatus received by the information communicating unit and the attribute of the multimedia data.

With this configuration, for example, it becomes possible to perform control, such as causing a video storing apparatus, having a high use frequency of movies, to cache data, in the case where certain multimedia data is a movie. Thus, it becomes possible to distribute data to be cached, in consideration of load distribution when using the multimedia data and bandwidth consumption of a network.

Furthermore, it is preferable that the broadcast receiving apparatus further includes a storage unit that stores multimedia data, and a writing unit that writes data in the storage unit, wherein the selecting unit selects one of the storage unit and the plural video storing apparatuses connected to the network, and the writing unit writes the multimedia data in the storage unit, when the selecting unit selects the storage unit.

With this configuration, it becomes possible to distribute data to be cached to apparatuses including the broadcast receiving apparatus.

In order to solve the aforementioned problem, the video storing apparatus according to the present invention is a video storing apparatus which is connected, via a network, to a broadcast receiving apparatus that receives multimedia data from a broadcast station, and which stores the multimedia data, the multimedia data including at least one of video and audio, and the video storing apparatus includes: a Java execution unit that executes a Java application program; a storage unit that stores the multimedia data; an information communicating unit that communicates with a server connected via the network; a data receiving unit that receives the multimedia data from the broadcast receiving apparatus via the network; a data transmitting unit that transmits the multimedia data to an other video storing apparatus, via the network, wherein the information communicating unit obtains attribute information indicating attributes of the video storing apparatus, from the Java execution unit, when accepting an inquiry of the attributes from the server, and transmits the obtained attribute information to the server, and the data receiving unit stores the received multimedia data in the storage unit, when receiving a storage request from the server and receiving the multimedia data from the broadcast receiving apparatus, and the data transmitting unit transmits the multimedia data to the other video storing apparatus indicated by the information, when receiving, from the server, a request for transmitting the multimedia data stored in the storage unit and information indicating the other video storing apparatus to be a transmission destination.

With this configuration, it is possible that the video storing apparatus that executes the Java application program performs caching on the multimedia data in response to a request from the broadcast receiving apparatus, and transmits the multimedia data appropriately when using the cached multimedia data.

It is preferable that the video storing apparatus further includes a right processing unit that performs right processing following use of the multimedia data, when the information communicating unit receives a request for transmitting the multimedia data.

With this configuration, when using the cached multimedia content, it is possible to appropriately perform the right processing including billing processing.

Furthermore, in order to solve the aforementioned problem, the video storing apparatus according to the present invention is a reception terminal which is connected to the network and which receives the multimedia data from the device installed in the broadcast station, the broadcast station providing a Video On Demand (VoD) service, and the multimedia data including at least one of video and audio, and the video storing apparatus further includes: a request transmitting unit that transmits, to the device installed in the broadcast station, a request for transmitting multimedia data; and an information communicating unit that communicates with the video storing apparatus that stores the multimedia data, via the network. When the information communicating unit receives a request of the VoD service from a terminal operated by a user, the information communicating unit obtains information indicating whether or not the video storing apparatus stores the multimedia data requested in the VoD service, by communicating with the video storing apparatus via the network. When the information communicating unit obtains the information indicating that the video storing apparatus stores the multimedia data, the information communicating uriit transmits, to the video storing apparatus that has transmitted the information, a request for transmitting the multimedia data requested in the VoD service, and when the information communicating unit obtains information indicating that the video storing apparatus does not store the multimedia data, the request transmitting unit: transmits, to the device installed in the broadcast station, a request for transmitting the multimedia data requested in the VoD service.

With this configuration, it becomes possible to efficiently use the data cached to the video storing apparatus connected to the network, and to eliminate the bandwidth consumption caused by unnecessary communication with the broadcast station.

It is preferable that the broadcast receiving apparatus further includes a right processing unit that performs right processing following use of the multimedia data, when the request transmitting unit transmits a request for transmitting the multimedia data stored in the video storing apparatus.

With this configuration, when using the cached multimedia content, it is possible to appropriately perform the right processing including billing processing.

Furthermore, it is preferable that the broadcast receiving apparatus further includes: a Java execution unit that executes a Java application program; a request transmitting unit that transmits, to a device installed in a broadcast station, a request for transmitting multimedia data; an information communicating unit that communicates, via the network, with a video storing apparatus which stores multimedia data, wherein the information communicating unit obtains information indicating whether or not the video storing apparatus stores the multimedia data requested in the VoD service by communicating with the video storing apparatus via the network, when the Java execution unit accepts an identifier of a content.

With this configuration, when the video storing apparatus that executes the Java application program uses the VoD service, it becomes possible to efficiently use the data cached in the video storing apparatus connected to the network, and to eliminate the bandwidth consumption caused by unnecessary communication with the broadcast station.

It is preferable that the broadcast receiving apparatus further includes a right processing unit that performs right processing following use of the multimedia data, when the request transmitting unit transmits a request for transmitting the multimedia data stored in the video storing apparatus.

With this configuration, when using the cached multimedia content, it is possible to appropriately perform the right processing including billing processing.

Note that the present invention can be implemented not only as such a broadcast receiving apparatus, a video storing apparatus, and a reception terminal, but also as a method having the characteristic units included in the aforementioned broadcast receiving apparatus, video storing apparatus, and reception terminal as steps, and as a program which causes a computer to execute such steps, as a characteristic means included in the aforementioned broadcast receiving apparatus, video storing apparatus, and reception terminal. In addition, it is obvious that such program can be distributed via a recording medium, such as a CD-ROM and via a communication network, such as the Internet.

Furthermore, the present invention can be implemented as a multimedia delivering system including plural apparatuses that are the combination of the broadcast receiving apparatus, video storing apparatus, and reception terminal each having the aforementioned characteristic units.

### EFFECTS OF THE INVENTION

As described above, in the multimedia delivering system, or the broadcast receiving apparatus and the video storing apparatus according to the present invention, it is possible to cache much multimedia data provided from a VoD service, a Near VoD service, or the like, by optimally distributing the multimedia data to plural storage units in a house, and to respond to a request of a VoD service issued concurrently from plural terminals so as not to wastefully consume the bandwidth between broadcast facilities and each house. Furthermore, even when the multimedia data is cached data, it becomes possible to appropriately perform right processing including billing.

### BRIEF DESCRIPTION OF DRAWINGS

FIG. 1 is a configuration diagram for the multimedia delivering system in the first embodiment of the present invention.

FIG. 2 is a block diagram showing the configuration of the broadcast receiving apparatus according to the first embodiment of the present invention.

FIG. 3 is a block diagram showing the configuration of the video storing apparatus according to the first embodiment of the present invention.

FIG. 4 is a flowchart showing an example of processing executed by the selecting unit of the broadcast receiving apparatus according to the first embodiment of the present invention.

FIG. 5 is a block diagram showing the configuration of the broadcast receiving apparatus in the variation of the first embodiment of the present invention.

FIG. 6 is a diagram showing the configuration of the broadcast receiving apparatus according to the second embodiment of the present invention.

FIG. 7 is a diagram showing an example of an external view in the case where the input unit is made up of a front panel.

FIG. 8 is a structure diagram of a program to be held and executed by the broadcast receiving apparatus according to the second embodiment of the present invention.

FIG. 9(a) is a diagram showing the first example of an on-screen display according to the present invention. FIG. 9(b) is a diagram showing the second example of an on-screen display according to the present invention.

FIG. 10 is a diagram showing an example of TV-program information stored in the second memory according to the second embodiment of the present invention.

FIG. 11 is a diagram showing an example of channel information stored in the second memory according to the second embodiment of the present invention.

FIG. 12(a) is a diagram showing the first example of information indicating an identifier of a channel stored in the second memory according to the second embodiment of the present invention. FIG. 12(b) is a diagram showing the second example of information indicating an identifier of a channel stored in the second memory according to the second embodiment of the present invention. FIG. 12(c) is a diagram showing the third example of information indicating an identifier of a channel stored in the second memory according to the second embodiment of the present invention.

FIG. 13 schematically shows an example of the collected PAT information according to the second embodiment of the present invention.

FIG. 14 schematically shows an example of the collected PMT information according to the second embodiment of the present invention.

FIG. 15 schematically shows an example of the collected AIT information according to the second embodiment of the present invention.

FIG. 16 shows an example of a downloaded file system according to the second embodiment of the present invention.

FIG. 17 is a block diagram showing an example of an internal configuration of the network library according to the second embodiment of the present invention.

FIG. 18 is a diagram showing an example of a Java API provided by the control unit according to the second embodiment of the present invention.

FIG. 19 shows an example of the structure of a NetDevice class.

FIG. 20 shows an example of the structure of the DevAttrib class.

FIG. 21 is a diagram showing an example of a Java API provided by the data receiving unit according to the second embodiment of the present invention.

FIG. 22 is a diagram showing an example of a Java API provided by the information communicating unit according to the second embodiment of the present invention.

FIG. 23 is a diagram showing an example of an MMRequest class used for the network library according to the second embodiment of the present invention.

FIG. 24 is a diagram showing an example of a Java API provided by the selecting unit according to the second embodiment of the present invention.

FIG. 25 is a diagram showing an example of a Java API provided by the data output unit according to the second embodiment of the present invention.

FIG. 26 is a diagram showing an example of a Java API provided by the request transmitting unit according to the second embodiment of the present invention.

FIG. 27 shows an example of a Java API provided by the right processing unit according to the second embodiment of the present invention.

FIG. 28 is a diagram showing the configuration of the video storing apparatus according to the second embodiment of the present invention.

FIG. 29 is a structure diagram of a program to be held and executed by the video storing apparatus according to the second embodiment of the present invention.

FIG. 30 is a block diagram showing an example of an internal configuration of the network library according to the second embodiment of the present invention.

FIG. 31 shows an example of a Java API provided by the control unit included in the internal configuration of the network library according to the second embodiment of the present invention.

FIG. 32 is a diagram showing the structure of a ContentInfo class used for the network library according to the second embodiment of the present invention.

FIG. 33 shows an example of a Java API provided by the control information communicating unit included in the internal configuration of the network library according to the second embodiment of the present invention.

FIG. 34 shows an example of a Java API provided by the data receiving unit included in the internal configuration of the network library according to the second embodiment of the present invention.

FIG. 35 is a diagram showing an example of a RemoteProgram class used for the network library according to the second embodiment of the present invention.

FIG. 36 shows an example of a Java API provided by the data transmitting unit included in the internal configuration of the network library according to the second embodiment of the present invention.

FIG. 37 shows an example of a Java API provided by the attribute management unit included in the internal configuration of the network library according to the second embodiment of the present invention.

FIG. 38 shows an example of a Java API provided by the right processing unit included in the internal configuration of the network library according to the second embodiment of the present invention.

FIG. 39 is a configuration diagram for the multimedia delivering system in the third embodiment of the present invention.

FIG. 40 is a block diagram showing the configuration of the broadcast receiving apparatus according to the third embodiment of the present invention.

FIG. 41 is a block diagram showing the configuration of the video storing apparatus according to the third embodiment of the present invention.

FIG. 42 is a block diagram showing the configuration of the broadcast receiving apparatus in the variation of the third embodiment of the present invention.

FIG. 43 is a diagram showing the configuration of the broadcast receiving apparatus according to the fourth embodiment of the present invention.

FIG. 44 is a diagram showing an example of an external view in the case where the input unit is made up of a front panel according to the fourth embodiment of the present invention.

FIG. 45 is a structure diagram of a program to be held and executed by the broadcast receiving apparatus according to the fourth embodiment of the present invention.

FIG. 46(a) is a diagram showing the first example of an on-screen display according to the fourth embodiment of the present invention. FIG. 46(b) is a diagram showing the second example of an on-screen display according to the fourth embodiment of the present invention.

FIG. 47 is a diagram showing an example of TV-program information stored in the second memory according to the fourth embodiment of the present invention.

FIG. 48 is a diagram showing an example of channel information stored in the second memory according to the fourth embodiment of the present invention.

FIG. 49(a) is a diagram showing the first example of information indicating an identifier of a channel stored in the second memory according to the fourth embodiment of the present invention. FIG. 49(b) is a diagram showing the second example of information indicating an identifier of a channel stored in the second memory according to the fourth embodiment of the present invention. FIG. 49(c) is a diagram showing the third example of information indicating an identifier of a channel stored in the second memory according to the fourth embodiment of the present invention.

FIG. 50 schematically shows an example of the collected PAT information according to the fourth embodiment of the present invention.

FIG. 51 schematically shows an example of the collected PMT information according to the fourth embodiment of the present invention.

FIG. 52 schematically shows an example of the collected AIT information according to the fourth embodiment of the present invention.

FIG. 53 shows an example of a downloaded file system according to the fourth embodiment of the present invention.

FIG. 54 is a block diagram showing an example of an internal configuration of the network library according to the fourth embodiment of the present invention.

FIG. 55 is a diagram showing an example of a Java API provided by the control unit according to the fourth embodiment of the present invention.

FIG. 56 shows an example of the structure of a NetDevice class according to the fourth embodiment of the present invention.

FIG. 57 shows an example of the structure of a DevAttrib class according to the fourth embodiment of the present invention.

FIG. 58 is a diagram showing an example of a Java API provided by the data receiving unit according to the fourth embodiment of the present invention.

FIG. 59 is a diagram showing an example of a Java API provided by the information communicating unit according to the fourth embodiment of the present invention.

FIG. 60 is a structure diagram of an MMRequest class according to the fourth embodiment of the present invention.

FIG. 61 is a diagram showing an example of a Java API provided by the selecting unit according to the fourth embodiment of the present invention.

FIG. 62 is a diagram showing an example of a Java API provided by the data output unit according to the fourth embodiment of the present invention.

FIG. 63 shows an example of a Java API provided by the right processing unit according to the fourth embodiment of the present invention.

FIG. 64 is a block diagram showing the configuration of the video storing apparatus according to the fourth embodiment of the present invention.

FIG. 65 is a structure diagram of a program to be held and executed by the video storing apparatus according to the fourth embodiment of the present invention.

FIG. 66 is a diagram showing an example of an internal configuration of the network library according to the fourth embodiment of the present invention.

FIG. 67 shows an example of a Java API provided by the control unit included in the internal configuration of the network library according to the fourth embodiment of the present invention.

FIG. 68 is a diagram showing the structure of a ContentInfo class used for the network library according to the fourth embodiment of the present invention.

FIG. 69 shows an example of a Java API provided by the control information communicating unit included in the internal configuration of the network library according to the fourth embodiment of the present invention.

FIG. 70 shows an example of a Java API provided by the data receiving unit included in the internal configuration of the network library according to the fourth embodiment of the present invention.

FIG. 71 is a diagram showing an example of a RemoteProgram class used for the network library according to the fourth embodiment of the present invention.

FIG. 72 shows an example of a Java API provided by the data transmitting unit 2803 included in the internal configuration of the network library according to the fourth embodiment of the present invention.

FIG. 73 shows an example of a Java API provided by the attribute management unit included in the internal configuration of the network library according to the fourth embodiment of the present invention.

FIG. 74 shows an example of a Java API provided by the right processing unit included in the internal configuration of the network library according to the fourth embodiment of the present invention.

### NUMERICAL REFERENCES

101, 3901 Multimedia delivering system
102, 3902 Broadcast receiving apparatus
103, 104, 3903, 3904 Video storing apparatus
1105, 106, 3905, 3906 Terminal
107, 3907 Network
108 Broadcast station
109 Cable
201, 4001 Control unit
202, 305, 4002, 4105 Data receiving unit
203, 4003 Information communicating unit
204, 4004 Selecting unit
205, 4005 Data output unit
206 Request transmitting unit
207, 309, 4006, 4109 Right processing unit 208, 310, 4007,
4110 Network interface
209 Cable interface
301, 4101 Control unit
302, 402, 4102, 4202 Storage unit
303, 4103 Control information communicating unit
304, 4104 Attribute storing unit
306, 4106 Data transmitting unit
307, 401, 4107, 4201 Writing unit
308, 403, 4108, 4203 Reading unit
501, 2701, 4201, 6401 Input unit
502, 2702, 4302, 6402 First memory
503, 2703, 4303, 6403 Second memory
504, 4304 Receiving unit
505, 2704, 4305, 6404 Demultiplex unit
506, 4306 Descrambler
507, 2704, 4307, 6405 TS decoder
508, 2706, 4308, 6406 Video output unit
509, 2707, 4309, 6407 Audio output unit
510, 4310 TS multiplexer
511, 2708, 4311, 6408 Network unit
512, 2709, 4312, 6409 CPU
3908 Receiving unit

### BEST MODE FOR CARRYING OUT THE INVENTION

Hereinafter, the embodiment of the present invention will be described with reference to the drawings.

### First Embodiment

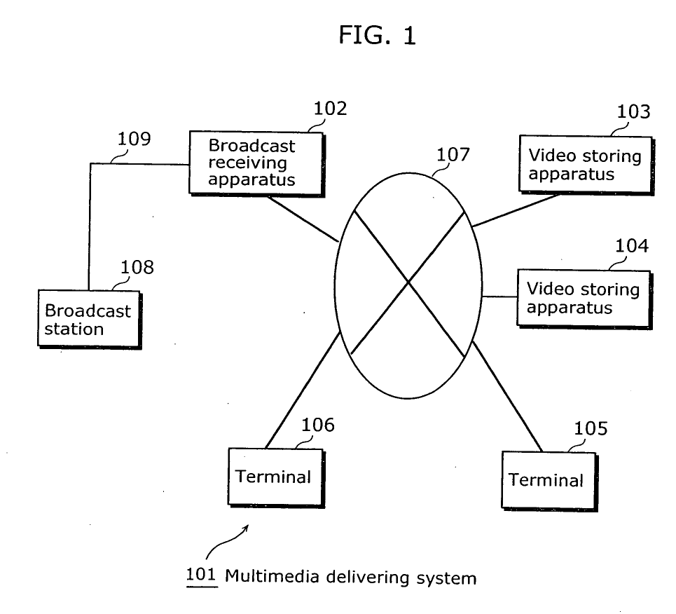

FIG. 1 is a configuration diagram for the multimedia delivering system in the first embodiment of the present invention. A multimedia delivering system 101 shown in FIG. 1 includes a broadcast receiving apparatus 102, a first video storing apparatus 103, a second video storing apparatus 104, a first terminal 105, a second terminal 106, a network 107, a broadcast station for a cable television 108, and a cable 109 that connects the broadcast station 108 to the broadcast receiving apparatus 102. The broadcast receiving apparatus 102, the video storing apparatus 103, the video storing apparatus 104, the terminal 105, and the terminal 106 are connected to the network 107, and they can communicate with each other via the network 107. Furthermore, the broadcast receiving apparatus 102 and the broadcast station 108 are connected through the cable 109, and they can communicate with each other through the cable 109. Note that the plural number of video storing apparatuses and terminals has only to be included in the system, and it is assumed that two video storing apparatuses and two terminals are included herein in order to make the description easier.

The broadcast receiving apparatus 102 in the present embodiment receives multimedia data from the broadcast station 108 through the cable 109. Furthermore, the broadcast receiving apparatus 102 uses a VoD service. Thus, the broadcast receiving apparatus 102 transmits and receives control information through the cable 109, such as transmitting a transmission request of multimedia data for a VoD service and performs communication for right processing, including billing, to use the multimedia data. Note that the control information may be communicated via other communication paths not shown in the figure, such as a phone line, instead of the cable 109.

Furthermore, when the broadcast receiving apparatus 102 receives, in advance, multimedia data for the VoD service from the broadcast station 108, it transmits a request for transmitting attributes to the video storing apparatuses 103 and 104 via the network 107, and receives the attributes from the video storing apparatuses 103 and 104. Furthermore, the broadcast receiving apparatus 102 selects one of the video storing apparatus 103 and the video storing apparatus 104 as a storage destination for the received multimedia data, based on the attributes of the multimedia data received from the broadcast station and the attributes of the video storing apparatuses received from the video storing apparatuses. Furthermore, the broadcast receiving apparatus 102 transmits a request for storing multimedia data, to one of the selected video storing apparatus 103 or 104, and then transmits the multimedia data to the selected video storing apparatus.

Note that transmission of the multimedia data for the VoD service performed in advance from the broadcast station 108 to the broadcast receiving apparatus 102 may be performed in response to a request from the broadcast station 108 or a request from the broadcast receiving apparatus 102. Alternatively, the transmission may be performed in a particular date and time and for each particular time.

Furthermore, when the broadcast receiving apparatus 102 receives, from the terminal 105 or the terminal 106, a request of using a VoD service in which a content such as a program is specified, it inquires about whether or not multimedia data of the content is stored, by communicating with one of the video storing apparatuses 103 and 104 or both of the video storing apparatuses.

When the data is stored neither in the video storing apparatus 103 nor the video storing apparatus 104, the broadcast receiving apparatus 102 transmits a request for transmitting the multimedia data, to the broadcast station 108. If necessary, after performing appropriate right processing including billing, the broadcast receiving apparatus 102 receives the multimedia data through the cable 109 and transmits, via the network 107, the multimedia data to one of the terminals 105 and 106 that requests the VoD service.

Furthermore, when the data is stored either in the video storing apparatus 103 or the video storing apparatus 104, the broadcast receiving apparatus 102 requests one of the video storing apparatuses 103 and 104 that stores the multimedia data to transmit the multimedia data to the terminal that requests the VoD service. In this case, if necessary, the broadcast receiving apparatus 102 performs, by communicating with the video storing apparatus, right processing, including billing, following the use of the multimedia data, and notifies the processing to the broadcast station 108. Furthermore, the broadcast receiving apparatus 102 notifies the terminal that requests the VoD service of information indicating that the multimedia data is to be transmitted from the video storing apparatus that stores the multimedia data.

Once each of the video storing apparatuses 103 and 104 in the present embodiment receives a request for transmitting the attributes, from the broadcast receiving apparatus 102, each of the video storing apparatuses transmits, to the broadcast receiving apparatus 102, the attributes stored in the video storing apparatus. An attribute of a video storing apparatus includes information, such as a free space in a storage unit that stores multimedia data for a VoD service, a storage frequency of multimedia data, stored by the user's operation, per genre, and use frequency of the reproduced multimedia data per genre.

Furthermore, once each of the video storing apparatuses 103 and 104 receives a request for storing multimedia data, from the broadcast receiving apparatus 102, each of the video storing apparatuses receives the multimedia data from the broadcast receiving apparatus 102 via the network 107, and stores the data in a storage unit.

Furthermore, once each of the video storing apparatuses 103 and 104 receives an inquiry about whether or not multimedia data of a particular content is stored, each of the video storing apparatuses searches for the stored content data, and returns the result.

Furthermore, once each of the video storing apparatuses 103 and 104 receives, from the broadcast receiving apparatus 102, a request for transmitting the multimedia data of a particular content to a particular terminal connected to the network 107, it transmits the multimedia data to the terminal via the network 107. When starting the transmission, if necessary, each of the video storing apparatuses 103 and 104 communicates with the broadcast receiving apparatus 102, and performs right processing following the use of the multimedia data, such as billing.

Each of the terminals 105 and 106 in the present embodiment issues a request of a VoD service to the broadcast receiving apparatus 102 by the user's operation, receives the multimedia data via the network 107, and reproduces the multimedia data. Furthermore, when the data is stored either in the video storing apparatus 103 or the video storing apparatus 104, one of the video storing apparatuses 103 and 104 that stores the multimedia data is notified by the broadcast receiving apparatus 102, and the broadcast receiving apparatus 102 receives, via the network 107, the multimedia data transmitted from one of the video storing apparatuses.

The network 107 is a home network established in the household, and is an IP network configured of the Ethernet (trademark), a wireless LAN, a communication technology called c. LINK that uses a coaxial cable as a medium, or the like.

The broadcast station 108 and the cable 109 in the present embodiment are facilities that provide a VoD service.

As described above, with the multimedia delivering system 101, the broadcast receiving apparatus 102, and the video storing apparatuses 103 and 104 according to the present invention, it is possible to distribute multimedia data for use in a VoD service to the video storing apparatuses 103 and 104 and to store the data therein, on an appropriate condition. Even when the terminals 105 and 106 concurrently issue requests for a VoD service, it is possible to reduce unnecessary requests to the broadcast station 108 for transmitting multimedia content data, and bandwidth consumption of the cable 109, by using the multimedia data stored in the video storing apparatuses 103 and 104.

Hereinafter, the broadcast receiving apparatus 102 and the video storing apparatuses 103 and 104, which compose the multimedia delivering system 101 are to be described in details.

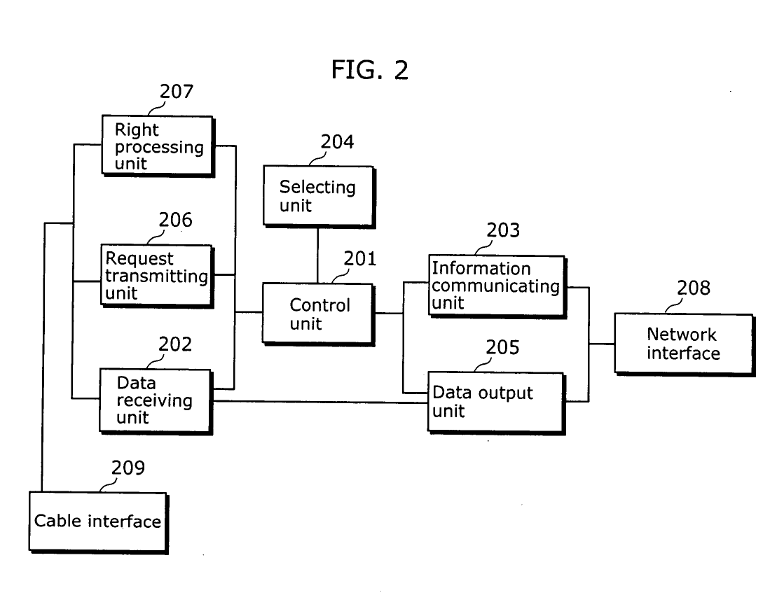

First, with reference to FIG. 2, the details of the broadcast receiving apparatus 102 are to be described.

FIG. 2 is a block diagram showing an example of the configuration of the broadcast receiving apparatus 102 according to the first embodiment of the present invention.

The broadcast receiving apparatus shown in FIG. 2 includes: a control unit 201; a data receiving unit 202 that receives multimedia data transmitted from the broadcast station 108; an information communicating unit 203 that communicates with an external device connected to the network 107; a selecting unit 204 that selects one of the video storing apparatuses connected to the network 107; a data output unit 205 that transmits multimedia data to the external device connected to the network 107; a request transmitting unit 206 that transmits a request for transmitting multimedia data to the broadcast station 108; a right processing unit 207 that performs right processing, including billing, following the use of the multimedia data in the VoD service; a network interface 208 connected to the network 107; and a cable interface 209 connected to the cable 109.

The control unit 201 is to be described in details. The control unit 201 includes a microprocessor, a ROM, a RAM, and the like. In the ROM, RAM, and an information storage unit not shown in the figure, an OS operated by the microprocessor, a Java Virtual Machine (Java VM) program, a Java program library, and a Java application program are stored. The microprocessor reads and runs the OS on start-up. Next, on start-up of the Java application program, the microprocessor reads and runs the Java VM program, and runs the Java application program while reading the Java program library as necessary.

When the control unit 201 receives, in advance, multimedia data for a VoD service from the data receiving unit 202, it transmits a request for transmitting each attribute to the video storing apparatuses connected to the network 107, using the information communicating unit 203. Then, the control unit 201 receives respective attributes from the video storing apparatuses, using the information communicating unit 203. Furthermore, the control unit 201 transmits, to the selecting unit, the received attributes of the video storing apparatuses and the attributes of the multimedia data, and instructs the selecting unit to select one of the video storing apparatuses. Furthermore, the control unit 201 transmits a request for storing the multimedia data to the selected video storing apparatus, using the information communicating unit 203. Furthermore, when the control unit 201 receives, using the information communicating unit 203, information indicating that the video storing apparatus receives the storage request, the control unit 201 instructs the data output unit 205 to transmit the multimedia data to the video storing apparatus via the network 107.

Furthermore, when the control unit 201 receives, using the information communicating unit 203, a request of a VoD service from the terminal connected to the network 107, the control unit 201 transmits an inquiry, to each of the video storing apparatuses, about whether or not the video storing apparatus connected to the network 107 stores the requested multimedia data, using the information communicating unit 203. Then, the control unit 201 receives a reply regarding this inquiry from each of the video storing apparatuses, using the information communicating unit 203. When a video storing apparatus stores the multimedia data, the control unit 201 transmits, to the video storing apparatus, a request for transmitting the multimedia data to the terminal that has issued the request of the VoD service of the multimedia data. In this case, if necessary, the control unit 201 communicates with the video storing apparatus, and instructs the right processing unit 207 to perform right processing following the use of the multimedia data, such as billing. Furthermore, the control unit 201 notifies the terminal of information indicating that the multimedia data is to be transmitted from the video storing apparatus, using the information communicating unit 203.

The data receiving unit 202 is connected to the cable interface 209, and receives multimedia data transmitted from the broadcast station 108 through the cable interface 209. The data receiving unit 202 is a tuner as a representative example, receives and decodes a signal transmitted from the broadcast station 108, and extracts multimedia data. Furthermore, although the multimedia data transmitted from the broadcast station 108 is sometimes scrambled when it is a pay content, in such a case, the data is decoded by the data receiving unit 202.

The multimedia data transmitted from the broadcast station 108 is coded digital data as represented by the MPEG2, and is transmitted in the MPEG2-Transport Stream (TS) format. Although in the MPEG2-TS, it is possible to store plural contents within a stream, the data receiving unit 202 selects multimedia data of a single content from the stream.

The information communicating unit 203 is connected to the network interface 208, and in response to an instruction from the control unit 201, it transmits control information to an external device connected to the network 107. Furthermore, the information communicating unit 203 receives information that is to be transmitted to the broadcast receiving apparatus 102 and that has been received by the network interface 208, and passes the information to the control unit 201. The information communicating unit 203 is, as a representative example, a socket interface provided by the OS or the Java library, or a program using the socket interface. Note that the configuration of the information communicating unit 203 is not limited to the one including such software, but may be the one including hardware.

In response to an instruction from the control unit 201, the selecting unit 204 selects one of a plurality of video storing apparatuses connected to network 107, base on the attributes of the multimedia data and the attributes of the video storing apparatuses. The selecting unit 204 is, as a representative example, a sub-routine included in the Java library or the Java application program. Note that the configuration of the selecting unit 204 is not limited to the one including such software, but may be the one including hardware.

In the present embodiment, as attributes of multimedia data, genres of contents, such as a movie, a drama, and a sport are used. Furthermore, free space in a storage unit for the VoD data is used as an attribute of a video storing apparatus. The selecting unit 204 selects a video storing apparatus according to a genre of multimedia data, and when the selected video storing apparatus does not have an enough free space, it selects a video storing apparatus having a large space.

The data output unit 205 is connected to the network interface 208, operates in response to an instruction from the control unit 201, converts the multimedia data to a packet for a destination instructed by the control unit 201, and outputs the packet through the network interface 208. The data output unit 205 is, as a representative example, a socket interface provided by the OS or the Java library, or a program using the socket interface. Note that the configuration of the data output unit 205 is not limited to the one including such software, but may be the one including hardware.

The request transmitting unit 206 transmits a data transmission request in a VoD service in response to an instruction from the control unit 201, to the broadcast station 108 through the cable interface 209.

The right processing unit 207 performs right processing, including billing, following the use of multimedia data by communicating with the broadcast station 108. The right processing unit 207 includes a CableCARD (trademark), and uses this information for the communication with the broadcast station 108. Furthermore, when the multimedia data transmitted from the broadcast station 108 is scrambled, the right processing unit 207 passes the information of the CableCARD to the control unit 201 so as to decode the data in the data receiving unit 202.

The network interface 208 is configured of: hardware that provides an interface corresponding to a physical medium of a network, such as the Ether cable or a wireless LAN; and the driver software.

The cable interface 209 receives a signal transmitted from the broadcast station 108 through the cable 109, converts the signal to an appropriate signal depending on a type of data and the destination, and distributes the converted signal to the data receiving unit 202, the request transmitting unit 206, and the right processing unit 207, respectively. Furthermore, the cable interface 209 converts the data transmitted from the request transmitting unit 206 and the right processing unit 207 to the broadcast station, to a signal appropriate for transmitting to the cable 109, and transmits the converted signal. For example, when the broadcast station 108, the request transmitting unit 206, and the right processing unit 207 communicate with each other in accordance with a protocol of the IP network, the cable interface 209 serves as a bridge between the IP network and a cable.

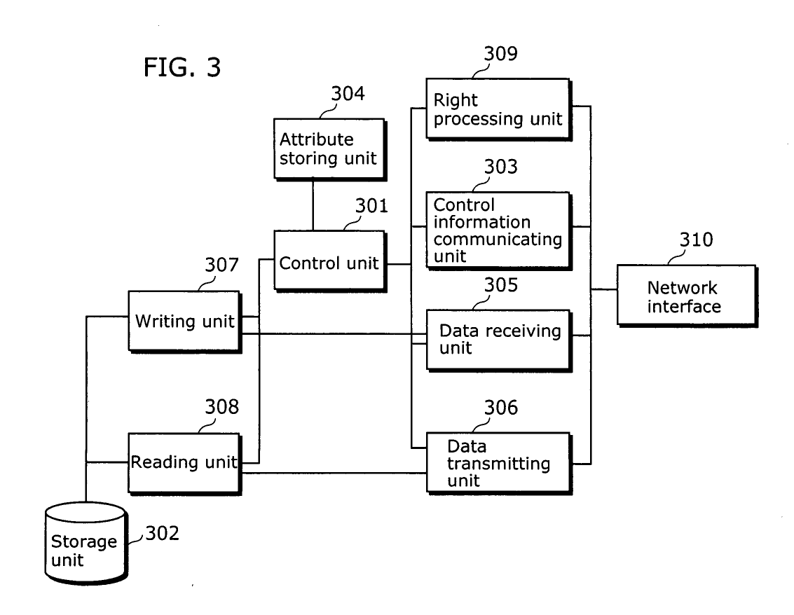

Next, with reference to FIG. 3, the details of the video storing apparatus 103 and the video storing apparatus 104 according to the present embodiment are to be described.

FIG. 3 is a block diagram showing an example of the configuration of the video storing apparatuses 103 and 104 according to the first embodiment of the present invention.

In FIG. 3, 301 denotes a control unit; 302 denotes a storage unit that stores multimedia data; 303 denotes a control information communicating unit that communicates control information with an external device connected to the network 107; 304 is an attribute storing unit that stores an attribute of a video storing apparatus; 305 denotes a data receiving unit that receives multimedia data transmitted from the broadcast receiving apparatus 102; 306 denotes a data transmitting unit that transmits the multimedia data stored in the storage unit 302, to the terminal 105 or 106 connected to the network 107; 307 denotes a writing unit that writes the multimedia data received by the data receiving unit 305, in the storage unit 302; 308 denotes a reading unit that reads the multimedia data from the storage unit 302; 309 denotes a right processing unit that performs right processing, including billing, following use of the multimedia data, by communicating with the broadcast receiving apparatus 10; and 310 denotes a network interface connected to the network 107.

The control unit 301 is to be described in details. The control unit 301 includes a microprocessor, a ROM, a RAM, and the like. In the ROM, RAM, and an information storage unit, an OS operated by the microprocessor, a Java VM program, a Java program library, and a Java application program are stored. The microprocessor reads and runs the OS on start-up. Next, on start-up of the Java application program, the microprocessor reads and runs the Java VM program, and runs the Java application program while reading the Java program library as necessary.

Once the control unit 301 receives a request for transmitting attributes, from the broadcast receiving apparatus 102 using the control information communicating unit 303, it transmits attribute information stored in the attribute storing unit 304 from the control information communicating unit 303 to the broadcast receiving apparatus 102. Furthermore, once receiving a request for storing multimedia data from the broadcast receiving apparatus 102, using the control information communicating unit 303, the control unit 301 instructs the data receiving unit 305 to receive the multimedia data transmitted from the broadcast receiving apparatus 102 through the network 107, and instructs the writing unit 307 to write the multimedia data received by the data receiving unit 305, in the storage unit 302 so as to store the multimedia data in the storage unit 302. Furthermore, after storing the data, the control unit 301 receives, from the writing unit 307, information of a free space of the storage unit 302, and updates the attribute information stored in the attribute storing unit 304.

Furthermore, when the control unit 301 receives, from the broadcast receiving apparatus 102 using the control information communicating unit 303, an inquiry about whether or not particular multimedia data is stored, the control unit 301 instructs the reading unit 308 to check the multimedia data stored in the storage unit 302, judges whether or not the multimedia data is stored, and transmits a result of the judgment from the control information communicating unit 303 to the broadcast receiving apparatus 102.

Furthermore, when the control unit 301 receives a request for outputting the stored particular multimedia data and a terminal to which the data is outputted, from the broadcast receiving apparatus 102 using the control information communicating unit 303, the control unit 301 instructs the reading unit 308 to read the multimedia data from the storage unit 302, and further instructs the data transmitting unit 306 to transmit the multimedia data read by the reading unit 308, to the specified terminal. Furthermore, in this case, if necessary, the control unit 301 instructs the right processing unit 309 to communicate with the broadcast receiving apparatus 102 so as to perform right processing following the use of the multimedia data. When use of the multimedia data is not permitted in the right processing, the control unit 301 controls the multimedia data not to be transmitted to the specified terminal.

The storage unit 302 is configured of: a storage device for storing digital data having a large space, as represented by a hard disk drive; and the driver software.

The control information communicating unit 303 is connected to the network interface 310, receives control information for the video storing apparatus which has been received by the network interface 310, and passes the information to the control unit 301. Furthermore, in response to an instruction from the control unit 301, the control information communicating unit 303 transmits the control information passed from the control unit 301 to a specified external device through the network interface 310. The control information communicating unit 303 is, as a representative example, a socket interface provided by the OS or the Java library, or a program using the socket interface. Note that the configuration of the control information communicating unit 303 is not limited to the one including such software, but may be the one including hardware.

The attribute storing unit 304 is configured of a storage device or a part of the device, such as a flash memory and a HDD, and in response to an instruction from the control unit 301, it stores data received from the control unit 301.

The data receiving unit 305 is connected to the network interface 310, operates in response to an instruction from the control unit 301, and receives the multimedia data transmitted from the broadcast receiving apparatus 102, through the network interface 310. The data receiving unit 305 is, as a representative example, a socket interface provided by the OS or the Java library, or a program using the socket interface. Note that the configuration of the data receiving unit 305 is not limited to the one including such software, but may be the one including hardware.

The data transmitting unit 306 is connected to the network interface 310, operates in response to an instruction from the control unit 301, converts the multimedia data read by the reading unit 308 to a packet of the external device that is connected to the network 107 and that is specified by the control unit 301, and outputs the packet through the network interface 310. The data transmitting unit 306 is, as a representative example, a socket interface provided by the OS or the Java library, or a program using the socket interface. Note that the configuration of the data transmitting unit 306 is not limited to the one including such software, but may be the one including hardware.

The writing unit 307 operates in response to an instruction from the control unit 301, and writes data in the data storage unit 302. The writing unit 307 is, as a representative example, a software sub-routine that uses a file access interface provided by the OS and the Java library. Note that the configuration of the writing unit 307 is not limited to the one including such software, but may be the one including hardware.

The reading unit 308 operates in response to an instruction from the control unit 301, and reads the multimedia data stored in the data storage unit 302. The reading unit 308 is, as a representative example, a software sub-routine that uses a file access interface provided by the OS and the Java library. Note that the configuration of the reading unit 308 is not limited to the one including such software, but may be the one including hardware.

The right processing unit 309 is connected to the network interface 310, operates in response to an instruction from the control unit 301, and performs right processing following the use of multimedia data, such as billing, by communicating with the broadcast receiving apparatus 102. The right processing unit 309 transmits, to the broadcast receiving apparatus 102, an identifier that identifies multimedia data to be used, receives a response from the broadcast receiving apparatus 102, and passes the response to the control unit 301. The response is permission or rejection for the use of the multimedia data.

The network interface 310 is configured of: hardware that provides an interface corresponding to a physical medium of a network, such as the Ether cable or a wireless LAN; and the driver software.

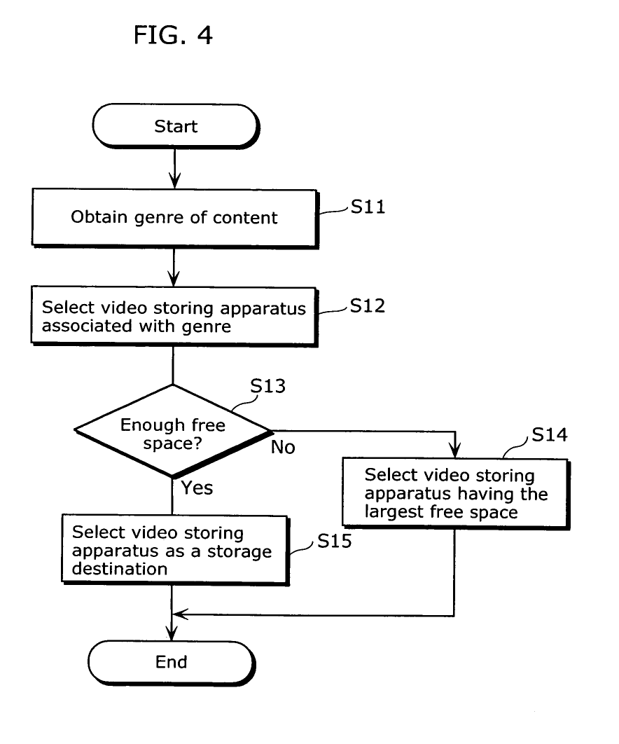

FIG. 4 is a flowchart showing an example of processing executed by the selecting unit 204 of the broadcast receiving apparatus 102 according to the first embodiment of the present invention. In the diagram, a genre of a content is used as an example of an attribute of multimedia, showing the processing when using, as an example of an attribute of a video storing apparatus, the free space of the storage unit 302 stored included in each of the video storing apparatuses.

The selecting unit 204 obtains a genre of a content in response to an instruction from the control unit 201 (S11).

The selecting unit 204 selects a video storing apparatus associated with the obtained genre (S12).

The selecting unit 204 obtains information of the free space of the storage unit 302 included in each of the video storing apparatuses selected in the storage destination selecting processing (S12), and judges whether or not the obtained free space is enough to store data including the content to be stored (S13).

When judging that the free space is enough (Yes at S13), the selecting unit 204 selects the video storing apparatus as a storage destination (S15), and ends the processing.

When judging that the free space is not enough (No at S13), the selecting unit 14 selects, as a storage destination, the video storing apparatus having the largest free space (S14), and ends the processing.

### Variation of the First Embodiment

Although the present invention is described based on the above-mentioned first embodiment, it should be obvious that the present invention is not limited to such above-mentioned embodiment. The present invention also includes such cases as described below.

(1) It is possible that the broadcast receiving apparatus 102 further includes a storage unit that stores multimedia data and a writing unit that writes the multimedia data in the storage unit, and the selecting unit 204 selects one of a storage unit of the broadcast receiving apparatus 102 and a video storing apparatus connected to the network 107. Furthermore, the broadcast receiving apparatus 102 further checks whether or not multimedia data of the content is stored in the video storing apparatus connected to the network 107 and the storage unit of the broadcast receiving apparatus 102, and when it is stored in the storage unit of the broadcast receiving apparatus 102, it is possible that the multimedia data is transmitted to a terminal that issues a request of the VoD service.

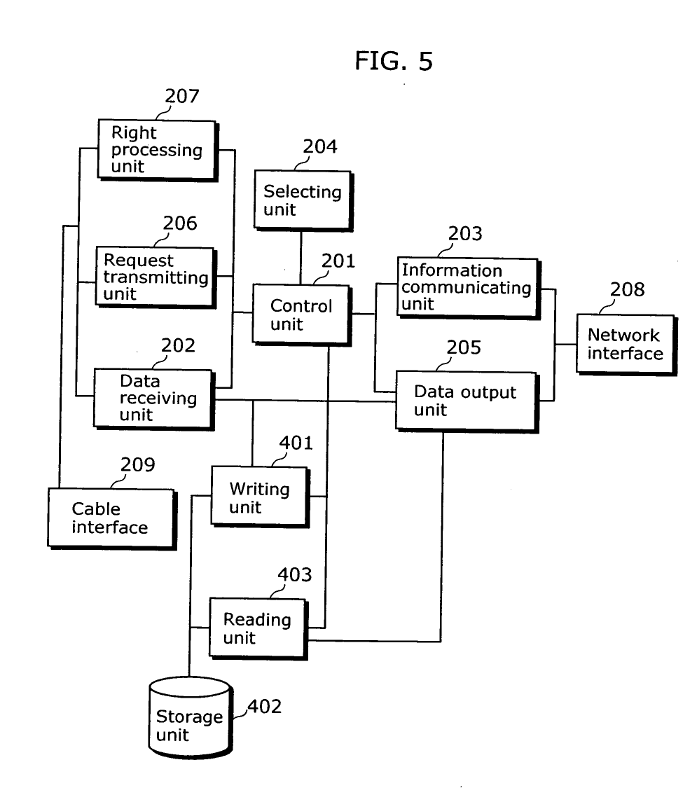

FIG. 5 is a block diagram showing the configuration of the broadcast receiving apparatus in the variation of the first embodiment of the present invention.

The broadcast receiving apparatus 102 shown in FIG. 5 includes a writing unit 401, a storage unit 402, a reading unit 403 that reads multimedia data stored in the storage unit 402, the control unit 201, the data receiving unit 202, the information communicating unit 203, the selecting unit 204, the request transmitting unit 206, the right processing unit 207, the network interface 208, and the cable interface 209. Although the control unit 201, the data receiving unit 202, the information communicating unit 203, the selecting unit 204, the request transmitting unit 206, the right processing unit 207, the network interface 208, and the cable interface 209 are the same as described in the first embodiment, they differ in the following points. When the control unit 201 receives, in advance, multimedia data for a VoD service from the data receiving unit 202 it receives the attributes from the video storing apparatuses 103 and 104, and at the same time, reads the attribute of the broadcast receiving apparatus 102. The attributes of the broadcast receiving apparatus 102 is the same as the attribute information of the video storing apparatuses 103 and 104 in the aforementioned embodiment. Furthermore, the control unit 201 transmits the attributes of the broadcast receiving apparatus 102 to the selecting unit 204, together with the attributes of the video storing apparatuses. The selecting unit 204 selects one of the video storing apparatuses 103, 104, and the storage unit 402, based on the transmitted attributes.

The writing unit 401 is the same as the writing unit 307 of the video storing apparatuses 103 and 104 in the aforementioned embodiment. Furthermore, the storage unit 402 is the same as the storage unit 302 of the video storing apparatuses 103 and 104 in the aforementioned embodiment. Furthermore, the reading unit 403 is the same as the reading unit 308 of the video storing apparatuses 103 and 104 in the aforementioned embodiment.

(2) Furthermore, it is possible that broadcast receiving apparatus 102 perform predetermined encryption on multimedia data and transmit the encrypted multimedia data to the video storing apparatuses 103 and 104. Furthermore, it is possible that the video storing apparatuses 103 and 104 decrypt the received and encrypted multimedia data, stores the multimedia data in the storage unit 302, and further stores the data by performing predetermined encryption on the multimedia data.

Furthermore, when the broadcast receiving apparatus 102, and the video storing apparatuses 103 and 104 transmit multimedia data to the terminals 105 and 106, it is possible that they perform predetermined encryption on the multimedia data, and transmit the encrypted multimedia data, decrypt the encrypted multimedia data received by the terminals 105 and 106, and reproduce the multimedia data.

(3) Furthermore, although the selecting unit 204 of the broadcast receiving apparatus 102 in the present embodiment selects a video storing apparatus based on a genre of multimedia data and the free space of the video storing apparatus, it is obvious that the conditions for selecting a video storing apparatus is not limited to these conditions.

For example, it is possible that the broadcast receiving apparatus 102 selects video receiving devices in order. Furthermore, it is possible that the selection is based on priorities of the video storing apparatuses set by the user. Furthermore, it is possible to select a video storing apparatus only based on a genre of multimedia data. Furthermore, it is possible to select a video storing apparatus only based on a free space of a video storing apparatus. Furthermore, it is possible to select it according to use frequency of a video storing apparatus. Furthermore, it is possible to select a video storing apparatus by checking individual storing frequencies of genres, program names, performers, and the like of multimedia data stored in the video storing apparatuses by the user's operation, with genres, program names, performers, and the like of multimedia data.

Furthermore, it is possible to select a video storing apparatus by checking individual storing frequencies of genres, program names, performers, and the like of multimedia data reproduced or outputted to the video storing apparatuses by the user's operation, with genres, program names, performers, and the like of multimedia data.

Furthermore, it is possible to select a pair of a terminal and a video storing apparatus according to data, for example, selecting the video storing apparatus 103 for multimedia data having a high frequency to be used in the terminal 105, and selecting the video storing apparatus 104 for multimedia data having a high frequency to be used in the terminal 106.

Furthermore, it is possible to select a pair of a terminal and a video storing apparatus according to priorities of terminals set by the user. Furthermore, it is possible to select a pair of a terminal and a video storing apparatus based on the use frequency of a terminal used by the user or the use frequencies for each genre of the terminals used by the user.

(4) Furthermore, although the broadcast receiving apparatus 102 judges whether or not multimedia data of a content requested in the VoD service is stored, by communicating with the video storing apparatuses 103 and 104 in the aforementioned embodiment, it is possible that the broadcast receiving apparatus 102 stores multimedia data stored in the video storing apparatuses 103 and 104, and judges whether or not the data is stored, from the content of the stored multimedia data.

(5) Furthermore, although the multimedia data is transmitted from the broadcast station 108 through the cable 109 in the aforementioned embodiment, it is possible that the multimedia data is transmitted through other communication paths, such as the IP network for the Internet. Furthermore, although the multimedia data is provided to a broadcast station, such as a cable television provider in the aforementioned embodiment, the providers include distributors who distribute data in other formats, such as content providers on the Internet.

(6) Furthermore, in the present embodiment, when multimedia data for the VoD service requested from a terminal is stored either in the video storing apparatus 103 or 104, the broadcast receiving apparatus 102 issues, to the video storing apparatus that stores the data, a request for transmitting the multimedia data to the terminal that requests the VoD service, and notifies the terminal of information indicating that the multimedia data is to be transmitted from the video storing apparatus. However, it is possible that the broadcast receiving apparatus 102 performs right processing such as billing with the video storing apparatus, notifies the video storing apparatus to the terminal, and issues a request for transmitting the multimedia data from the terminal to the video storing apparatus.

(7) Furthermore, although in the present embodiment, when multimedia data for the VoD service requested from a terminal is stored either in the video storing apparatus 103 or 104, the broadcast receiving apparatus 102 communicates with the video storing apparatus and performs right processing following the use of the multimedia data, such as billing, it is possible that the broadcast receiving apparatus 102 communicates with the terminal that requests the VoD service and performs the right processing. Alternatively, it is possible that the broadcast receiving apparatus 102 performs right processing without communicating with a video storing apparatus and a terminal.

Furthermore, although the right processing following the use of multimedia data, such as billing, is performed when a request for transmitting multimedia data is issued in the aforementioned embodiment, it is possible to perform the right processing after the multimedia data is used. Furthermore, it is possible to change the amount to be billed according to the number of times that the multimedia data is used, a use section of the multimedia data, or the like.

(8) Furthermore, although single multimedia data is stored in a video storing apparatus in the aforementioned embodiment, it is possible to divide the multimedia data and distribute the divided data to plural video storing apparatuses. Alternatively, it is possible to concurrently store single multimedia data in the plural video storing apparatuses. With this, when plural terminals request identical multimedia data, it is possible to distribute loads in which the video storing apparatus transmits video to the terminal.

(9) Furthermore, the broadcast receiving apparatus 102 further includes a coding unit that creates coded multimedia data, and it is possible that the broadcast receiving apparatus 102 temporarily decodes multimedia data to be transmitted, newly creates multimedia data using the coding unit, and transmits the created multimedia data. Furthermore, it is possible that the video storing apparatuses 103 and 104 further include a decoding unit that decodes multimedia data, and a coding unit that creates coded multimedia data, and it is possible that the decoding unit temporarily decodes the received multimedia data, newly creates multimedia data using the coding unit, and stores the created multimedia data.

(10) It is possible that a part or all of the constituent elements making up each of the above-mentioned apparatuses is made from one system LSI (Large Scale Integration circuit). The system LSI is a super multi-function LSI that is manufactured by integrating plural elements in one chip, and is specifically a computer system which is configured by including a microprocessor, a ROM, a RAM, and so on. A computer program is stored in the RAM. The system LSI accomplishes its functions through the operation of the microprocessor in accordance with the computer program.

(11) It is possible that a part or all of the constituent elements making up each of the above-mentioned apparatuses is made from an IC card that can be attached to/detached from each apparatus, or a stand-alone module. The IC card or the module is a computer system made from a microprocessor, a ROM, a RAM, and so on. The IC card or the module may include the super multi-function LSI. The IC card or the module accomplishes its functions through the operation of the microprocessor in accordance with the computer program. The IC card or the module may also be tamper-resistant.

(12) The present invention may operate in the aforementioned methods. Furthermore, the present invention may also be a computer program for causing a computer to execute such methods, or as a digital signal made from the computer program.

Furthermore, the present invention may be a computer-readable recording medium, such as a flexible disk, a hard disk, a CD-ROM, an MO, a DVD, a DVD-ROM, a DVD-RAM, a Blu-ray Disc (BD (trademark)), or a semiconductor memory, on which the computer program or the digital signal is recorded. Furthermore, the present invention may also be the computer program or the digital signal recorded on such recording media.

Furthermore, the present invention may transmit the computer program or the digital signal via an electrical communication line, a wireless or wired communication line, a network represented by the Internet, a data broadcast, and so on.

Furthermore, the present invention compose a computer system including a microprocessor and a memory, with the memory storing the computer program and the microprocessor operating in accordance with the computer program.

Furthermore, the present invention may also be implemented in another independent computer system by recording the program or the digital signal on the recording medium and transferring the recording medium, or by transferring the program or the digital signal via the network, and the like.

(13) It is also possible to combine the above-described embodiment and the aforementioned variation.

### Second Embodiment

Since a configuration of a multimedia delivering system in the second embodiment is the same as that of the first embodiment shown in FIG. 1, the description is omitted hereinafter.

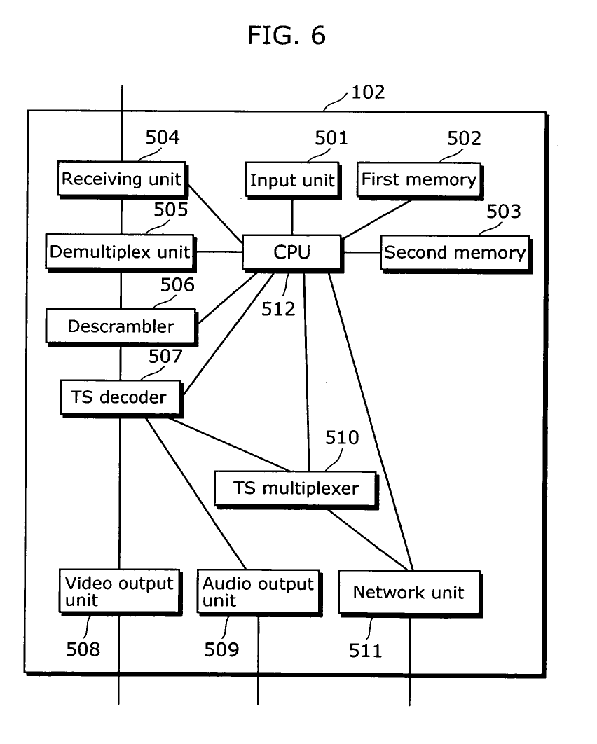

FIG. 6 is a block diagram showing a relationship between the constituent elements that compose the broadcast receiving apparatus 102 according to the second embodiment of the present invention. The broadcast receiving apparatus 102 of the second embodiment includes an input unit 501, a first memory 502, a second memory 503, a receiving unit 504, a demultiplex unit 505, a descrambler 506, a TS decoder 507, a video output unit 508, an audio output unit 509, a TS multiplexer 510, a network unit 511, and a CPU 512.

The input unit 501 is configured of a front panel, a remote control signal receiver, and the like, and accepts an instruction, such as a channel selection from a user.

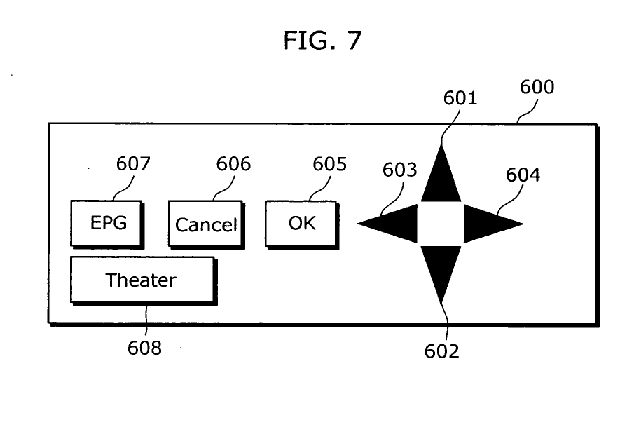

FIG. 7 shows an example of the input unit 501 in the case where it is configured of a front panel. 600 is a front panel configured of 8 buttons, namely, an up-cursor button 601, a down-cursor button 602, a left-cursor button 603, a right-cursor button 604, an OK button 605, a cancel button 606, an EPG button 607, and a theater button 608. When the user presses down a button, the identifier of such pressed button is notified to the CPU 512.

The first memory 502 is configured of a RAM, or the like, and is used when the CPU 512 temporarily stores data.

The second memory 503 is configured of a device that can hold information even when power is turned off, such as a flash memory, a hard disk, or the like, and stores a program executed by the CPU 512. The second memory may use a detachable storage device such as an SD memory card and the like.

The receiving unit 504 is connected to a cable from the broadcast station 108, receives broadcast waves, tunes to the frequency specified by the CPU 512, extracts an MPEG transport stream, and passes this to the demultiplex unit 505.

The demultiplex unit 505 receives the MPEG transport stream from the receiving unit 504, extracts information specified by the CPU 512, and passes this to the CPU 512. Furthermore, the demultiplex unit 505 passes the MPEG transport stream, as is, to the descrambler 506.

The descrambler 506 descrambles (decrypts) the scrambled MPEG transport stream provided by the demultiplex unit 505, and passes this to the TS decoder 507. The descrambler 506 may be a module built-into the broadcast receiving apparatus 102, and may also be implemented through the CableCARD™ introduced in North American cable receivers. The specifications of CableCARD are described in the CableCARD Interface Specification laid out by the CableLabs in United States, and thus the description is omitted herein.

The TS decoder 507 receives, from the CPU 512, identifiers of section data such as audio data, video data, PSI/SI information, and so on. In addition, the TS decoder 507 extracts, from a descrambled stream received from the descrambler 506, data corresponding to the identifiers of audio data, video data, section data such as PSI/SI information, and so on, and passes the extracted video data to the video output unit 508, and the extracted audio data to the audio output unit 509. Furthermore, it passes, to the TS multiplexer 510, both the extracted video data and audio data, and the section data.

The video output unit 508, which includes a video output terminal, converts the received video data to video data that complies with the terminal, and outputs this. An example of the terminal is a composite cable terminal, and so on.

The audio output unit 509, which includes an audio output terminal, converts the received audio data to audio data that complies with the terminal, and outputs this. Examples of the terminal are earphone terminals, a composite cable terminal, and so on.

The TS multiplexer 510 configures an MPEG2 transport stream from the received video data, audio data, and section data, and passes the MPEG2 transport stream to the network unit 511. The PSI/SI information can be rewritten as necessary.

The network unit 511, which includes a network interface, converts the data received from the CPU 512 into a signal that is in accordance with the physical media of the network to which the network interface is connected, and outputs this signal. Furthermore, the network unit 511 receives a signal from the network interface, converts the signal into a packet defined by the IP network, and passes the packet to the CPU 512.

The CPU 512 controls the receiving unit 504, the demultiplex unit 505, the descrambler 506, the TS decoder 507, the TS multiplexer 510, and the network unit 511 by executing a program stored in the second memory 503.

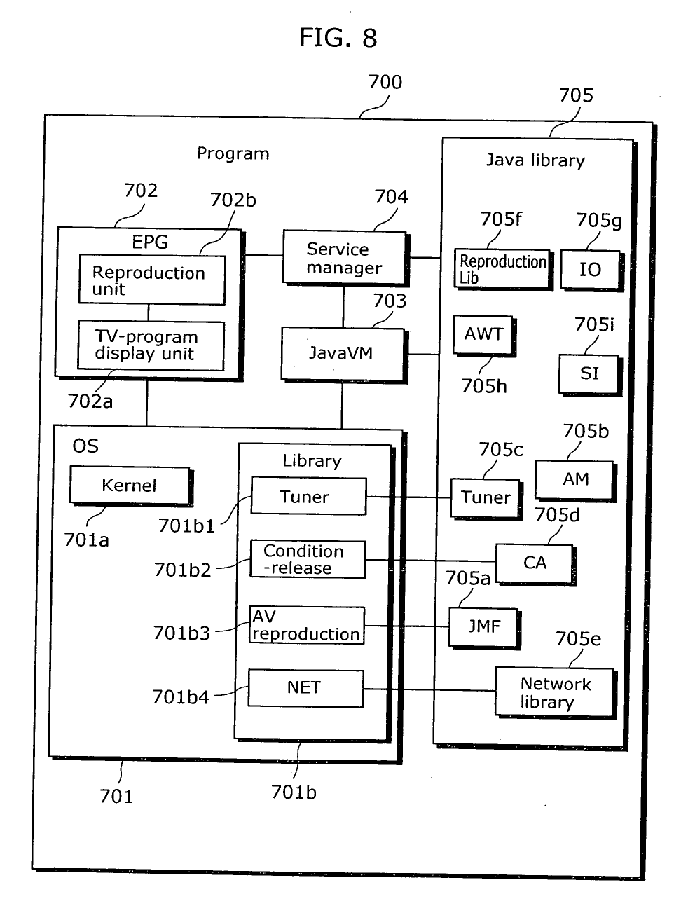

FIG. 8 is a structure diagram of a program to be held and executed by the broadcast receiving apparatus according to the second embodiment of the present invention. The diagram shows an example of a structure of the program stored in the second memory 503 and executed by the CPU 512.

A program 700 is made up of plural subprograms, and specifically includes an OS 701, an EPG 702, a Java VM 703, a service manager 704, and a Java library 705.

The OS 701 is a subprogram activated on the CPU 512 when power to the broadcast receiving apparatus 102 is turned on. OS is the acronym of operating system, an example of which is Linux and the like. The OS 701 is a generic name for publicly known technology made up of a kernel 701a for executing a subprogram concurrently with another subprogram and of a library 701b, and thus, the detailed description is omitted. In the present embodiment, the kernel 701a of the OS 701 executes the EPG 702 and the VM 703 as subprograms. Furthermore, the library 701b provides these subprograms with plural functions required for controlling the constituent elements held by the broadcast receiving apparatus 102.

In the present embodiment, the library 701b includes a tuner 701b1, condition-release 701b2, AV reproduction 701b3, and NET 701b4, as an example of such functions.

The tuner 701b1 receives tuning information including a frequency from other subprograms or a Tuner 705c of the Java library 705, and passes this to the receiving unit 504. The receiving unit 504 can perform demodulation based on the provided tuning information, and pass the demodulated data to the demultiplex unit 505. As a result, the other subprograms and the Tuner 705c of the Java library 705 can control the receiving unit 504 through the library 701b.

The condition-release 701b2 receives information from other subprograms or a CA 705d of the Java library 705, and passes this to the descrambler 506.

The AV reproduction 701b3 receives an audio packet ID and a video packet ID from the other subprograms or a JMF 705a of the Java library 705. It then provides the received audio packet ID and video packet ID to the TS decoder 507. As a result, the TS decoder 507 performs filtering based on the provided packet IDs, and implements the reproduction of audio/video.

The NET 701b4 creates packets of a protocol lower than the application layer defined by the IP network, for the data received from the other subprograms or a network library 705e of the Java library 705. A protocol lower than the application layer refers to, for example, a TCP packet, a UDP packet, an IP packet, and so on. By passing this to the network unit 511, messages and data are transmitted to other devices via the network 104. Furthermore, when a message is received from other devices via the network 107, the NET 701b4 converts the message to an application layer protocol packet and passes this to the other subprograms or the network library 705e of the Java library 705. An application layer protocol refers to, for example, HTTP, RTP, and so on.

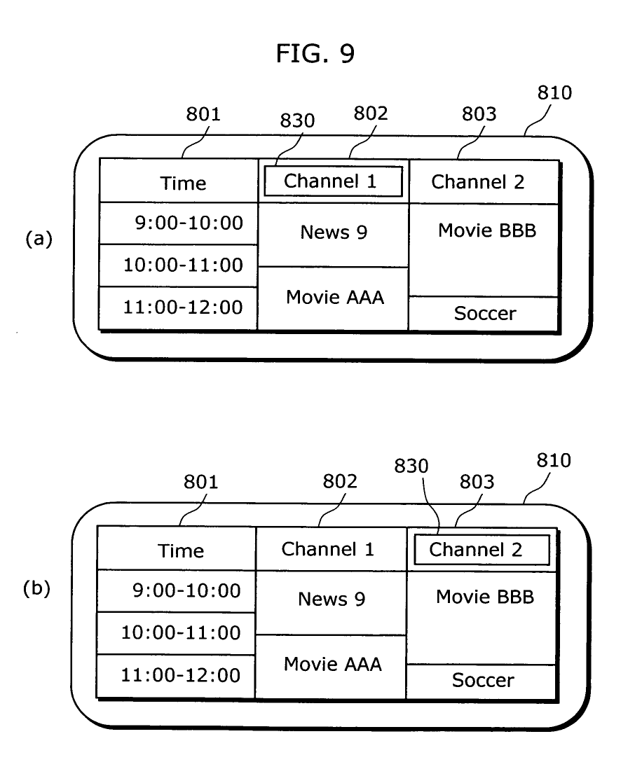

The EPG 702 includes a TV-program display unit 702a for displaying a list of TV-programs to the user as well as for accepting an input from the user, and a reproduction unit 702b for selecting channels. Here, EPG is an abbreviation of Electric Program Guide. The EPG 702 is activated by the kernel 701a when power to the broadcast receiving apparatus 102 is turned on. Inside the activated EPG 702, the TV-program display unit 702a and the reproduction unit 702b are activated at the same time. When activated, the TV-program display unit 702a waits for an input from the user through the input unit 501 of the broadcast receiving apparatus 102. Here, in the case where the input unit 501 is made up of the front panel illustrated in FIG. 7, when the user presses down the EPG button 607 on the input unit 501, the CPU 512 is notified of the identifier of such EPG button. The TV-program display unit 702a of the EPG 702, which is a subprogram running on the CPU 512, accepts this identifier, creates TV-program information display data, and outputs the data to a monitor 810, using a monitor output unit not shown in the figure. The monitor 810 may be included in the broadcast receiving apparatus 102, and may also be a television connected to the broadcast receiving apparatus 102 via a composite cable, HDMI cable, or the like. The monitor 810 displays the received TV-program information display data. FIG. 9(a) and (b) shows examples of a TV show table displayed on the monitor 810. TV-program information is displayed in a grid pattern on the monitor 810 shown in FIG. 9(a). A column 801 displays time information. A column 802 displays a channel name “Channel 1” and TV-programs to be broadcasted during time periods corresponding to the respective times described in the column 801. The monitor 810 shows that, on “Channel 2”, a TV-program “News 9” is broadcast from 9:00 to 10:30, and “Movie AAA” is broadcast from 10:30 to 12:00. A column 803 displays a channel name “Channel 2” and TV-programs to be broadcasted during time periods corresponding to the respective times described in the column 801. The monitor 810 shows that, on “Channel 2”, a TV-program “Movie BBB” is broadcast from 9:00 to 11:00, and “Soccer” is broadcast from 11:00 to 12:00. The cursor 830 moves at the press of the left-cursor 603 or the right-cursor 604 on the front panel 600. When the right-cursor 604 is pressed down in the state illustrated in FIG. 9(a), the cursor 830 moves towards the right as shown in FIG. 9(b). Furthermore, when the left-cursor 603 is pressed down in the state illustrated in FIG. 9(b), the cursor 830 moves towards the left as shown in FIG. 9(a).

When the OK button 605 on the front panel 600 is pressed down in the state shown in FIG. 9(a), the TV-program display unit 702a notifies the reproduction unit 702b of the identifier of “Channel 1”. When the OK button 605 on the front panel 600 is pressed down in the state shown in FIG. 9(b), the TV program display unit 702a notifies the reproduction unit 702b of the identifier of “Channel 2”.

Furthermore, the TV-program display unit 702a stores TV-program information to be displayed, in the second memory 503 through the demultiplex unit 505 at regular intervals. Generally, it takes time to obtain TV-program information from a broadcast station. It is possible to quickly display a TV show table by displaying the TV-program information stored in advance in the second memory 503, at the press of the EPG button 607 of the input unit 501.

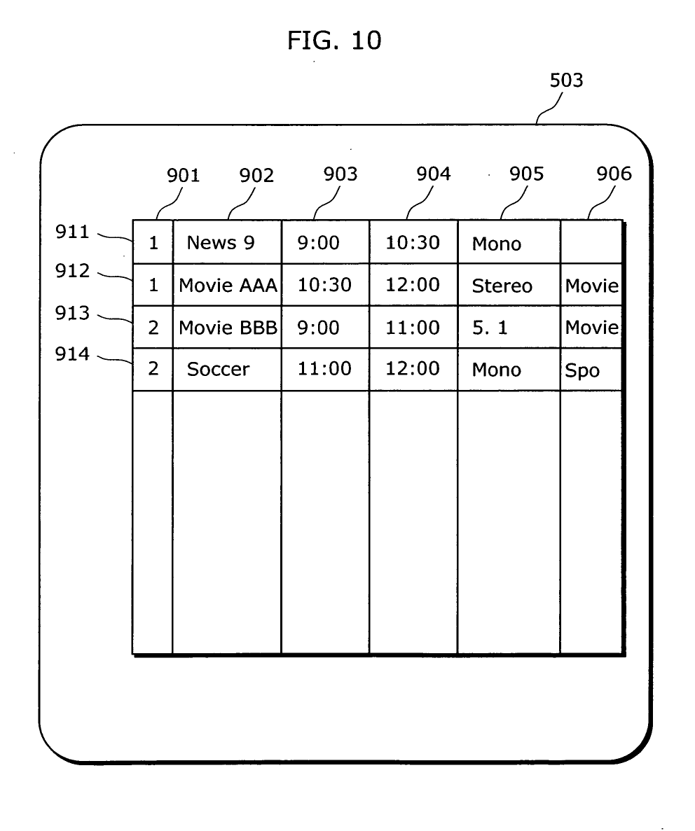

FIG. 10 is a diagram showing an example of TV-program information stored in the second memory 503 according to the second embodiment of the present invention. The TV-program information is stored in tabular form. A column 901 describes the identifiers of channels. A column 902 describes TV-program names. A column 903 describes the broadcast start times of the TV-programs, and a column 904 describes the broadcast end times. A column 905 describes the sound type of the programs, and indicates mono sound, stereo sound, and 5.1 channel sound as “mono”, “stereo”, and “5.1”, respectively. A column 906 describes the type of the programs. A regular TV-program is described as an empty cell, a movie is described as “movie”, and a sports program is described as “spo”. Each of rows 911 to 914 describes information for one TV-program. In this example, one TV-program information is the set of the channel identifier, channel name, broadcast start time, broadcast end time, and TV-program sound type. For example, the row 911 describes a set which includes “1” as the channel identifier, “News 9” as the TV-program name, “9:00” as the broadcast start time, “10:30” as the broadcast end time, “mono” as the sound-type, and “regular” as the TV-program type.

The reproduction unit 702b reproduces a channel using the received identifier of the channel. In other words, it reproduces the video and audio making up the channel. The relationship between channel identifiers and channels is pre-stored in the second memory 503 as channel information.

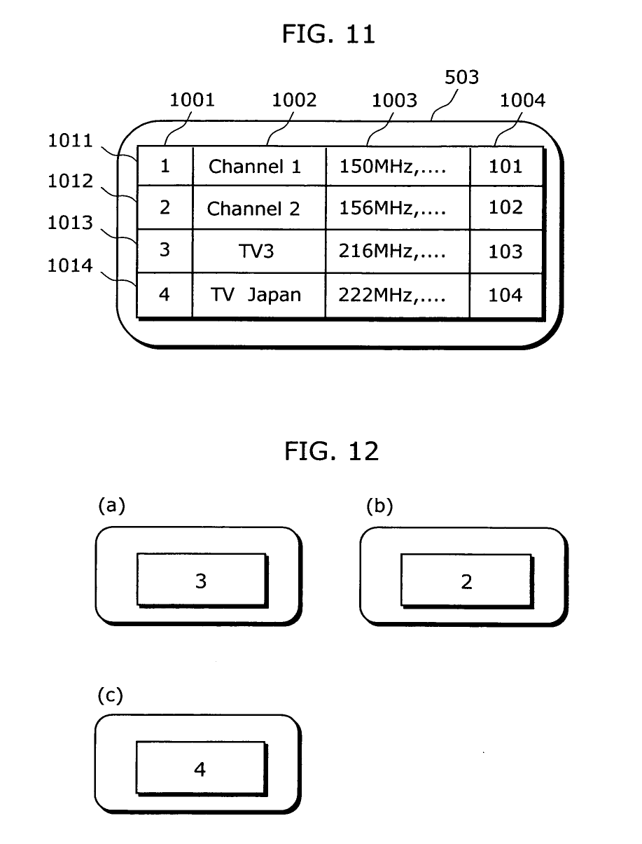

FIG. 11 is a diagram showing an example of channel information stored in the second memory 503 according to the second embodiment of the present invention. The channel information is stored in tabular form. A column 1001 describes the identifiers of channels. A column 1002 describes channel names. A column 1003 describes tuning information. Here, the tuning information is represented by values to be provided to the receiving unit 504, such as a frequency, transmission rate, and coding ratio. A column 1004 describes program numbers. Program numbers are numbers used to identify PMTs defined by the MPEG-2 standard. A description about PMT is given later. Each of rows 1011 to 1014 indicates a set of the identifier, channel name, and tuning information of each channel. The row 1011 describes a set that includes “1” as an identifier, “Channel I” as a channel name, a frequency of “150 MHz” as tuning information, and “101” as a program number. The reproduction unit 702b passes the identifier of the received channel directly to the service manager in order to reproduce the channel.

Moreover, when the user presses down the up-cursor 601 or the down-cursor 602 on the front panel 600 while the reproduction is taking place, the reproduction unit 702b receives a notification about such pressing from the input unit 501 through the CPU 512, and changes the channel being reproduced accordingly. When the up-cursor 601 is pressed down, a channel having the next lower channel identifier to that of the currently-reproduced channel is reproduced, and when the down-cursor 602 is pressed down, a channel having the next higher channel identifier to that of the currently-reproduced channel is reproduced. First, the reproduction unit 702b stores, in the second memory 503, the identifier of the channel that is currently reproduced.

FIG. 12(a), (b), and (c) is an example of information each indicating an identifier of a channel stored in the second memory 503 according to the second embodiment of the present invention. FIG. 12(a) shows that an identifier “3” is stored, and by referring to FIG. 11, it is shown that a channel having the channel name “TV 3” is currently being reproduced. When the user presses down the up-cursor 601 in a state illustrated in FIG. 12(a), the reproduction unit 702b refers to the channel information shown in FIG. 11, and passes the identifier “2” of a channel with the channel name of “Channel 2” to the service manager in order to switch reproduction to the channel with the channel name of “Channel 2” which is the channel having an identifier that is one value lower than that of the channel currently being reproduced in the table. At the same time, the reproduction unit 702b rewrites the identifier stored in the second memory 503 to the channel identifier “2”. FIG. 12(b) shows the state in which the channel identifier has been rewritten. When the user presses down the down-cursor 602 in a state illustrated in FIG. 12(a), the reproduction unit 702b refers to the channel information shown in FIG. 11, and passes the identifier “4” of a channel with the channel name of “TV Japan” to the service manager in order to switch reproduction to the channel with the channel name of “TV Japan” which is the channel having an identifier that is one value higher than that of the channel currently being reproduced in the table. At the same time, the reproduction unit 702b rewrites the identifier stored in the second memory 503 to the channel identifier “4”. FIG. 12(c) shows the state in which the channel identifier has been rewritten. The channel identifier is saved even when power to the broadcast receiving apparatus 102 is cut-off since it is stored in the second memory 503.

Furthermore, upon being activated when power to the broadcast receiving apparatus 102 is turned on, the reproduction unit 702b reads the channel identifier stored in the second memory 503. Then, the reproduction unit 702b passes such channel identifier to the service manager. Thus, when power is turned on, the broadcast receiving apparatus 102 is able to start the reproduction of the last channel that has been reproduced during its previous operation.

The Java VM 703 is a Java virtual machine that sequentially analyzes and executes programs written in the Java™ language. Programs written in the Java language are compiled into intermediate codes known as byte codes which are not dependent on hardware. A Java virtual machine is an interpreter that executes such byte code. Some Java virtual machines pass the byte code to the CPU 512 after translating the byte code into an execution format which can be interpreted by the CPU 512, and execute it. The Java VM 703 is activated, with a Java program to be executed being specified by the kernel 7011a. In the present embodiment, the kernel 701a specifies the service manager 704 as the Java program to be executed. Details of the Java language are described in many publications such as “Java Language Specification (ISBN 0-201-63451-1)”. Here, such details are omitted. Furthermore, the detailed operation of the Java VM itself is described in many publications such as “Java Virtual Machine Specification (ISBN 0-201-63451-X)”. Here, such details are omitted.

The service manager 704, which is a Java program written in the Java language, is sequentially executed by the Java VM 703. It is possible for the service manager 704 to call and be called by another subprogram not written in the Java language, through the Java Native Interface (JNI). The JNI is also described in many publications such as in the book “Java Native Interface” and so on. Here, such details are omitted.

The service manager 704 accepts the identifier of a channel from the reproduction unit 702b, through the JNI.

The service manager 704 first passes the identifier of the channel to the Tuner 705c in the library 705, and requests for tuning. The Tuner 705c refers to the channel information stored in the second memory 503, and obtains the tuning information. Now, when the service manager 704 passes the identifier “2” of the channel to the Tuner 705c, the Tuner 705c refers to the column 1012 shown in FIG. 11, and obtains the corresponding tuning information “156 MHz”. The Tuner 705c passes the tuning information to the receiving unit 504 through the tuner 701b1 of the library 701b of the OS 701. The receiving unit 504 performs demodulation on the signal transmitted from the broadcast station, based on the provided tuning information, and passes the result to the demultiplex unit 505.

The service manager 704 requests the CA 705d inside the Java library 705 to perform descrambling. The CA 705d provides the descrambler 506 with information required for descrambling, through the condition-release 701b2 of the library 701b in the OS 701. On the basis of such provided information, the descrambler 506 decodes the signal provided by the receiving unit 504, and passes the result to the TS decoder 507.

A case where video and audio are reproduced by outputting the video and audio from the video output unit 508 and the audio output unit 509, respectively and a case where multimedia data is outputted from the network unit 511 are to be described individually, since each processing is different.

First, the case where video and audio are reproduced is to be described.

The service manager 704 provides the identifier of the channel to the JMF 705a inside the Java library 705, and requests for the reproduction of the video and audio.

First, the JMF 705a obtains, from a PAT and a PMT, packet IDs used to specify the video and audio to be reproduced. PAT and PMT are tables stipulated by the MPEG-2 standard that show the TV-program line-up included in an MPEG-2 transport stream. PAT and PMT are embedded in the payloads in packets included in an MPEG-2 transport stream, and sent together with audio and video. Refer to the Specification for details. Here, only the outline shall be described. PAT, which is an abbreviation of Program Association Table, is stored and sent in packets with the packet ID “0”. In order to obtain the PAT, the JMF 705a specifies, to the demultiplex unit 505, the packet ID “0”, through the library 701b of the OS 701. The demultiplex unit 505 performs filtering based on the packet ID “0” and, by passing the result to the CPU 512, the JMF 705a collects the PAT packets.

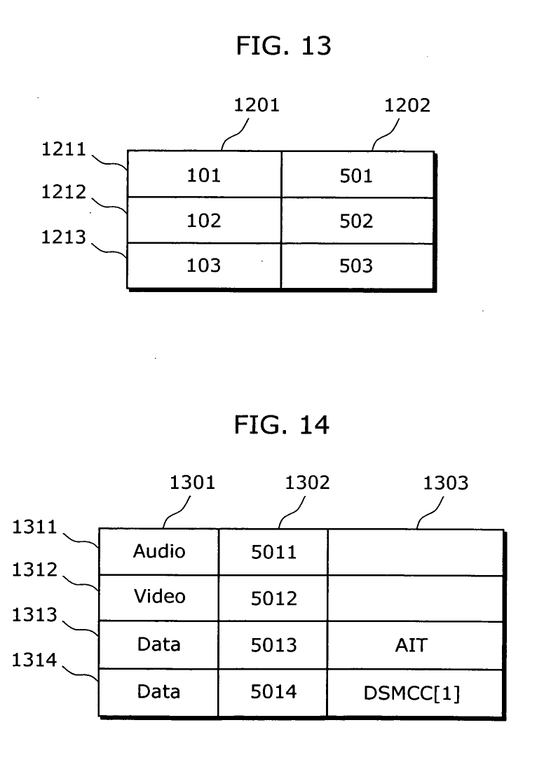

FIG. 13 schematically shows an example of the collected PAT information. A column 1201 describes program numbers. A column 1202 describes packet IDs. The packet IDs shown in the column 1202 are used to obtain the PMT. Each of rows 1211 to 1213 is a pair of the program number of a channel and a corresponding packet ID. Here, three channels are defined. The row 1211 defines a pair of the program number “101” and the packet ID “501”. Now, when the channel identifier provided to the JMF 705a is “2”, the JMF 705a refers to the column 1012 in FIG. 11, so as to obtain the corresponding program number “102”, and then refers to the column 1212 in the PAT shown in FIG. 13, so as to obtain the packet ID “502” corresponding to the program number “102”. PMT, which is an abbreviation of Program Map Table, is stored and sent in packets of the packet ID stipulated in the PAT. In order to obtain the PMT, the JMF 705a specifies, to the demultiplex unit 505, a packet ID, through the library 701b of the OS 701. Here, it is assumed that the packet ID specified is “502”. The demultiplex unit 505 performs filtering based on the packet ID “502”, and by passing the result to the CPU 512, the JMF 705a collects the PMT packets.

FIG. 14 schematically shows an example of the collected PMT information. A column 1301 describes stream types. A column 1302 describes packet IDs. Information specified in the respective stream types is stored and sent in the payloads of packets with the packet IDs specified in the column 1302. A column 1303 describes supplementary information. Each of columns 1311 to 1314 is a pair of a packet ID and the type of information being transmitted, which is known as an elementary stream. The column 1311, which is a pair of the stream type “audio” and the packet ID “5011”, indicates that audio data is stored in the payload of the packet with the packet ID “5011”. The JMF 705a obtains, from the PMT, the packet IDs of the video and audio to be reproduced. Referring to FIG. 14, the JMF 705a obtains the audio packet ID “5011” from the row 1311, and the video packet ID “5012” from the row 1312.

Next, the JMF 705a passes the obtained audio packet ID and video packet ID to the AV reproduction 701b3 of the library 701b of the OS 701. Upon receiving this, the AV reproduction 701b3 provides the received audio packet ID and video packet ID to the TS decoder 507. The TS decoder 505 performs filtering based on such provided packet IDs. Here, the packet with the packet ID “5011” is passed to the audio output unit 509, and the packet with the packet ID “5012” is passed to the video output unit 508. Then, the audio output unit 509 converts (for example, digital-analog conversion) the provided packet, as necessary, and output this. The video output unit 508 converts (for example, digital-analog conversion) the provided packet, as necessary, and outputs this.

Finally, the service manager 704 provides the identifier of the channel to the AM 705b inside the Java library 705, and requests for data broadcast reproduction. Here, data broadcast reproduction refers to extracting a Java program included in the MPEG-2 transport stream, and having it executed by the Java VM 703. As a method of embedding a Java program into an MPEG-2 transport stream, a method referred to as DSMCC, which is described in the MPEG Standard ISO/IEC 13818-6, is being used. Here, detailed description of DSMCC shall be omitted. The DSMCC format defines a method of encoding, in packets within an MPEG-2 transport stream, a file system made up of directories and files used by a computer. Furthermore, information about the Java program to be executed is embedded and sent in packets in the MPEG-2 transport stream in a format referred to as AIT. AIT is an abbreviation of Application Information Table defined in the 10th chapter of the DVB-MHP Standard (formally as, ETSI TS 101 812 DVB-MHP Specification V1.0.2).

First, in order to obtain the AIT, the AM 705b obtains the PAT and PMT as in the case of the JMF 705a, so as to obtain the packet ID of the packet that stores the AIT. Now, when “2” is the identifier of the provided channel and the PAT shown in FIG. 13 and the PMT shown in FIG. 14 are being transmitted, the AM 705b obtains the PMT shown in FIG. 14 according to the same procedure followed by the JMF 705a. The AM 705b extracts, from the PMT, the packet ID of the elementary stream having a stream type of “Data” and which has “AIT” as supplementary information. With reference to FIG. 14, the elementary stream in the row 1313 corresponds to such elementary stream, and therefore the AM 705b obtains the packet ID “5013” from it.

The AM 705b provides the packet ID of the AIT to the demultiplex unit 505, through the library 701b of the OS 701. The demultiplex unit 505 performs filtering based on such provided packet ID, and passes the result to the CPU 512. As a result, the AM 705b can collect the packets of AIT.

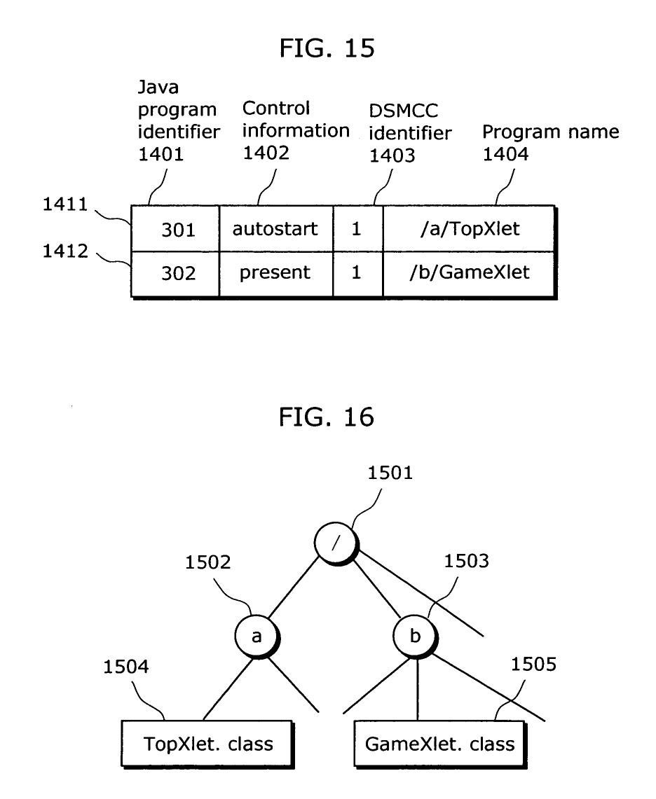

FIG. 15 schematically shows an example of the collected AIT information. A column 1401 describes the identifiers of Java programs. A column 1402 describes control information of the Java programs. The control information includes “autostart”, “present”, and “kill”. “autostart” means that the broadcast receiving apparatus 102 automatically executes the program promptly. “present” means that the program is not executed automatically. “kill” means that the program is to be terminated. A column 1403 describes DSMCC identifiers for extracting packet IDs including a Java program in the DSMCC format. A column 1404 describes program names of the Java programs. Each of rows 1411 and 1412 is a set of information about a Java program. The Java program defined in the row 1411 is a set of an identifier “301”, control information “autostart”, a DSMCC identifier “1”, and a program name “a/TopXlet”. The Java program defined in the row 1412 is a set of an identifier “302”, control information “present”, a DSMCC identifier “1”, and a program name “b/GameXlet”. Here, the two Java programs have the same DSMCC identifier which indicates that two Java programs are included within a single file system encoded in the DSMCC format. Here, although only four items of information are stipulated for the respective Java programs, more items of information are specified actually. Refer to the DVB-MHP standard for details.

The AM 705b finds the “autostart” Java program from within the AIT, and extracts the corresponding DSMCC identifier and Java program name. Referring to FIG. 15, the AM 705b extracts the Java program in the row 1411, and obtains the DSMCC identifier “1” and the Java program name “a/TopXlet”.

Next, using the DSMCC identifier obtained from the AIT, the AM 705b obtains, from the PMT, the packet ID of packets that store Java programs in the DSMCC format. More specifically, the AM 705b obtains, from the PMT, the packet ID of the elementary stream whose stream type is “Data” and having a matching DSMCC identifier in the supplementary information.

Now, assuming that such DSMCC identifier is “1” and the PMT is that shown in FIG. 14, the elementary stream in the row 1314 matches, and the packet ID “5014” is to be extracted.

The AM 705b provides the demultiplex unit 505 with the packet ID of the packet in which data is embedded in the DSMCC format, through the library 701b of the OS 701. Here, the packet ID “5014” is provided. The demultiplex unit 505 performs filtering based on such provided packet ID, and passes the result to the CPU 512. As a result, the AM 705b can collect the required packets. The AM 705b reconstructs the file system from the collected packets, according to the DSMCC format, and stores this in the first memory 502 or the second memory 503. Extracting the data such as a file system and the like, and storing this in the first memory 502 or the second memory 503 shall hereafter be referred to as download.

FIG. 16 shows an example of a downloaded file system. In FIG. 16, a circle denotes a directory and a square denotes a file. 1501 denotes a root directory, 1502 denotes a directory “a”, 1503 denotes a directory “b”, 1504 denotes a file “TopXlet.class”, and 1505 denotes a file “GameXlet.class”.

Here, although an example of downloading a file system from an MPEG2 transport stream is described, the OCAP specification also stipulates downloading using an IP network, and so on. Furthermore, the OCAP specification also stipulates a method for identifying the location of a file system using information referred to as XAIT, instead of AIT, and a method for downloading the file system.

Next, the AM 705b passes, to the Java VM 703, the Java program to be executed from within the file system downloaded into the first memory 502 or the second memory 503. Here, when the name of the Java program to be executed is “a/TopXlet”, the file “a/TopXlet.class”, having “.class” added to the end of the Java program name, is the file to be executed. “/” is a division of a directory and file name and, by referring to FIG. 16, the file 1504 is the Java program to be executed. Next, the AM 705b passes the file 1504 to the Java VM 703.

The Java VM 703 executes the Java program passed to it.

Next, the process of outputting multimedia data from the network unit 511 is to be described.

First, the service manager 704 provides the identifier of the channel to the network library 705e inside the Java library 705, and requests for transmitting the data. The network library 705e first obtains the PAT and PMT in the same manner as the JMF 705a and AM 705b, and obtains packet IDs for the video data, audio data, and respective section data relating to the TV-program to be transmitted. Now, when “2” is the identifier of the provided channel, and the PAT shown in FIG. 12 and the PMT shown in FIG. 14 are being transmitted, the AM 705b obtains the PMT shown in FIG. 14 according to the same procedure followed by the JMF 705a. The data to be transmitted are all the data described in the PMT in FIG. 14.

The network library 705e provides these packet IDs to the TS decoder 507 via the library 701b of the OS 701 and causes these to be outputted to the TS multiplexer 510. The TS decoder 507 performs filtering based on such provided packet IDs, and passes the result to the TS multiplexer 510.

The network library 705e provides, to the TS multiplexer 510 through the library 701b of the OS 701, the number of types of data to be transmitted, and causes the configuration of an MPEG2 transport stream from the data passed on from the TS decoder 507. The TS multiplexer 510 passes the configured MPEG2 transport stream to the CPU.

In addition, the network library 705e provides the address of the transmission destination to the NET 701b4 of the library 701b of the OS 701. Next, the network library 705e converts the MPEG-2 transport stream received from the TS multiplexer 510 into a format that is in accordance with the protocol of the application layer to be transmitted, and passes this sequentially to the NET 701b4. An application layer protocol refers to, for example, HTTP, RTP, and so on. With this, the NET 701b4 refers to the transmission destination address, and converts the data passed on to it into IP network packets and passes these to the network unit 511. The network unit 511 converts the data passed on to it into a signal that is in accordance with the physical media of the connected network, and outputs this signal.

Upon receiving an identifier of an other channel, the service manager 704 stops the execution or the output to the network, though the respective libraries included in the Java library 705, of the video/audio and Java program currently being reproduced likewise through the respective libraries included in the Java library 705, and performs the reproduction of video/audio, and execution of a Java program or the output of the Java program to the network, based on the newly received channel identifier.

Furthermore, the service manager 704 also includes a function for receiving the identifier of a channel from a Java program executed on the Java VM 703, aside from the reproduction unit 702b. Specifically, a Java language class for obtaining the identifier of the channel, and the method thereof, are provided. Upon receiving an identifier of an other channel, the service manager 704 stops the execution or the output to the network, though the respective libraries included in the Java library 705, of the video/audio and Java program currently being reproduced likewise through the respective libraries included in the Java library 705, and performs the reproduction of video/audio, and execution of a Java program or the output of the Java program to the network, based on the newly received channel identifier.

Furthermore, although the reproduction or output to the network, of a general TV-program is described above, the same processing is performed on a VoD service.

The Java library 705 is a collection of plural Java libraries stored in the second memory 503. In the present embodiment, the Java library 705 includes the JMF 705a, the AM 705b, the Tuner 705c, the CA 705d, the network library 705e, a reproduction Lib 705f, an IO 705g, an AWT 705h, and the like.

The functions of the JMF 705a, the AM 705b, the Tuner 705c, and the CA 705d have already been described, and thus the description is omitted. The reproduction Lib 705f provides the class and method of the Java language (hereafter called Java API) for passing, to the Java program, the identifier of the channel currently being reproduced, which is stored in the second memory 503. By using this Java API, the Java program is able to recognize the channel that is currently being reproduced.

The IO 705g provides, to the Java program, Java APIs for the writing of data in the second memory 503 by the Java program, or a Java API for the reading of such data which has been written, from the second memory 503. By using this API, the Java program is able to store arbitrary data in the secondary memory 503. Since such stored data is not erased even when power to the broadcast receiving apparatus 102 is turned off, the data can be read again after power to the broadcast receiving apparatus 102 is turned on.

The AWT 705h provides Java APIs for drawing or for the reception of a key input notification from the input unit 501, by the Java program. To be more specific, these correspond to the java.awt package, java.awt.event package, and other java.awt subpackages described in “The Java class Libraries Second Edition, Volume 2” (ISBN0-201-31003-1). Here, the detailed description shall be omitted.

The SI 705i provides Java APIs for the obtaining of channel information and electronic program information by the Java program. To be more specific, there are the Java TV Specification and the like. Furthermore, the MPEG section filter API for obtaining raw binary data from an MPEG-2 transport stream currently being broadcast is defined in the OCAP Specification, and the Java application program can understand and handle unique electronic program data that has been transmitted.

The network library 705e communicates with the video storing apparatuses 103 and 104, and the terminals 105 and 106 which are connected to the network 107, through the NET 701b4 of the library 701b of the OS 701. Furthermore, between the network library 705e and the video storing apparatuses 103 and 104, following communication is performed for: transmitting and receiving the attributes of the video storing apparatuses; transmitting a request for storing multimedia data and the multimedia data; inquiring whether or not particular multimedia data is stored; requesting transmission of the stored multimedia data; and right processing following the use of the multimedia data. Furthermore, between the network library 705e and the terminals 105 and 106, following processing is performed: accepting a request for transmitting multimedia data; and transmitting the multimedia data or notifying a video storing apparatus to which the multimedia data is transmitted.

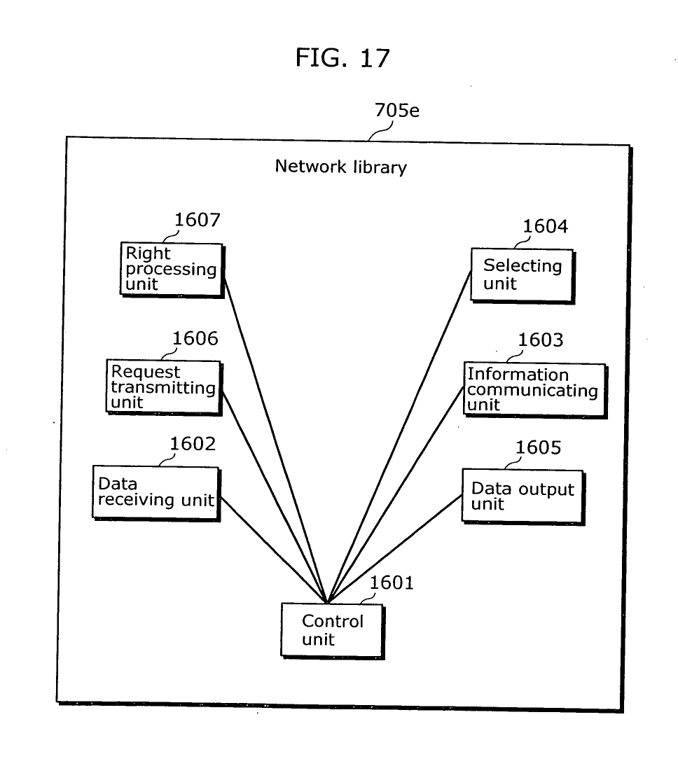

FIG. 17 is a block diagram showing an example of an internal configuration of the network library 705e according to the second embodiment of the present invention. The network library 705e includes a control unit 1601, a data receiving unit 1602, an information communicating unit 1603, a selecting unit 1604, a data output unit 1605, a request transmitting unit 1606, and a right processing unit 1607. Note that the network library 705e may include other functions relating to the IP network.

The control unit 1601 provides, to a downloaded Java application program, the functions which the network library 705e implements. In other words, the Java application can execute network functions by calling the Java APIs provided by the control unit 1601. When the Java API is called, the control unit 1601 performs processes using the data receiving unit 1602, the information communicating unit 1603, the selecting unit 1604, the data output unit 1605, the request transmitting unit 1606, the right processing unit 1607, and the rest of the Java library 705 and the library 701b of the OS 701, as necessary.

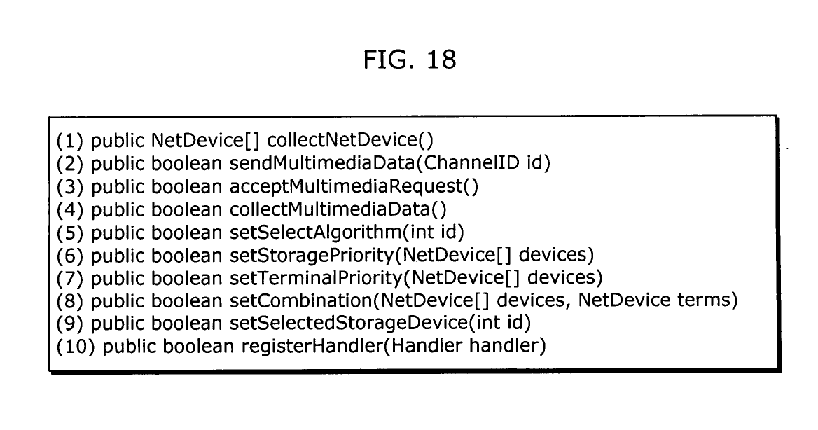

FIG. 18 is a diagram showing an example of Java APIs provided by the control unit 1601 according to the second embodiment of the present invention. The method collectNetDevice( ) in FIG. 18 (1) collects information on an external device connected to the network 107, and returns, as such information, the array of NetDevice objects. More specifically, the control unit 1601 calls the method connectNetDevice( ) of the information communicating unit 1603 to be described later, and returns the return value. With this method, it is possible to obtain information on the device connected to the network.

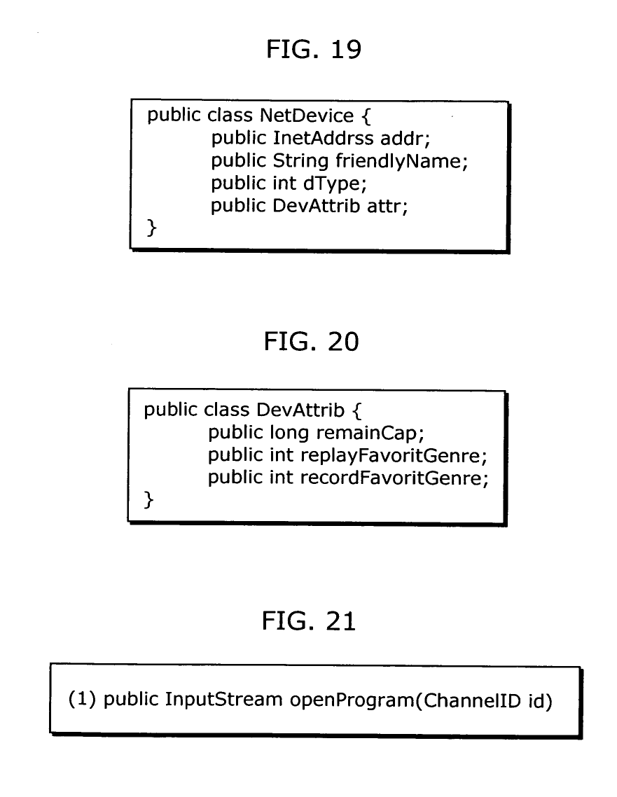

FIG. 19 shows an example of the structure of a NetDevice class. In FIG. 19, addr represents the network address of the device, friendlyName represents the nickname given to the device, dType represents the type of the device, 0 represents the broadcast receiving apparatus, 1 represents the video storing apparatus, and 2 represents the terminal in the present invention. Since such information can be carried out according to the method defined in UPnP DA, the detailed description shall be omitted. Furthermore, attr is an object of a DevAttrib class and represents the attributes of a video storing apparatus.

FIG. 20 shows an example of the structure of the DevAttrib class. In FIG. 20, remainCap represents the capacity of free space in which multimedia data is stored, replayFavoritGenre represents a genre having the highest use frequency from among the contents reproduced or outputted to a network, such as 0 indicating a movie and 1 indicating a sport. recordFavoritGenre represents a genre having the highest use frequency from among the contents recorded by the user's operation.

The method sendMultimediaData( ) in FIG. 18 (2) specifies an identifier of a channel for transmitting multimedia data to the video storing apparatus 103 or 104. When successful, it returns true, and in the case of failure, it returns false.

The method acceptMultimediaRequest( ) in FIG. 18 (3), upon being called, first activates a new process or a new thread and continues to operate on the new process or the new thread. The method accepts a request for transmitting multimedia data from the terminal, and checks whether or not the video storing apparatus 103 or 104 stores the multimedia data. When the data is stored, it issues a request for transmitting the data from the video storing apparatus to the terminal, the terminal that issues the request is notified of information indicating that the multimedia data is to be transmitted from the video storing apparatus, and when the data is not stored, it receives the multimedia data from a broadcast station and transmits the data to the terminal. For the normal end, true is returned, and for the abnormal end, false is returned. Note that it is possible to end the operation once a single request is accepted, without continuing to operate.

These methods are to be described in details later, since such methods use the APIs of the data receiving unit 1602, the information communicating unit 1603, the selecting unit 1604, the data output unit 1605, the request transmitting unit 1606, and the right processing unit 1607.

The method collectMultimediaData( ) in FIG. 18 (4) retrieves for multimedia contents provided by the VoD service using the Java library 705, receives the part of or entire of the data by requesting the service manager 704, and transmits the data to the video storing apparatus by calling the method sendMultimediaData( ). When successful, it returns true, and in the case of failure, it returns false.

The method setSelectAlgorithm( ) in FIG. 18 (5) sets an algorithm used when the selecting unit 1604 selects a video storing apparatus to be an algorithm provided by the argument id. When successful, it returns true, and in the case of failure, it returns false. The value of id and each algorithm are defined in advance. The present method is carried out by calling the method setSelectAlgorithm( ) used by the selecting unit 1604.

The method setStoragePriority( ) in FIG. 18 (6) sets a priority of a video storing apparatus when the selecting unit 1604 selects a video storing apparatus based on the priority, and the priority becomes high in order of the array represented by the argument devices. When successful, it returns true, and in the case of failure, it returns false. The present method is carried out by calling the method setStoragePriority( ) provided by the selecting unit 1604. Note that the present method may be set, using an array of a pair of a video storing apparatus and its priority as an argument.

The method setTerminalPriority( ) in FIG. 18 (7) sets a priority of a terminal when the selecting unit 1604 selects a video storing apparatus based on the priority of the terminal, and the priority becomes high in order of the array represented by the argument devices. When successful, it returns true, and in the case of failure, it returns false. The present method is carried out by calling the method setTerminalPriority( ) provided by the selecting unit 1604. Note that the present method may be set, using an array of a pair of a terminal and a value of its priority as an argument.

The method setCombination( ) in FIG. 18 (8) sets a pair of a video storing apparatus and a terminal, when the selecting unit 1604 selects a video storing apparatus based on the priority of the terminal. The pair is set in each array having the same index by providing the argument devices with the video storing apparatus and the argument terms with the terminal. The present method is carried out by calling the setCombination( ) provided by the selecting unit 1604.

The method setSelectedStorageDevice( ) in FIG. 18 (9) sets the video storing apparatus having the index provided by the argument id to be the selected video storing apparatus. Since the present method is carried out by calling the method setSelectedStorageDevice( ) provided by the selecting unit 1604, the details is to be described later.

The method registerHandler( ) in FIG. 18 (10) registers, into the system, a handler which is provided through an argument handler, and returns true when successful and false in the case of a failure. By registering the handler, the Java application program can receive a callback from the network library 705e.

The data receiving unit 1602: controls the TS decoder 507 and the TS multiplexer 510 of the broadcast receiving apparatus 102 through the library 701 of the OS 701; configures, as a MPEG2 transport stream, the video, audio, and the section data in each of which filtering has been performed using the TS decoder 507; and reads the configured MPEG2 transport stream.

The data receiving unit 1602 provides Java APIs to the control unit 1601 and the downloaded Java application program.

FIG. 21 is a diagram showing an example of Java APIs provided by the data receiving unit 1602 according to the second embodiment of the present invention.

The method openprogram( ) in FIG. 21 (1) returns an object of Input Stream that reads the MPEG2 transport stream configured by the TS multiplexer 510 based on the identifier of the channel specified by the argument. Note that it returns null in the case of failure.

The information communicating unit 1603 controls the network unit 511 of the broadcast receiving apparatus 102 through the NET701b4 of the library 701b of the OS 701, and receives and transmits a message to and from the specified external device that is connected to the network 107.

The information communicating unit 1603 provides Java APIs to the control unit 1601 and the downloaded Java application program.

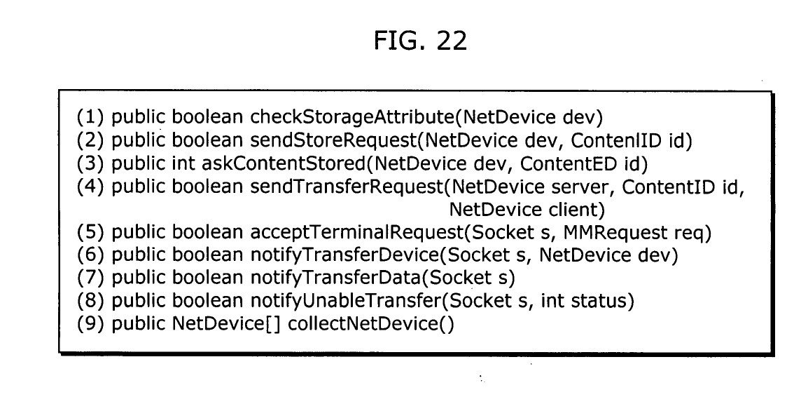

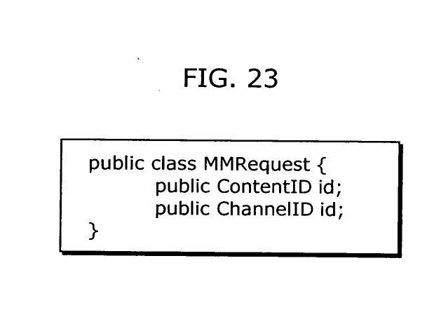

FIG. 22 is a diagram showing an example of the Java APIs provided by the information communicating unit 1603 according to the second embodiment of the present invention. The method checkStorageAttribute( ) in FIG. 22 (1) transmits a request for transmitting attributes to a video storing apparatus specified by an argument, receives the reply, and sets the requested attribute as the object of the NetDevice class indicated by the argument dev. When successful, it returns true, and in the case of failure, it returns false. The method sendStoreRequest( ) in FIG. 22 (2) transmits a request for storing data to the video storing apparatus specified by the argument dev, and receives the reply. When successful, it returns true, and in the case of communication failure or rejection of the request, it returns false. The argument id is an identifier of the multimedia data issued by the control unit 1601, and is transmitted to a video storing apparatus with the transmission request. The method askContentStored( ) in FIG. 22 (3) transmits an inquiry to the video storing apparatus specified by the argument dev about whether or not the multimedia data specified by the argument id is stored, and receives the reply. When receiving a reply indicating that the data is stored, it returns true, and when receiving a reply indicating that the data is not stored or in the case of communication failure, it returns false. The method sendTransferRequest( ) in FIG. 22 (4) transmits, to the video storing apparatus specified by the argument server, a request for transmitting the multimedia data specified by the argument id to the terminal specified by the argument client, and receives the reply. When receiving OK, it returns true, and when receiving NG or in the case of communication failure, it returns false. The method acceptTerminalRequest( ) in FIG. 22 (5) receives a request from the terminal connected using the Socket object specified by the argument s, and stores the identifier of the multimedia data of which the terminal requests the transmission to the argument req. When successful, it returns true, and in the case of failure, it returns false. FIG. 23 shows the structure of an MMRequest class. The method notifyTransferDevice( ) in FIG. 22 (6) notifies the terminal connected using the Socket object specified by the argument s of information indicating that the multimedia data is to be transmitted from the video storing apparatus specified by the argument dev, through the Socket object. When successful, it returns true, and in the case of failure, it returns false. The method notifyTransferDevice( ) in FIG. 22 (7) notifies the terminal connected using the Socket object specified by the argument s of information indicating that the multimedia data is to be transmitted from the broadcast receiving apparatus 102, through the Socket object. The method notifyUnableTransfer( ) in FIG. 22 (8) notifies the terminal connected using the Socket object specified by the argument s of information indicating that the requested multimedia data can not be transmitted due to a reason represented by the argument status, through the Socket object. When successful, it returns true, and in the case of failure, it returns false. The method collectNetDevice( ) in FIG. 22 (9) collects information on external devices connected to the network 107, and returns, as such information, the array of NetDevice objects. Since this processing can be carried out according to the method defined in UPnP DA, the detailed description shall be omitted.

The selecting unit 1604 selects one of the video storing apparatuses connected to the network 107, based on the attributes of the video storing apparatus, attributes of the multimedia data, and the like, in accordance with the set algorithm.

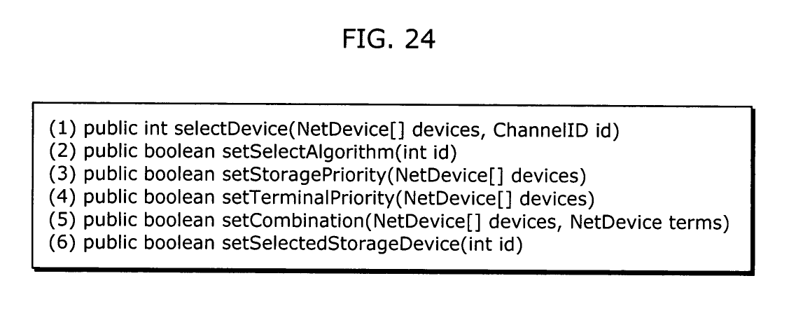

The selecting unit 1604 provides Java APIs to the control unit 1601 and the downloaded Java application program. FIG. 24 shows an example of Java APIs provided by the selecting unit 1604 according to the second embodiment of the present invention.

The method selectDevice( ) in FIG. 24 (1) selects one video storing apparatus, based on the attributes of the video storing apparatus stored in the argument devices and the attributes of the multimedia data that can be obtained by referring the identifier of the channel indicated by the argument id and the TV-program information stored in the second memory 503 shown in FIG. 10, from among the video storing apparatuses indicated by the argument devices, in accordance with the algorithm set in a method setAlgorithm( ) to be described later. When successful, it returns the selected video storing apparatus with its index in the array devices, and in the case of failure, it returns a negative value. The algorithms to be selected includes an algorithm for: selecting a video storing apparatus having a large space; selecting a video storing apparatus by allocating video storing apparatuses for each genre of multimedia data; selecting a video storing apparatus having a high frequency with which multimedia data categorized as the same genre as that of the multimedia data is recoded by the user's operation; selecting a video storing apparatus according to a priority of the video storing apparatus which is set by the method setStoragePriority( ) to be described later; selecting a terminal based on the priority of the terminal set by the method setTerminalPriority( ) to be described later, from the combinations of the terminals and video storing apparatuses set by the method setCombination( ) to be described later, and selecting the video storing apparatus combined with the selected terminal; or selecting the video storing apparatus specified by the method setSelectedStorageDevice( ) to be described later by informing, when there are plural video storing apparatuses, the Java application program with a callback function, providing the list to the user, and accepting inputs from the user.

The method setSelectAlgorithm( ) in FIG. 24 (2) sets an algorithm used when the selecting unit 1604 selects a video storing apparatus to be an algorithm provided by the argument id. When successful, it returns true, and in the case of failure, it returns false. The value of id and each algorithm are defined in advance.

The method setStoragePriority( ) in FIG. 24 (3) sets a priority of a video storing apparatus when the selecting unit 1604 selects a video storing apparatus based on the priority, and the priority becomes high in order of the array represented by the argument devices. When successful, it returns true, and in the case of failure, it returns false. Note that the present method may be set, using an array of a pair of a video storing apparatus and its priority as an argument.

The method setTerminalPriority( ) in FIG. 24 (4) sets a priority of a terminal when the selecting unit 1604 selects a terminal based on the priority of the terminal, and the priority becomes high in order of the array represented by the argument devices. When successful, it returns true, and in the case of failure, it returns false. Note that the present method may be set, using an array of a pair of a terminal and a value of its priority as an argument.

The method setCombination( ) in FIG. 24 (5) sets a pair of a video storing apparatus and a terminal when the selecting unit 1604 selects a video storing apparatus based on the priority of the terminal. The pair is set in each array having the same index by providing the argument devices with the video storing apparatus and the argument terms with the terminal.

The method setSelectedStorageDevice( ) in FIG. 24 (6) sets the video storing apparatus having the index provided by the argument id to be the selected video storing apparatus. The present method notifies the Java application program with the callback function, and is called by the Java application program that accepts the input of the user, when the method selectDevice( ) selects a video storing apparatus by the input of the user, using the set algorithm. The callback function is represented by, for example, Handler.notify(NetDevices[ ] devices,Object obj), assuming that the handler object of the Java application program is Handler. With this, the Java application program provides the user with the list of the video storing apparatuses given by the arguments, and accepts the input of the user. Since the index of the specified array devices is obtained from the accepted input, and the instances of the control unit 1601 or the selecting unit 1604 is given using the argument obj, the method setSelectedStorageDevice( ) is called and set. The aforementioned handler object Handler is registered by the method registerHandler( ) provided by the control unit 1601. Note that the selecting unit 1604 may have the same registerhandler( ) method and expose it to the Java application program.

The data output unit 1605 controls the network unit 511 of the broadcast receiving apparatus 102 through the NET70b4 of the library 701b of the OS 701, and transmits the multimedia data received by the data receiving unit 1602, to an external device that is connected to the network 107 and that has been specified.

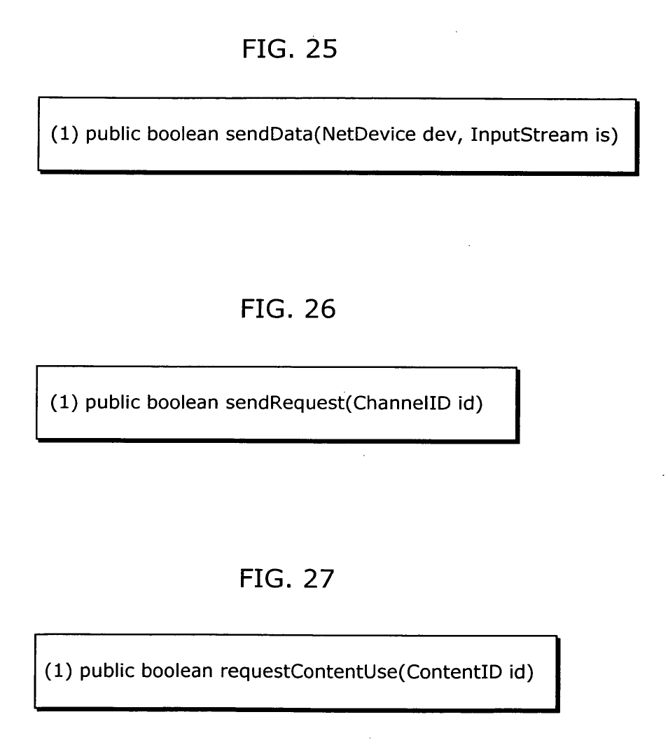

The data output unit 1605 provides Java APIs to the control unit 1601 and the downloaded Java application program. FIG. 25 shows an example of Java APIs provided by the data output unit 1605 according to the second embodiment of the present invention. The method sendData( ) in FIG. 25 (1) transmits, to a device which is specified by the argument dev and connected to the network 107, the data read from the Input Stream object specified by the argument is, until EOF is read from the argument is. When successful, it returns true, and in the case of failure, it returns false.

The request transmitting unit 1606 requests the service manager 704 to transmit multimedia data of the VoD service.

The request transmitting unit 1606 provides Java APIs to the control unit 1601 and the downloaded Java application program. FIG. 26 shows an example of Java APIs provided by the request transmitting unit 1606 according to the second embodiment of the present invention. The method sendRequest( ) in FIG. 26 (1) requests the service manager 704 to transmit the multimedia data specified by the argument id. When successful, it returns true, and in the case of failure, it returns false.

The right processing unit 1607 requests the service manager 704 to perform right processing following the use of multimedia data including billing. The right processing unit 1607 provides Java APIs to the control unit 1601 and the downloaded Java application program.

FIG. 27 shows an example of Java APIs provided by the right processing unit 1607 according to the second embodiment of the present invention. The method requestContentUse( ) in FIG. 27 (1) requests the service manager 704 to perform right processing on the content specified by the argument id, and when the use of the content is permitted, it returns true, and if not or in the case of the processing failure, it returns false.

The processing of the method sendMultimediaData( ) and the method acceptMultimediaRequest( ) provided by the control unit 1601 is to be described hereinafter.

First, the processing of the method sendMultimediaData( ) shall be described. Upon calling the sendMultimediaData( ), first, the method collectNetDevice( ) provided by the control unit 1601 searches for the video storing apparatuses connected to the network 107. Next, the method checkStorageAttribute( ) provided by the information communicating unit 1603 is called for each video storing apparatus so that the attributes of each video storing apparatus are checked. Next, the method selectDevice( ) provided by the selecting unit 1604 is called, so that a video storing apparatus is selected. Furthermore, an identifier that identifies this multimedia data is issued. By calling, for the selected video storing apparatus, the method sendStoreRequest( ) provided by the information communicating unit 1603, a storage request is transmitted together with the identifier of the multimedia data and TV-program information of the multimedia data. Next, calling the method openProgram( ) provided by the data receiving unit 1602, an Input Stream object is obtained that reads the multimedia data. Furthermore, calling the method sendData( ) provided by the data output unit 1605, the received multimedia data is transmitted to the selected video storing apparatus. When the processing is successful, the identifier of the issued multimedia data is stored in the second memory 503, together with the attributes of the multimedia data.

Note that after executing the collectNetDevice( ), these information may be stored in the second memory 503, and the information stored in the second memory 503 may be read after that.

Next, the processing of the method acceptMultimediaRequest( ) shall be described. The method acceptMultimediaRequest( ), upon being called, generates another new process or a new thread and operates on the new process or the new thread. First, it creates a Socket object that accepts a connection from a terminal, and waits for a connection request. Upon receiving the connection request from the terminal, the method acceptTerminalRequest( ) provided by the information communicating unit 1603 is called, and a request from the terminal is received. Next, the identifier of the requested multimedia data is identified based on the request from the terminal, or on the identifier of the channel received from the terminal and information stored in the second memory 503. Next, the video storing apparatus connected to the network is searched by calling the method collectNetDevice( ) provided by the control unit 1601, or based on the information stored in the second memory 503. Then, calling the method askContentStored( ) provided by the information communicating unit 1603 for each video storing apparatus, whether or not the video storing apparatus stores the multimedia data is inquired. When there is a video storing apparatus that stores the data, calling the method sendTransferRequest( ) provided by the information communicating unit 1603, a request for transmitting the multimedia data to the requested terminal is issued to the video storing apparatus. Note that the requested terminal is identified based on the Socket object through which the method communicates with the terminal, and a result of the method collectNetDevice( ) provided by the control unit 1601 or information stored in the second memory 503. Note that right processing is performed by calling the method requestContentUse( ) provided by the right processing unit 1607 as necessary. Next, the requested terminal is notified of the video storing apparatus that stores the data by calling the method notifyTransferDevice( ) provided by the information communicating unit 1603. Furthermore, when a video storing apparatus that stores the multimedia data is not found, a data transmission request is issued by calling the method sendRequest( ) provided by the request transmitting unit 1606. In the case where the sendRequest( ) returns false because the multimedia data is not transmitted from a broadcast station or can not be received due to a certain reason, the method notifyUnableTransfer( ) provided by the information communicating unit 1603 is called so as to notify that the data transmission to the terminal is not possible, and the system returns to a request waiting state. Furthermore, when sendRequest( ) returns true, the method notifyTransferData( ) provided by the information communicating unit 1603 is called so as to notify the terminal of information indicating that the multimedia data is to be transmitted from the broadcast receiving apparatus 102. Next, as in the aforementioned method sendMultimediaData( ), the multimedia data is transmitted to the terminal by calling the method openprogram( ) provided by the data receiving unit 1602, and then calling the method sendData( ) provided by the data output unit 1605. When the data transmission ends, the system returns to a connection request waiting state. Note that upon accepting a connection request, further, the system may generate another new thread or new process, operate on the new thread or the new process for the following processing, and the original thread or the process may return to a connection request waiting state. In this case, the processing on the thread or process ends without returning to the connection request waiting state.

With the aforementioned structure, the Java application program can transmit content data for a VoD service prior to the use, and store the data in a video storing apparatus. Note that the storage may be carried out at predetermined intervals, and at a date and time set by the user. Furthermore, the storage may be carried out at predetermined intervals set by the user. Furthermore, the storage may be carried out by the user's operation. Furthermore, the storage may be carried out according to an instruction from the broadcast station 108.

Next, the configuration of the video storing apparatuses 103 and 104 is to be described.

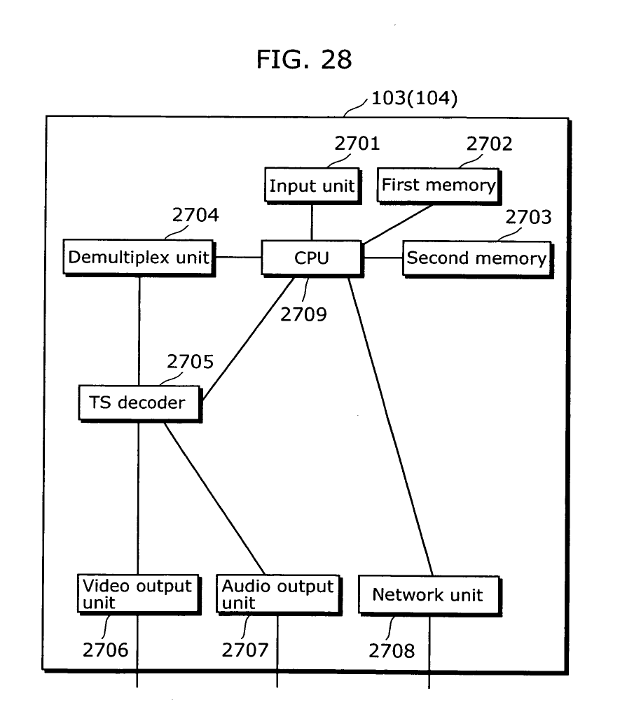

FIG. 28 is a block diagram showing a relationship between the constituent elements that compose the video storing apparatus 103 and 104 according to the second embodiment of the present invention. The video storing apparatuses 103 and 104 of the second embodiment includes an input unit 2701, a first memory 2702, a second memory 2703, a demultiplex unit 2704, a TS decoder 2705, a video output unit 2706, an audio output unit 2707, a network unit 2708, and a CPU 2709. Note that the video storing apparatuses 103 and 104 of the second embodiment not only store multimedia data but also reproduce the multimedia data received from the broadcast receiving apparatus 102 and the stored multimedia data by the user's operation.

The input unit 2701, the first memory 2702, and the second memory 2703 are the same as the input unit 501, the first memory 502, and the second memory 503 of the broadcast receiving apparatus 102 in the aforementioned second embodiment. Note that the video storing apparatuses 103 and 104 of the second embodiment store multimedia data in the second memory 2703. Furthermore, the video storing apparatuses 103 and 104 stores not only multimedia data but also TV-program information concurrently obtained from an EPG, such as the identifier, a title, a date and time to be broadcasted, and a broadcast channel of the multimedia data, as metadata.

The demultiplex unit 2704 receives the MPEG transport stream from the CPU 2709, extracts information specified by the CPU 2709, and passes the extracted information to the CPU 2709. In addition, the demultiplex unit 2704 passes the MPEG transport stream to the TS decoder 2705 as it is. The TS decoder 2705 receives identifiers of audio data and video data from the CPU 2709. In addition, the TS decoder 2705 extracts data corresponding to the received identifiers of audio data and video data, from the stream received from the demultiplex unit 2704. The TS decoder 2705 passes the extracted video data to the video output unit 2706, and the extracted audio data to the audio output unit 2707.

The video output unit 2706 and the audio output unit 2707 are the same as the video output unit 508 and the audio output unit 509 of the broadcast receiving apparatus 102 in the aforementioned present embodiment.

The network unit 2708, which includes a network interface, converts the data received from the CPU 2709 into a signal that is in accordance with the physical media of the network to which the network interface is connected, and outputs this signal. Furthermore, the network unit 2708 receives a signal from the network interface, converts the signal into a packet defined by the IP network, and passes the packet to the CPU 2709.

The CPU 2709 controls the demultiplex unit 2704, the TS decoder 2705, and the network unit 2708 by executing a program stored in the second memory 2703.

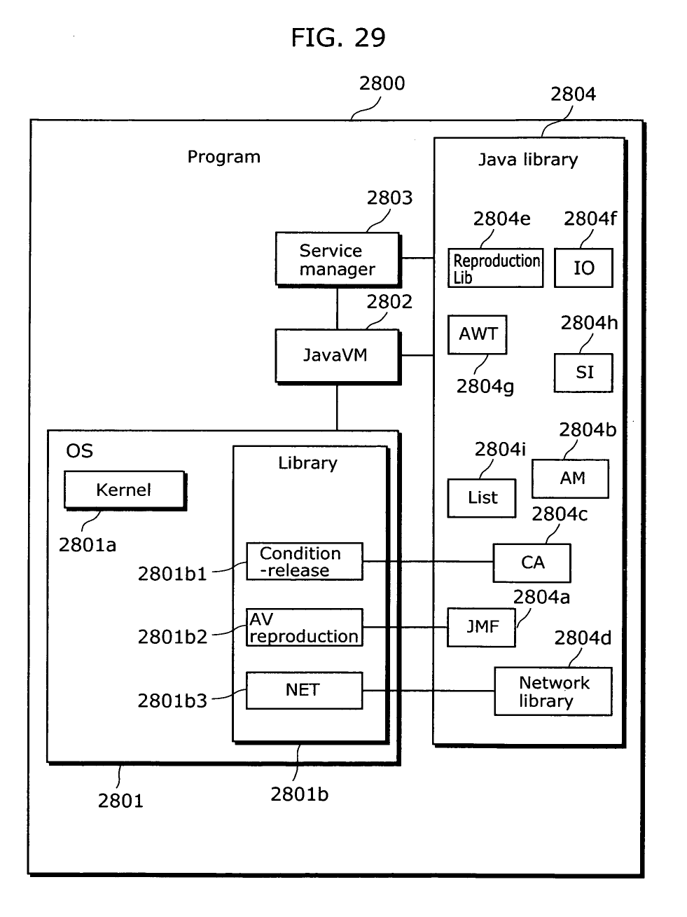

FIG. 29 is a structure diagram of a program to be held and executed by the video storing apparatus according to the second embodiment of the present invention. The diagram shows an example of a structure of the program stored in the second memory 2703 and executed by the CPU 2709.

The program 2800 is made up of plural subprograms, and specifically includes an OS 2801, a Java VM 2802, a service manager 2803, and a Java library 2804.

The OS 2801 is a subprogram activated on the CPU 2709 when power to the video storing apparatuses 103 and 104 are turned on. OS is the acronym of operating system, an example of which is Linux and the like. The OS 2801 is a generic name for publicly known technology made up of a kernel 2801a for executing a subprogram concurrently with another subprogram and of a library 2801b, and thus, the detailed description is omitted. In the present embodiment, the kernel 2801a of the OS 2801 executes the Java VM 2803 as subprograms. Furthermore, the library 2801b provides these subprograms with plural functions required for controlling the constituent elements of the video storing apparatuses 103 and 104.

In the present embodiment, the library 2801b includes a condition-release 2801b1, AV reproduction 2801b2, and NET 2801b3, as an example of functions.

The condition-release 2801b1 receives information from other subprograms or a CA 2804c of the Java library 2804, and permits the reproduction of the multimedia data received from the network and the multimedia data stored in the second memory 2703 by decrypting the encrypted data received from the network, and validating the AV reproduction 2801b2.

The AV reproduction 2801b2 receives an audio packet ID and a video packet ID from the other subprograms or a JMF 2804a of the Java library 2804. It then provides the received audio packet ID and video packet ID to the TS decoder 2705. As a result, the TS decoder 2705 performs filtering based on the provided packet IDs, and implements the reproduction of audio/video.

The NET 2801b3 creates packets of a protocol lower than the application layer defined by the IP network, for the data received from the other subprograms or a network library 2804d of the Java library 2804. A protocol lower than the application layer refers to, for example, a TCP packet, a UDP packet, an IP packet, and so on. By passing this to the network unit 2708, messages and data are transmitted to other devices via the network 107. Furthermore, when a message is received from other devices via the network 107, the NET 2801b3 converts the message to an application layer protocol packet and passes this to the other subprograms or the network library 2804d of the Java library 2804. An application layer protocol refers to, for example, HTTP, RTP, and so on.

The Java VM 2802 is the same as the Java VM 703 of the broadcast receiving apparatus 102 of the aforementioned first embodiment.

The service manager 2803 is the same as the service manager 704 of the broadcast receiving apparatus 102 of the aforementioned second embodiment except for the following different points. The service manager 704: receives a channel identifier from the reproduction unit 702b; passes the identifier to the Tuner 705c and causes the Tuner 705c to perform tuning; performs descrambling by requesting the CA 705d; and requests the reproduction of video and audio by providing the channel identifier to the JMF 705a. Whereas, the service manager 2803: receives the content identifier from a List 2804i inside the Java library 2804; passes the content identifier to the IO 2804f inside the Java library 2804; and reads the stream stored in the second memory 2703, or passes the content identifier as well as information on the apparatus storing such content identifier, and so on, to the network library 2804d and receives a stream from the apparatus; then requests for the reproduction of video and audio by providing the content identifier to the JMF 2804a inside the Java library 2804. The List 2804i shall be described later.

Furthermore, the service manager 2803 receives multimedia data from the broadcast receiving apparatus 102 and stores the multimedia data in the second memory 2703 by requesting the network library 2804d inside the Java library 2804 to wait for a storage request from the broadcast receiving apparatus 102 and to receive and store the data.

Furthermore, the service manager 2803 transmits, to the terminal, the multimedia data stored in the second memory 2703, by requesting the network library 2804d inside the Java library 2804 to transmit multimedia data from the broadcast receiving apparatus 102, to accept the data transmission request from the terminal 105 or 106, and to transmit data corresponding to the request.

The Java library 2804 is a collection of plural Java libraries stored in the second memory 2703. In the present embodiment, the Java library 2804 includes the JMF 2804a, the AM 2804b, the CA 2804c, the network library 2804d, a reproduction Lib 2804e, the List 2804i, and the like.

The JMF 2804a, the AM 2804b, the reproduction Lib 2804e, the IO 2804f, AWT 2804g, and an SI 2804h are the same as the JMF 705a, the AM 705b, the reproduction Lib 705f, the IO 705g, AWT 705h, and the SI 705i inside the Java library 705 of the broadcast receiving apparatus 102 of the present embodiment.

The CA 2804c manages right processing of the multimedia data, such as copy control and billing of the multimedia data transmitted through the network 107 and the multimedia data stored in the second memory 2703. Copy control is to rewrite data as necessary with reference to copy control information included in the section information of the transmitted transport stream. Furthermore, billing and the like is performed by communicating with the broadcast receiving apparatus 102 through the network library 2804d.

The List 2804i displays a list of multimedia contents stored in the EPG and the second memory 2703 of the broadcast receiving apparatus 102, and a list of multimedia contents stored in the video storing apparatus connected to the network 107, selects one of the multimedia contents from the lists, by the user's operation accepted by the input unit 2701, and requests the service manager 2803 to reproduce the selected content. When the content is stored in the broadcast receiving apparatus 102 or an other video storing apparatus connected to the network 107, the information of the device is also passed to the service manager 2803. The list of the contents stored in the second memory 2703 can be obtained by reading information though the IO 2804f. Furthermore, the list of the contents stored in the EPG of the broadcast receiving apparatus 102 and the other video storing apparatus connected to the network 107 can be obtained though the network library 2804d. Since these information can be implemented according to the method defined in UPnP AV, the detailed description shall be omitted.

The network library 2804d communicates with the broadcast receiving apparatus 102, and other video receiving apparatuses, and the terminals 105 and 106 which are connected to the network 107, through the NET 2801b3 of the Library 2801b. Furthermore, between the network library 2804e and the broadcast receiving apparatus 102, following communication is performed for: transmitting the attributes of the video storing apparatus; receiving a request for storing multimedia data and the multimedia data; receiving an inquiry about whether or not the multimedia data is stored and transmitting the reply; accepting the request for transmitting the stored multimedia data; and performing right processing following the use of the multimedia data. Furthermore, among the network library 2804e, the terminals 105 and 106, and the other broadcast receiving apparatuses, following processing is performed: transmitting and receiving a list of multimedia data; transmitting multimedia data; and receiving multimedia data.

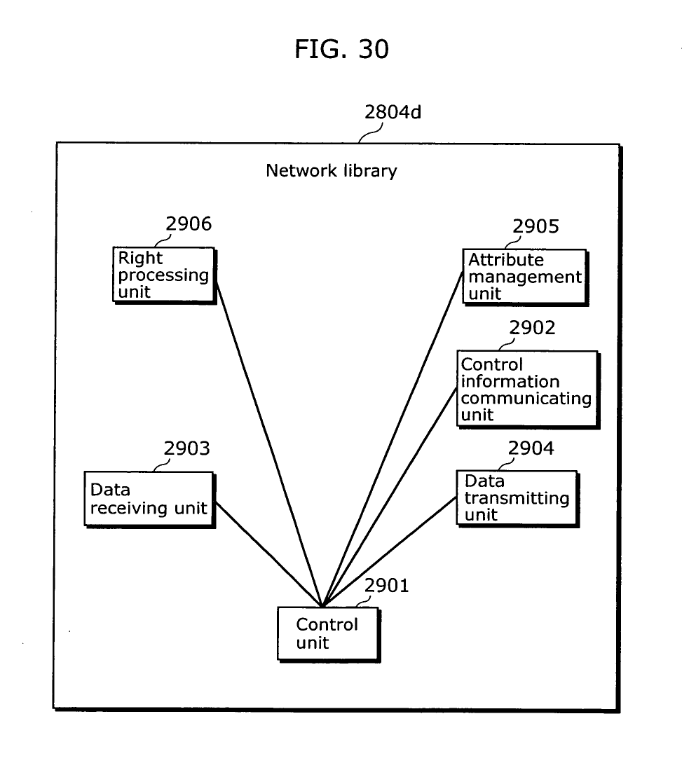

FIG. 30 is a block diagram showing the second example of an internal configuration of the network library 2804d according to the second embodiment of the present invention. The network library 2804d includes a control unit 2901, a control information communicating unit 2902, a data receiving unit 2903, a data transmitting unit 2904, an attribute management unit 2905, and a right processing unit 2906. Note that the network library 2804d may include other functions relating to the IP network.

The control unit 2901 provides, to a downloaded Java application program, the functions which the network library 2804d implements. In other words, the Java application can execute a network functions by calling the Java APIs provided by the control unit 2901. When the Java API is invoked, the control unit 2901 performs processes using the control information communicating unit 2902, the data receiving unit 2903, the selecting unit 2904, the attribute management unit 2905, the right processing unit 2906, and the rest of the Java library 2804 and the library 2801b of the OS 2801, as necessary.

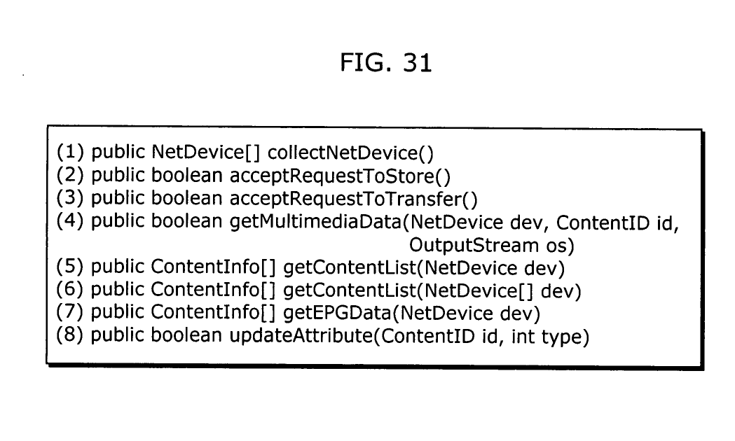

FIG. 31 shows an example of Java APIs provided by the control unit 2901 included in the internal configuration of the network library 2804d according to the second embodiment of the present invention.

The method collectNetDevice( ) in FIG. 31 (1) collects information on an external device connected to the network 107, returns, as such information, the array of NetDevice objects, and in the case of failure, it returns null. This method is performed using the method collectNetDevice( ) of the control information communicating unit 2902 to be described later.

The method acceptRequestToStore( ) in FIG. 31 (2), upon being called, first activates a new process or a new thread and continues to operate on the new process or the new thread. The method accepts, from the broadcast receiving apparatus 102, a request for transmitting the attributes; accepting a request for storing multimedia data; receives the multimedia data; and stores the multimedia data in the second memory 2703. For the normal end, true is returned, and for the abnormal end, false is returned. Note that it is possible to end the operation once a single request is accepted, without continuing to operate. Note that the Java application program may pass a device connected to the network 107 with the argument, and receives and stores the data from the device by communicating with that device. Details of this process shall be described later.

The method acceptRequestToTransfer( ) in FIG. 31 (3), upon being called, first activates a new process or a new thread and continues to operate on the new process or the new thread. The method accepts an inquiry about whether or not particular multimedia data from the broadcast receiving apparatus 102 is stored, and returns the reply, and alternatively, accepts a request from the broadcast receiving apparatus 102 for transmitting the particular multimedia data to a particular terminal, and transmits the multimedia data to the terminal. Furthermore, the method accepts a request for transmitting multimedia data from an external device, such as the terminals 105 and 106, and transmits the multimedia data. For the normal end, true is returned, and for the abnormal end, false is returned. Note that it is possible to end the operation once a single request is accepted, without continuing to operate. Details of this process shall be described later.

The method getMultimediaData( ) in FIG. 31 (4) accepts a device connected to the network 107, an identifier of a content, and an output stream from the Java application program or other sub-programs, receives the multimedia data identified by the identifier, and writes the data in the output stream. For the normal end, true is returned, and for the abnormal end, false is returned. With this method, the Java application program can receive the multimedia data held by the other devices connected to the network 107 and reproduce the data. Details of this process shall be described later.

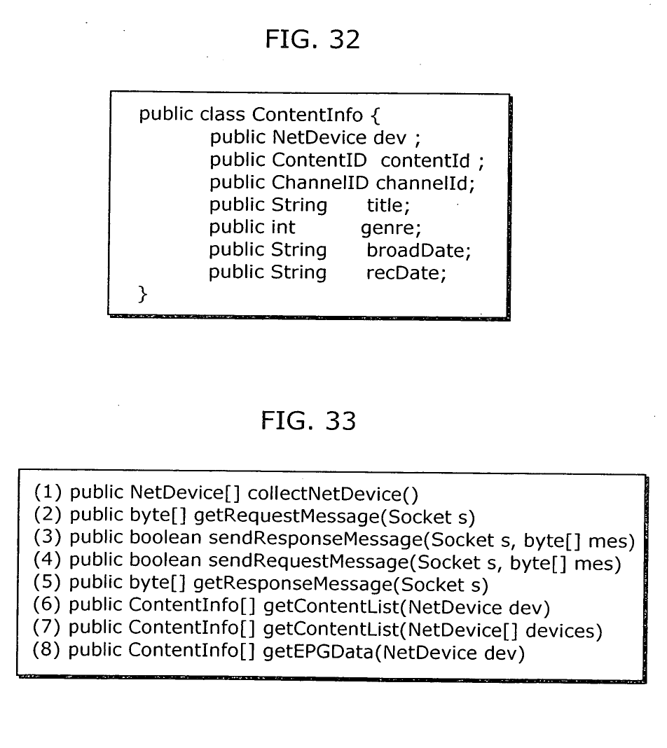

The method getContentList( ) in FIG. 31 (5) and (6) receives, from the Java application program or other sub-program, a video storing apparatus connected to the network 107, obtains a list of the contents stored by the video storing apparatus, and returns the array of the ContentInfo objects. When successful, it returns this array, and in the case of failure, it returns null. In this method, there are cases where a NetDevice object is given as an argument and cases where the array of the NetDevice objects is given. FIG. 32 is a diagram showing the structure of a ContentInfo class used for the network library 2804d according to the second embodiment of the present invention. In FIG. 32, dev represents the video storing apparatus, contentId represents an identifier of the content, channeled represents an identifier of a channel of which the content has been broadcasted, genre represents a genre of the content, broadDate represents a date and time when the content has been broadcasted, recDate represents a date and time when the content has been recorded. This processing is performed by calling the method getContentList( ) provided by the control information communicating unit 2902 to be described later.

The method getEPGData( ) in FIG. 31 (7) obtains EPG information from a specified device, and returns the array of the Contentinfo objects. When the method fails in detecting that the device specified by the argument dev is the broadcast receiving apparatus 102, it returns null. This processing is performed by calling the method getEPGData( ) provided by the control information communicating unit 2902 to be described later.

The method updateAttribute( ) in FIG. 31 (8) updates attribute information as the processing specified by the argument type is performed to the content specified by the argument id. When successful, it returns true, and in the case of failure, it returns false. The present method is performed by calling the method updateAttribute( ) provided by the attribute management unit 2905 to be described later.

The control information communicating unit 2902 controls the network unit 2708 through the NET2801b3 of the library 2801b of the OS 2801, and receives and transmits a message to and from an external device that is connected to the network 107 and that has been specified.

The control information communicating unit 2902 provides Java APIs to the control unit 2901 and the downloaded Java application program.

FIG. 33 shows an example of Java APIs provided by the control information communicating unit 2902.

The method collectNetDevice( ) in FIG. 33 (1) is the same as the method collectNetDevice( ) provided by the information communicating unit 1603 of the network library 705e in the broadcast receiving apparatus 102 according to the present embodiment.

The method getRequestMessage( ) in FIG. 33 (2) receives a message through the socket given by the argument s, and returns a byte sequence of the received data. When successful, it returns the byte sequence, and it returns null in the case of failure. The present method is used when receiving a request from an external device.

The method sendResponseMessage( ) in FIG. 33 (3) transmits a message given by the argument mes through the socket given by the argument s. When successful, it returns true, and it returns false in the case of failure. The present method is used when transmitting a reply to a request from an external device.

The method sendRequestMessage( ) in FIG. 33 (4) transmits the message given by the argument mes through the socket given by the argument s. When successful, it returns true, and it returns false in the case of failure. The present method is used when transmitting a request to an external device.

The method getResponseMessage( ) in FIG. 33 (5) receives a message through the socket given by the argument s, and returns a byte sequence of the received data. When successful, it returns the byte sequence, and it returns null in the case of failure. The present method is used when receiving a reply to a request to an external device, from the external device.

The method getContentList( ) in FIG. 33 (6) and (7) obtains a list of the contents stored by the video storing apparatus given by the argument dev or plural video storing apparatuses given by the argument devices, and returns the array of the ContentInfo objects. When successful, it returns this array, and in the case of failure, it returns null. Since the list of the contents stored by each of the video storing apparatuses is obtained according to a method defined in UPnP AV, the detailed description shall be omitted.

The method getEPGData( ) in FIG. 33 (8) obtains EPG information from a broadcast receiving apparatus given by the argument dev, and returns the array of the Contentinfo objects. When successful, it returns this array, and in the case of failure, it returns null. Since the EPG information is obtained according to a method defined in UPnP AV, the detailed description shall be omitted.

The data receiving unit 2903 controls the network unit 2708 through the NET2801b3 of the library 2801b of the OS 2801, and receives, via the network 107, multimedia data from a broadcast receiving apparatus or a video storing apparatus which is connected to the network 107.

The data receiving unit 2903 provides Java APIs to the control unit 2901 and the downloaded Java application program.

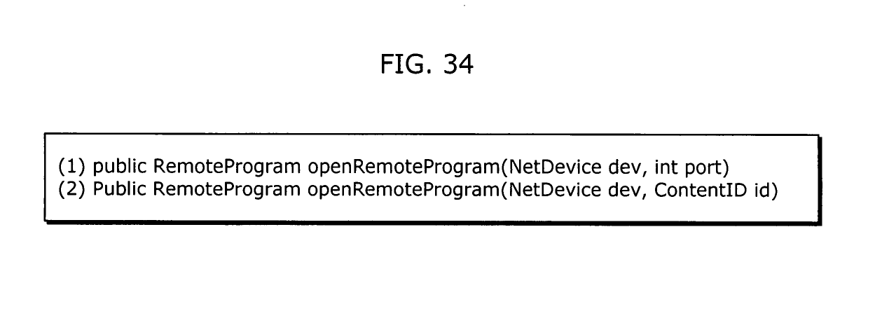

FIG. 34 shows an example of Java APIs provided by the data receiving unit 2903 included in the internal configuration of the network library according to the second embodiment of the present invention.

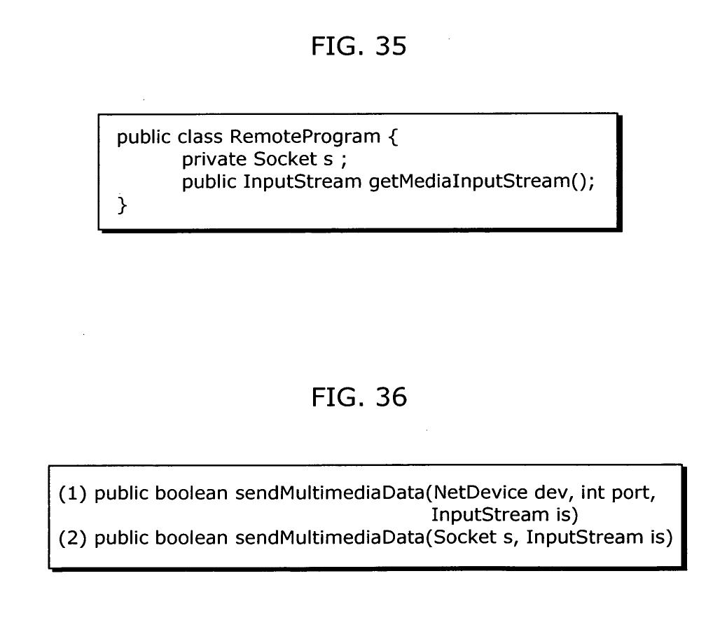

The method openRemoteProgram( ) in FIG. 34 (1) establishes a communication path through which the multimedia data can be received from a port specified by the argument port for a device given by the argument dev, and returns the RemoteProgram object. When successful, it returns the object, and in the case of failure, it returns null. FIG. 35 shows an example of the structure of a RemoteProgram class. In FIG. 35, s represents a socket to be used for the communication. The method getMediaInputStream( ) returns the InputStream object that reads the multimedia data.

The method openRemoteProgram( ) in FIG. 34 (2) establishes a communication path through which the multimedia data stored by a device given by the argument dev and that has an identifier given by the argument id can be received, and returns the RemoteProgram object. When successful, it returns the object, and in the case of failure, it returns null. The present method first generates the Socket object for the communication with the specified device, and connects to the device. Then, it creates a transmission request message including the given identifier, and transmits the message to the device by calling the method sendRequestMessage( ) provided by the control information communicating unit 2902. Then, it receives a reply message by calling the getResponseMessage( ) provided by the control information communicating unit 2902. When the reply message is OK, the method analyzes the message. Furthermore, when a particular port number is specified, it creates a new Socket object, creates the RemoteProgram object with specifying the new Socket object, and returns the created RemoteProgram object. When a particular port is not specified, it creates the RemoteProgram object with specifying the Socket object used for the communication, and returns the created RemoteProgram object. When the reply message is NG, it returns null.

The data transmitting unit 2904 controls the network unit 2708 through the NET280b3 of the library 2801b of the OS 2801, and outputs the specified multimedia data to an external device that is connected to the network 107 and that has been specified.

The data transmitting unit 2904 provides Java APIs to the control unit 2901 and the downloaded Java application program.

FIG. 36 shows an example of Java APIs provided by the data transmitting unit 2904 included in the internal configuration of the network library according to the second embodiment of the present invention.

The method sendMultimediaData( ) in FIG. 36 (1) sends data to a port given by the argument port for the device specified by the argument dev, and method sendMultimediaData( ) in FIG. 36 (2) transmits the read data through the Socket object specified by the argument s while reading the data from the InputStream object given by the argument is until the data reaches the EOF. When successful, it returns true, and in the case of failure, it returns false.

The attribute management unit 2905 manages attributes of a video storing apparatus. The attributes of the video storing apparatus are stored in the second memory 2703, and the attribute management unit 2905 reads and writes the attributes using the IO 2804f within the Java library 2404.

The attribute management unit 2905 provides Java APIs to the control unit 2901 and the downloaded Java application program.

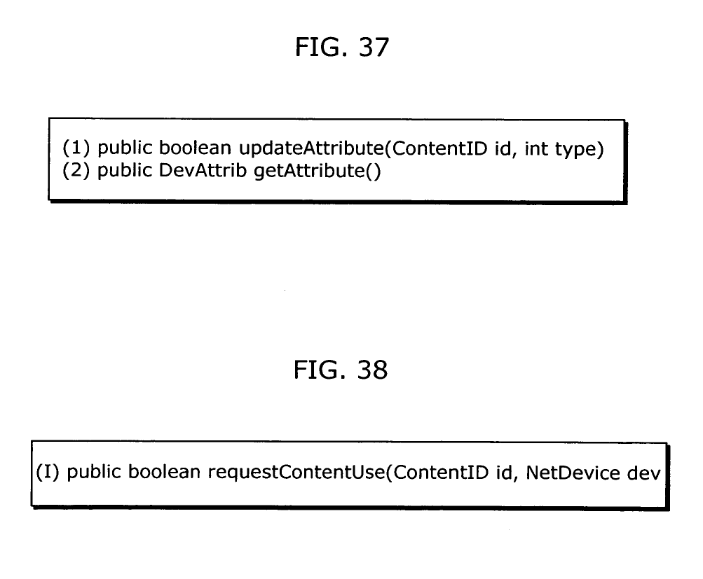

FIG. 37 shows an example of Java APIs provided by the attribute management unit 2905 included in the internal configuration of the network library according to the second embodiment of the present invention.

The method updateAttribute( ) in FIG. 37 (1) updates attribute information as the processing specified by the argument type is performed to the content specified by the argument id. When successful, it returns true, and in the case of failure, it returns false. When a value of type is 0, it represents storage, and when the value is 1, it represents reproduction or transmission to a network. The present method reads, from the second memory 2703, information of a content stored with attribute information, and updates the attribute information by checking a genre of the content and a free space of an area for multimedia data in the second memory 2703. Then, it writes the updated attribute information in the second memory 2703.

The method getAttribute( ) in FIG. 37 (2) reads the attribute information from the second memory 2703, stores the necessary data in the DevAttrib object, and returns the DevAttrib object. In the case of failure, it returns null.

The right processing unit 2906 performs right processing on the broadcast receiving apparatus 102, regarding the use of a content having an identifier given by the argument id.

The right processing unit 2906 provides Java APIs to the control unit 2901 and the downloaded Java application program.

FIG. 38 shows an example of Java APIs provided by the right processing unit 2906 included in the internal configuration of the network library according to the second embodiment of the present invention.

The method requestContentUse( ) in FIG. 38 (1) requests the device given by the argument dev to permit the use of the content specified by the argument id, and when the use of the content is permitted, it returns true, and if not or in the case of the processing failure, it returns false, respectively. Then, it creates a request message, and transmits the message by calling the method sendRequestMessage( ) provided by the control information communicating unit 2902. Furthermore, it receives a reply message by calling the getResponseMessage( ) provided by the control information communicating unit 2902. When the reply message indicates OK, it returns true, and when the message indicates NG, it returns false.

The method acceptRequestToStore( ), the method acceptRequestToTransfer( ), and the method getMultimediaData( ) are to be described here.

The method acceptRequestToStore( ), upon being called, generates another new process or new thread and operates on the new process or the new thread. First, it creates a Socket object through which a connection from the broadcast receiving apparatus 102 can be accepted, and waits for a connection request. When receiving the connection request from the broadcast receiving apparatus 102, the method receives a request message by calling the method getRequestMessage( ) provided by the control information communicating unit 2902. When the received request message is an inquiry of attributes, it reads attribute information by calling the method getAttribute( ) provided by the attribute management unit 2905, returns the attribute information by calling the method sendResponseMessage( ) provided by the control information communicating unit 2902, and returns to a connection request waiting state. When the received request message is a request for storing multimedia data, first, an identifier of the multimedia data and TV-program information are retrieved from the request message. Next, by calling the method openRemoteProgram( ) provided by the data receiving unit 2903, an InputStream object to be used for receiving data is created. Next, multimedia data is stored by writing the identifier, the TV-program information, and the multimedia data received from the InputStream, in the second memory 2703 through the IO 2804f of the Java library 2804. Furthermore, the attribute information is updated by calling the method updateAttribute( ) provided by the attribute management unit 2905. When the processing ends, the system returns to a connection request waiting state. Note that upon accepting a connection request, further, the system may generate another new thread or new process, operate on the new thread or the new process for the following processing, and the original thread or the process may return to a connection request waiting state. In this case, the processing on the new thread or the new process ends without returning to the connection request waiting state.

The method acceptRequestToStore( ) may use the NetDevice object as an argument, and this argument may specify the broadcast receiving apparatus 102. In this case, in addition to the aforementioned processing, when a device connected to the Socket object to be waited for is not the device given by the argument, the connection request is not accepted.

The method acceptRequestToStore( ), upon being called, generates another new process or new thread and operates on the new process and the new thread. First, it creates the Socket object that accepts a connection from a device connected to the network 107, and waits for a connection request. When receiving the connection request, the method receives a request message by calling the method getRequestMessage( ) provided by the control information communicating unit 2902. When the received request message is an inquiry from the broadcast receiving apparatus 102 about whether or not particular multimedia data is stored, the identifier of the multimedia data is retrieved from the request message. Next, a list of stored contents is read through the IO 2804f inside the Java library 2804, and whether or not the multimedia data is stored is judged by checking the list with the retrieved identifier. Then, it returns a judgment result by calling the sendResponseMessage( ) provided by the control information communicating unit 2902, and returns to a connection request waiting state. When the received request message is a request, from the broadcast receiving apparatus 102 for transmitting particular multimedia data, first, the identifier of the multimedia data to be transmitted and the identifier of the destination are retrieved from the request message. Next, the method obtains the InputStream through which the multimedia data can be read through the IO 2804f. Next, the multimedia data is transmitted to the terminal by calling the method sendMultimediaData( ) provided by the data transmitting unit 2904. When the data transmission ends, the attribute information is updated by calling the method updateAttribute( ) provided by the attribute management unit 2905 and the system returns to a connection request waiting state. When the received request message is a request for transmitting multimedia data from a terminal and the like, first, an identifier of multimedia data to be transmitted is retrieved from the request message. Next, the method obtains the InputStream through which the multimedia data can be read through the IO 2804f. Next, the multimedia data is transmitted to the terminal by calling the method sendMultimediaData( ) provided by the data transmitting unit 2904. When the data transmission ends, the attribute information is updated by calling the method updateAttribute( ) provided by the attribute management unit 2905 and the system returns to a connection request waiting state. Note that upon accepting a connection request, further, the system may generate another new thread or new process, operate on the new thread or the new process for the following processing, and the original thread or the process may return to a connection request waiting state. In this case, the processing on the thread or process ends without returning to the connection request waiting state.

The method getMultimediaData( ), upon being called, creates the Socket object through which the method connects to the device given by the argument dev, and connects to the device. Next, it creates a transmission request message of the multimedia data specified by the argument id, in a manner including the value of id, and transmits the multimedia data to the device by calling the method sendRequestMessage( ) provided by the control information communicating unit 2902. Next, by calling the method openRemoteProgram( ) provided by the data receiving unit 2903, an Input Stream object through which the multimedia data can be received is created. Then, it reads the data through the InputStream, and writes the data in the OutputStream given by the argument cs. When the entire received data is written, the processing ends. With the present method, it is possible to reproduce and store multimedia data by receiving the multimedia data corresponding to a content in the content list obtained by the method getContentList( ) or the method getEPGData( ).

Since the terminals 105 and 106 are made up of only constituent elements for reproducing multimedia data from among the constituent elements of the video storing apparatuses 103 and 104, the detailed description is omitted.

### Variation of the Second Embodiment

Although the present invention is described based on the above-mentioned second embodiment, it should be obvious that the present invention is not limited to such above-mentioned embodiment. The present invention also includes such cases as described below.

(1) The broadcast receiving apparatus 102 may further store multimedia data in the second memory 503, and the selecting unit 1604 of the network library 705e in the Java library 705 may select one of the broadcast receiving apparatus 102 and a video storing apparatus connected to the network 107. Furthermore, when receiving the VoD service from a terminal, the broadcast receiving apparatus 102 may further check whether or not multimedia data of the content is stored in the video storing apparatus connected to the network 107 and the storage unit of the broadcast receiving apparatus 102, and when it is stored in the storage unit of the broadcast receiving apparatus 102, the multimedia data may be transmitted to a terminal that issues a request of the VoD service.

(2) Furthermore, it is possible that the broadcast receiving apparatus 102 perform predetermined encryption on multimedia data and transmits the encrypted multimedia data to the video storing apparatuses 103 and 104. Furthermore, it is possible that the video storing apparatuses 103 and 104 decrypt the received and encrypted multimedia data, stores the data in the storage unit 302, and further stores the data by performing predetermined encryption on the multimedia data.

Furthermore, when the broadcast receiving apparatus 102, and the video storing apparatuses 103 and 104 transmit multimedia data to the terminals 105 and 106, it is possible that they perform predetermined encryption on the multimedia data, transmit the encrypted multimedia data, decrypt, in the terminals 105 and 106, the received and encrypted multimedia data, and reproduce the data.

(3) Furthermore, although the aforementioned embodiment describes an example of an algorithm selected by the selecting unit 1604 of the network library 705e in the Java library 705 of the broadcast receiving apparatus 102, it is obvious that the present invention is not limited to selection of such algorithm. For example, it is possible that the broadcast receiving apparatus 102 selects video receiving apparatuses in order. Furthermore, it is possible to select them based on a use frequency of a video storing apparatus. Furthermore, it is possible to select a video storing apparatus by checking individual storing frequencies of genres, TV-program names, performers, and the like of multimedia data stored by the user's operation, with the genres, TV-program names, performers of multimedia data, and the like. Furthermore, it is possible to select a video storing apparatus by checking individual storing frequencies of genres, TV-program names, performers, and the like of multimedia data reproduced or outputted by the user's operation, with genres, TV-program names, performers, and the like of multimedia data. Furthermore, it is possible to select a pair of a terminal and a video storing apparatus according to data, for example, selecting the video storing apparatus 103 for multimedia data having a high frequency to be used in the terminal 105, and selecting the video storing apparatus 104 for multimedia data having a high frequency to be used in the terminal 106.

(4) Furthermore, although the aforementioned embodiment describes that the broadcast receiving apparatus 102 judges whether or not multimedia data of a content requested in the VoD service is stored by communicating with the video storing apparatuses 103 and 104, it is possible that the broadcast receiving apparatus 102 stores multimedia data stored in the video storing apparatuses 103 and 104, and judges whether or not the data is stored based on the content of the stored multimedia data.

(5) Furthermore, in the present embodiment, when multimedia data for the VoD service requested from a terminal is stored either in the video storing apparatus 103 or 104, the broadcast receiving apparatus 102 issues, to the video storing apparatus that stores the data, a request for transmitting the multimedia data to the terminal that requests the VoD service, and notifies the terminal of information indicating that the multimedia data is to be transmitted from the video storing apparatus. However, it is possible that the broadcast receiving apparatus 102 performs right processing such as billing with the video storing apparatus, notifies the video storing apparatus to the terminal, and issues a request for transmitting the multimedia data from the terminal to the video storing apparatus.

(6) Furthermore, although in the present embodiment, when multimedia data for the VoD service requested from a terminal is stored either in the video storing apparatus 103 or 104, the broadcast receiving apparatus 102 and the video storing apparatus communicates with each other and performs right processing following the use of the multimedia data, such as billing, it is possible that the broadcast receiving apparatus 102 communicates with the terminal that requests the VoD service and performs the right processing. Alternatively, it is possible that the broadcast receiving apparatus 102 performs right processing without communicating with a video storing apparatus or a terminal.

Furthermore, although the right processing following the use of multimedia data, such as billing, is performed when a request for transmitting multimedia data is issued in the present embodiment, it is possible to perform the right processing after the multimedia data is used. Furthermore, it is possible to change the amount to be billed according to the number of times that the multimedia data is used, a use section, or the like.

(7) Furthermore, although single multimedia data is stored in a video storing apparatus in the aforementioned embodiment, it is possible to divide the multimedia data and distribute the divided data to plural video storing apparatuses. Alternatively, it is possible to concurrently store single multimedia data in the plural video storing apparatuses. With this, when plural terminals request identical multimedia data, it is possible to distribute loads in which the video storing apparatus transmits video to the terminal.

(8) Furthermore, the broadcast receiving apparatus 102 further includes a coding unit that creates coded multimedia data, and it is possible that the broadcast receiving apparatus 102 temporarily decodes multimedia data to be transmitted, newly creates multimedia data and transmits the created multimedia data, using the coding unit. Furthermore, it is possible that the video storing apparatuses 103 and 104 further include a decoding unit that decodes multimedia data, and a coding unit that creates coded multimedia data, and it is possible that the decoding unit temporarily decodes the received multimedia data, newly creates multimedia data and stores the created multimedia data, using the coding unit.

(9) It is possible that a part or all of the constituent elements making up each of the above-mentioned apparatuses is made from one system LSI (Large Scale Integration circuit). The system LSI is a super multi-function LSI that is manufactured by integrating plural elements in one chip, and is specifically a computer system which is configured by including a microprocessor, a ROM, a RAM, and so on. A computer program is stored in the RAM. The system LSI accomplishes its functions through the operation of the microprocessor in accordance with the computer program.

(10) It is possible that a part or all of the constituent elements making up each of the above-mentioned apparatuses is made from an IC card that can be attached to/detached from each apparatus, or a stand-alone module. The IC card or the module is a computer system made from a microprocessor, a ROM, a RAM, and so on. The IC card or the module may include the super multi-function LSI. The IC card or the module accomplishes its functions through the operation of the microprocessor in accordance with the computer program. The IC card or the module may also be tamper-resistant.

(11) The broadcast receiving apparatus and the video storing apparatus according to the present invention may operate in the aforementioned methods. Furthermore, the present invention may also be a computer program for executing such methods through a computer, or as a digital signal made from the computer program.

Furthermore, the broadcast receiving apparatus and the video storing apparatus of the present invention may be a computer-readable recording medium, such as a flexible disk, a hard disk, a CD-ROM, an MO, a DVD, a DVD-ROM, a DVD-RAM, a Blu-ray Disc (BD), or a semiconductor memory, on which the computer program or the digital signal is recorded. Furthermore, the broadcast receiving apparatus and the video storing apparatus of the present invention may also be the computer program or the digital signal recorded on such recording media.

Furthermore, the broadcast receiving apparatus and the video storing apparatus of the present invention may transmit the computer program or the digital signal via an electrical communication line, a wireless or wired communication line, a network represented by the Internet, a data broadcast, and so on.

Furthermore, the broadcast receiving apparatus and the video storing apparatus of the present invention compose a computer system including a microprocessor and a memory, with the memory storing the computer program and the microprocessor operating in accordance with the computer program.

Furthermore, the present invention may also be implemented in another independent computer system by recording the program or the digital signal on the recording medium and transferring the recording medium, or by transferring the program or the digital signal via the network, and the like.

(12) It is also possible to combine the above-described embodiment and the aforementioned variation of the second embodiment.

### Third Embodiment

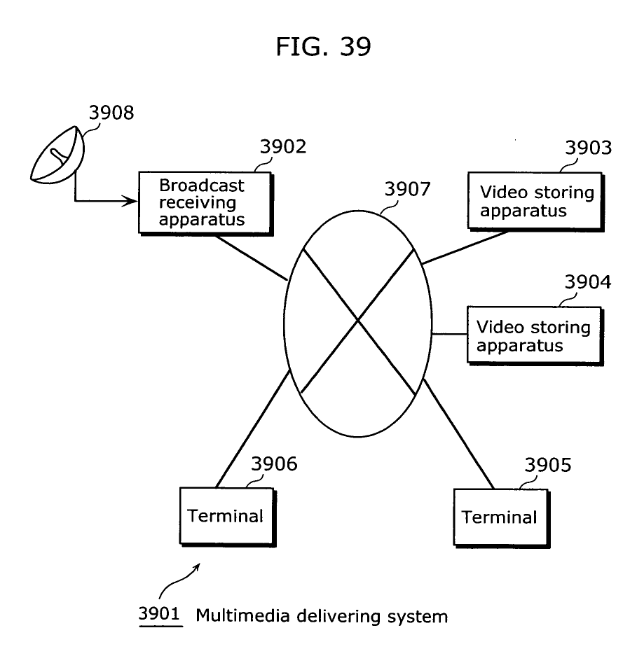

FIG. 39 is a configuration diagram for the multimedia delivering system in the third embodiment of the present invention. A multimedia delivering system 3901 includes a broadcast receiving apparatus 3902, a first video storing apparatus 3903, a second video storing apparatus 3904, a first terminal 3905, a second terminal 3906, a network 3907, and a receiving unit 3908.

The broadcast receiving apparatus 3902, the video storing apparatus 3903, the video storing apparatus 3904, the terminal 3905, and the terminal 3906 are connected to the network 3907, and they can communicate with each other via the network 3907. Furthermore, the broadcast receiving apparatus 3902 is connected to the receiving unit 3908, demodulates a signal of a digital broadcast received through the receiving unit 3908, and obtains multimedia data. Note that the plural number of video storing apparatuses and terminals has only to be included in the system, and it is assumed that two video storing apparatuses and two terminals are included herein in order to make the description easier.

The broadcast receiving apparatus 3902 in the third embodiment demodulates a signal received through the receiving unit 3908, and extracts multimedia data of the digital broadcast. Furthermore, the broadcast receiving apparatus 3902 uses pay television and the like provided through digital broadcasting, and performs communication for right processing, including billing, to use multimedia data of the pay television, using other communication paths not shown in the figure, such as a phone line.

Furthermore, when the broadcast receiving apparatus 3902 receives and stores, in advance, multimedia data of a TV-program to be broadcasted in the Near VoD service, according to a setting of the user, it transmits a request to video storing apparatuses 3903 and 3904 for transmitting each of the attributes, and receives the attributes from the video storing apparatuses. Furthermore, the broadcast receiving apparatus 3902 selects one of the video storing apparatus 3903 and the video storing apparatus 3904, based on the attributes of the multimedia data received from the broadcast station and the attributes of the video storing apparatuses received from the video storing apparatuses. Furthermore, the broadcast receiving apparatus 3902 transmits a request for storing multimedia data to the video storing apparatuses 3903 and 3904, and then transmits the multimedia data.

Note that the TV-program to be broadcasted in the Near VoD service may be received in advance by the broadcast receiving apparatus 3902, in response to a request from a broadcast station or in a particular day and time. Furthermore, the reception may be performed for each particular time. Furthermore, the reception may be performed in a date and time set by the user. Furthermore, the reception may be performed at particular time intervals set by the user.

Furthermore, when the broadcast receiving apparatus 3902 receives a request for viewing a content, such as a broadcast TV-program, from the terminal 3905 or 3906, it inquires about whether or not multimedia data of the content is stored by communicating with one of video storing apparatus 3903 and 3904, or with both of the video storing apparatuses 3903 and 3904. When the data is stored neither in the video storing apparatus 3903 nor the video storing apparatus 3904, the broadcast receiving apparatus 3902 receives the TV-program, using a tuner. If necessary, after appropriate right processing including billing is performed, the broadcast receiving apparatus 3902 transmits the multimedia data via the network 3907 to the requested terminal 3905 or 3906. Furthermore, when the data can not be received because the tuner is being used and the like, the condition is notified to the terminal. Furthermore, when the data is stored either in the video storing apparatus 3903 or the video storing apparatus 3904, the broadcast receiving apparatus 3902 requests one of the video storing apparatuses 3903 and 3904 that stores the multimedia data to transmit the multimedia data to the terminal that issues the request. In this case, if necessary, the broadcast receiving apparatus 3902 performs, by communicating with the video storing apparatus, right processing including billing following the use of the multimedia data, and notifies the processing to the broadcast station. Furthermore, the broadcast receiving apparatus 3902 notifies the terminal that issues the request of information indicating that the multimedia data is to be transmitted from the video storing apparatus that stores the multimedia data.

Once the video storing apparatuses 3903 and 3904 in the present embodiment receives a request for transmitting the attributes from the broadcast receiving apparatus 3902, they transmits, to the broadcast receiving apparatus 3902, the attributes each stored in the video storing apparatuses. An attribute of a video storing apparatus indicates information, such as a free space in a storage unit that stores, in advance, a TV-program in the Near VoD service, a storage frequency of multimedia data stored by the user's operation per genre, and use frequency of the reproduced multimedia data per genre.

Furthermore, once the video storing apparatuses 3903 and 3904 receive a request for storing multimedia data from the broadcast receiving apparatus 3902, they receives the multimedia data from the broadcast receiving apparatus 3902 via the network 3907, and stores the data in a storage unit.

Furthermore, once the video storing apparatuses 3903 and 3904 receive an inquiry about whether or not multimedia data of a particular content is stored, they search for the stored content data, and return the result.

Furthermore, once the video storing apparatuses 3903 and 3904 receive, from the broadcast receiving apparatus 3902, a request for transmitting the multimedia data of a particular content to a particular terminal connected to the network 3907, they transmit the multimedia data to the terminal via the network 3907. When starting the transmission, if necessary, the video storing apparatuses 3903 and 3904 communicate with the broadcast receiving apparatus 3902, and perform right processing following the use of the multimedia data, such as billing.

The terminals 3905 and 3906 in the present embodiment issue a request for viewing a TV-program to the broadcast receiving apparatus 3902 by the user's operation, receive the multimedia data via the network 3907, and reproduce the multimedia data. Furthermore, when the data is stored either in the video storing apparatus 3903 or the video storing apparatus 3904, the broadcast receiving apparatus 3902 notifies one of the video storing apparatuses 3903 and 3904 that accumulates the multimedia data, and receives, via the network 3907, the multimedia data transmitted from the video storing apparatus.

The network 3907 is a home network established in the household, and is an IP network configured of the Ethernet, a wireless LAN, a communication technology called c. LINK that uses a coaxial cable as a medium, or the like.

The receiving unit 3908 in the present embodiment provides broadcast receiving apparatus 3902 with a signal of a digital broadcast through the coaxial cable and is, as a representative example, an antenna that receives digital broadcast, and a head end for a cable television.

As described above, with the multimedia delivering system 3901, the broadcast receiving apparatus 3902, and the video storing apparatuses 3903 and 3904 according to the present invention, it is possible to distribute and store multiple data on an appropriate condition in advance. Even when the terminals 3905 and 3906 concurrently issue requests for viewing different TV-programs, by using the multimedia data stored in the video storing apparatuses 3903 and 3904, it is possible to reduce the number of tuners necessary for viewing the programs.

Hereinafter, the broadcast receiving apparatus 3902 and the video storing apparatuses 3903 and 3904, which compose the multimedia delivering system 3901 are to be described in details.

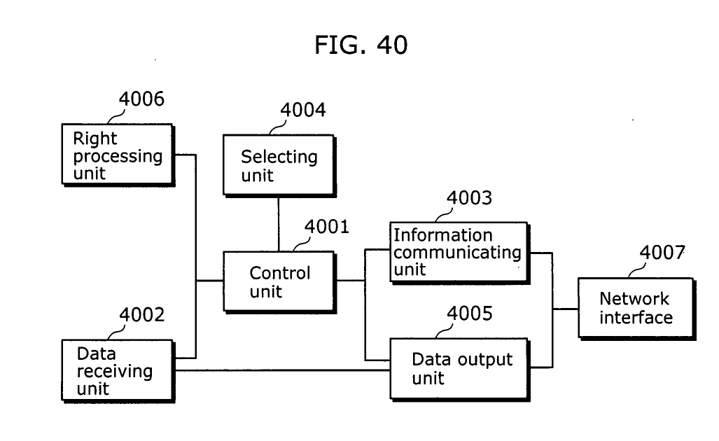

First, with reference to FIG. 40, the details of the broadcast receiving apparatus 3902 are to be described.

FIG. 40 is a block diagram showing an example of the configuration of the broadcast receiving apparatus 3902 according to the third embodiment of the present invention. The broadcast receiving apparatus shown in FIG. 40 includes: a control unit 4001; a receiving unit 4002 that receives multimedia data transmitted from the broadcast station 3908; an information communicating unit 4003 that communicates with an external device connected to the network 3907; a selecting unit that selects one of the video storing apparatuses connected to the network 3907; a data output unit 4005 that transmits multimedia data to the external device connected to the network 3907; a right processing unit 4006 following use of the multimedia data for a pay television, such as billing; and a Network interface 4007 connected to the network 3907.

The control unit 4001 is to be described in details. The control unit 4001 includes a microprocessor, a ROM, a RAM, and the like. In the ROM, RAM, and an information storage unit not shown in the figure, an OS operated by the microprocessor, a Java Virtual Machine (Java VM) program, a Java program library, and a Java application program are stored. The microprocessor reads and runs the OS on start-up. Next, on start-up of the Java application program, the microprocessor reads and runs the Java VM program, and runs the Java application program while reading the Java program library as necessary.

The control unit 4001 causes the data receiving unit 4002 to receive, in advance, multimedia data to be broadcasted in the Near VoD service, and the information communicating unit 4003 to transmit, to the video storing apparatuses, a request for transmitting attributes of the video storing apparatuses connected to the network 3907. Then, the information communicating unit 4003 receives respective attributes from the video storing apparatuses. Furthermore, the control unit 4001 transmits, to the selecting unit, the received attributes of the video storing apparatuses and the attributes of the multimedia data, and instructs the selecting unit to select one of the video storing apparatuses. Furthermore, the control unit 4001 transmits a request for storing the multimedia data to the selected video storing apparatus, using the information communicating unit 4003. Furthermore, when the information communicating unit 4003 receives information that the video storing apparatus receives the storage request, the control unit 4001 instructs the data output unit 4005 to transmit the multimedia data to the video storing apparatus via the network 3907.

Furthermore, when the information communicating unit 4003 receives a request for viewing a TV-program in the Near VoD service from the terminal connected to the network 3907, the control unit 4001 transmits an inquiry, to each of the video storing apparatuses connected to the network 3907, about whether or not the video storing apparatus connected to the network 3907 stores the requested multimedia data, using the information communicating unit 4003. Then, the control unit 4001 receives a reply regarding this inquiry from each of the video storing apparatuses, using the information communicating unit 4003. When a video storing apparatus stores the multimedia data, the control unit 4001 transmits, to the video storing apparatus, a request for transmitting the multimedia data to the terminal that has issued the request for viewing the multimedia data. In this case, if necessary, the control unit 4001 communicates with the video storing apparatus, and instructs the right processing unit 4006 to perform right processing following the use of the multimedia data, such as billing. Furthermore, the control unit 4001 notifies the terminal of information indicating that the multimedia data is to be transmitted from the video storing apparatus, using the information communicating unit 4003.

The data receiving unit 4002 receives a signal of a digital broadcast, and extracts multimedia data from a particular TV-program. The data receiving unit 4002 is a tuner as a representative example, receives and decodes a signal of the digital broadcast, and extracts multimedia data. Furthermore, although the multimedia data transmitted to be broadcasted is scrambled when it is a pay content, in such a case, the data is decoded by the data receiving unit 4002.

The multimedia data transmitted through a digital broadcast is coded digital data as represented by the MPEG2, and is transmitted in the MPEG2-Transport Stream (TS) format. Although in the MPEG2-TS, it is possible to store plural contents within a stream, the data receiving unit 4002 selects multimedia data of a single content from the stream.

The information communicating unit 4003 is connected to the network interface 4007, and in response to an instruction from the control unit 4001, it transmits control information to an external device connected to the network 3907. Furthermore, the information communicating unit 4003 receives information that is to be transmitted to the broadcast receiving apparatus 3902 and that has been received by the network interface 4007, and passes the information to the control unit 4001. The information communicating unit 4003 is, as a representative example, a program using the socket interface provided by the OS or the Java library. Note that the configuration of the information communicating unit 4003 is not limited to the one including such software, but may be the one including hardware.

In response to an instruction from the control unit 4001, the selecting unit 4004 selects one of the video storing apparatuses connected to network 3907, base on the attribute of the multimedia data and the attributes of the video storing apparatuses. The selecting unit 4004 is, as a representative example, a sub-routine included in the Java library or the Java application program. Note that the configuration of the selecting unit 4004 is not limited to the one including such software, but may be the one including hardware.

In the present embodiment, as attributes of multimedia data, genres of contents, such as a movie, a drama, and a sport are used. Furthermore, free space in a storage unit for cashing a TV-program in the Near VoD service is used as an attribute of a video storing apparatus. The selecting unit 4004 selects a video storing apparatus according to a genre of multimedia data, and when the selected video storing apparatus does not have an enough free space, it selects a video storing apparatus having a large space.

The data output unit 4005 is connected to the network interface 4007, operates in response to an instruction from the control unit 4001, converts the multimedia data to a packet for a destination instructed by the control unit 4001, and outputs the packet through the network interface 4007. The data output unit 4005 is, as a representative example, a program using the socket interface provided by the OS or the Java library. Note that the configuration of the data output unit 4005 is not limited to the one including such software, but may be the one including hardware.

The right processing unit 4006 performs right processing following the use of multimedia data including billing, by communicating with a service provider that provides a service. For example, the right processing unit 4006 includes a CableCARD, and uses this information for the communication with the service provider. Furthermore, when the multimedia data that has been broadcasted and transmitted is scrambled, the right processing unit 4006 passes the information of the CableCARD to the control unit 4001 so as to decode the data in the data receiving unit 4002.

The network interface 4007 is configured of: hardware that provides an interface corresponding to a physical medium of a network, such as the Ether cable or a wireless LAN; and the driver software.

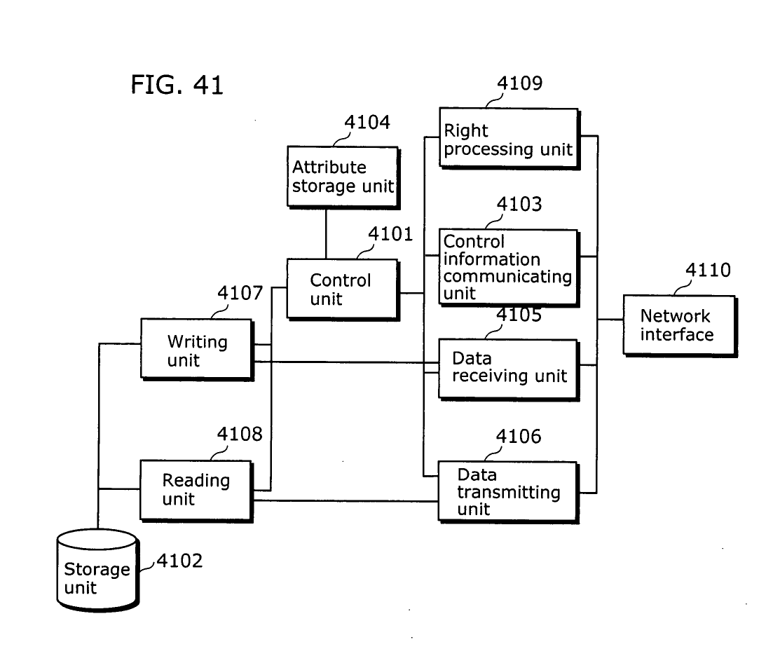

Next, with reference to FIG. 41, the details of the video storing apparatuses 3903 and 3904 according to the present embodiment are to be described.

FIG. 41 is a block diagram showing an example of the configuration of the video storing apparatuses 3903 and 3904 according to the third embodiment of the present invention. Note that the video storing apparatuses 3903 and 3904 includes: a control unit 4101; a storage unit 4102 that stores multimedia data; a control information communicating unit 4103 that communicates control information with an external device connected to the network 3907; an attribute storing unit 4104 that stores an attribute of a video storing apparatus; a data receiving unit 4105 that receives multimedia data transmitted from the broadcast receiving apparatus 3902; a data transmitting unit 4106 that transmits, to the terminal 3905 or 3906 connected to the network 3907, the multimedia data stored in the storage unit 4102; a writing unit 4107 that writes, in the storage unit 4102, the multimedia data received by the data receiving unit 4105; a reading unit 4108 that reads the multimedia data from the storage unit 4102; a right processing unit 4109 that performs right processing following the use of multimedia data including billing, and a network interface 4110 that is connected to the network 3907.

The control unit 4101 is to be described in details. The control unit 4101 includes a microprocessor, a ROM, a RAM, and the like. In the ROM, RAM, and an information storage unit not shown in the figure, an OS operated by the microprocessor, a Java VM program, a Java program library, and a Java application program are stored. The microprocessor reads and runs the OS on start-up. Next, on start-up of the Java application program, the microprocessor reads and runs the Java VM program, and runs the Java application program while reading the Java program library as necessary.

Once the control unit 4101 receives a request for transmitting an attribute, from the broadcast receiving apparatus 3902 using the control information communicating unit 4103, it transmits attribute information stored in the attribute storing unit 4104 from the control information communicating unit 4103 to the broadcast receiving apparatus 3902. Furthermore, once receiving a request for storing multimedia data from the broadcast receiving apparatus 3902, using the control information communicating unit 4103, the control unit 4101 instructs the data receiving unit 4105 to transmit the multimedia data transmitted from the broadcast receiving apparatus 3902 through the network 3907, and receives the data. Furthermore, the control unit 4101 instructs the writing unit 4107 to write the multimedia data received by the data receiving unit 4105, in the storage unit 4102 so as to store the multimedia data in the storage unit 4102. Furthermore, after storing the data, the control unit 4101 receives, from the writing unit 4107, information of a free space of the storage unit 4102, and updates the attribute information stored in the attribute storing unit 4104.

Furthermore, when the control unit 4101 receives, from the broadcast receiving apparatus 3902 using the control information communicating unit 4103, an inquiry about whether or not particular multimedia data is stored, the control unit 4101 instructs the reading unit 4108 to check the multimedia data stored in the storage unit 4102, judges whether or not the multimedia data is stored, and transmits a result of the judgment from the control information communicating unit 4103 to the broadcast receiving apparatus 3902.

Furthermore, when the control unit 4101 receives a request for outputting the stored particular multimedia data and a terminal to which the data is outputted, from the broadcast receiving apparatus 3902 using the control information communicating unit 4103, the control unit 4101 instructs the reading unit 4108 to read the multimedia data from the storage unit 4102, and further instructs the data transmitting unit 4106 to transmit the multimedia data read by the reading unit 4108, to the specified terminal. Furthermore, in this case, if necessary, the control unit 4101 instructs the right processing unit 4109 to communicate with the broadcast receiving apparatus 3902 so as to perform right processing following the use of the multimedia data. When use of the multimedia data is not permitted in the right processing, the control unit 4101 controls the multimedia data not to be transmitted to the specified terminal to be outputted.

The storage unit 4102 is configured of: a storage device for storing digital data having a large space, as represented by a hard disk drive; and the driver software.

The control information communicating unit 4103 is connected to the network interface 4110, receives control information for the video storing apparatus received at the network interface 4110, and passes the information to the control unit 4101. Furthermore, in response to an instruction from the control unit 4101, the control information communicating unit 4103 transmits the control information passed from the control unit 4101 to a specified external device through the network interface 4110. The control information communicating unit 4103 is, as a representative example, a program using the socket interface provided by the OS or the Java library. Note that the configuration of the control information communicating unit 4103 is not limited to the one including such software, but may be the one including hardware.

The attribute storing unit 4104 is configured of a storage device or a part of the device, such as a flash memory and a HDD, and in response to an instruction from the control unit 4101, it stores data received from the control unit 4101.

The data receiving unit 4105 is connected to the network interface 4110, operates in response to an instruction from the control unit 4101, and receives the multimedia data transmitted from the broadcast receiving apparatus 3902, through the network interface 4110. The data receiving unit 4105 is, as a representative example, a program using the socket interface provided by the OS or the Java library. Note that the configuration of the data receiving unit 4105 is not limited to the one including such software, but may be the one including hardware.

The data transmitting unit 4106 is connected to the network interface 4110, operates in response to an instruction from the control unit 4101, converts the multimedia data read by the reading unit 4108 to a packet of the external device that is connected to the network 3907 and that is specified by the control unit 4101, and outputs the packet through the network interface 4110. The data transmitting unit 4106 is, as a representative example, a program using the socket interface provided by the OS or the Java library. Note that the configuration of the data transmitting unit 4106 is not limited to the one including such software, but may be the one including hardware.

The writing unit 4107 operates in response to an instruction from the control unit 4101, and writes data in the data storage unit 4102. The writing unit 4107 is, as a representative example, a software sub-routine that uses a file access interface provided by the OS and the Java library. Note that the configuration of the writing unit 4107 is not limited to the one including such software, but may be the one including hardware.

The reading unit 4108 operates in response to an instruction from the control unit 4101, and reads 308 multimedia data stored in the data storage unit 4102. The reading unit 4108 is, as a representative example, a software sub-routine that uses a file access interface provided by the OS and the Java library. Note that the configuration of the reading unit 4108 is not limited to the one including such software, but may be the one including hardware.

The right processing unit 4109 is connected to the network interface 4110, operates in response to an instruction from the control unit 4101, and performs right processing following the use of multimedia data, such as billing by communicating with the broadcast receiving apparatus 3902. The right processing unit 4109 transmits, to the broadcast receiving apparatus 3902, an identifier that identifies multimedia data to be used, receives a response from the broadcast receiving apparatus 3902, and passes the response to the control unit 4101. The response is permission or rejection for the use of the multimedia data.

The network interface 4110 is configured of: hardware that provides an interface corresponding to a physical medium of a network, such as the Ether cable or a wireless LAN; and the driver software.

### Variation of the Third Embodiment

Although the third embodiment of the present invention is described, it should be obvious that the present invention is not limited to such above-mentioned embodiment. The present invention also includes such cases as described below.

(1) It is possible that the broadcast receiving apparatus further includes a storage unit that stores multimedia data and a writing unit that writes the multimedia data in the storage unit, and the selecting unit 4004 selects one of a storage unit of the broadcast receiving apparatus 3902 and a video storing apparatus connected to the network 3907. Furthermore, when receiving a request for viewing a TV-program in the Near VoD service from a terminal, the broadcast receiving apparatus 3902 may further check whether or not multimedia data of the content is stored in the video storing apparatus connected to the network 3907 and the storage unit of the broadcast receiving apparatus 3902, and when it is stored in the storage unit of the broadcast receiving apparatus 3902, the multimedia data may be transmitted to a terminal that issues a request for viewing the multimedia data.

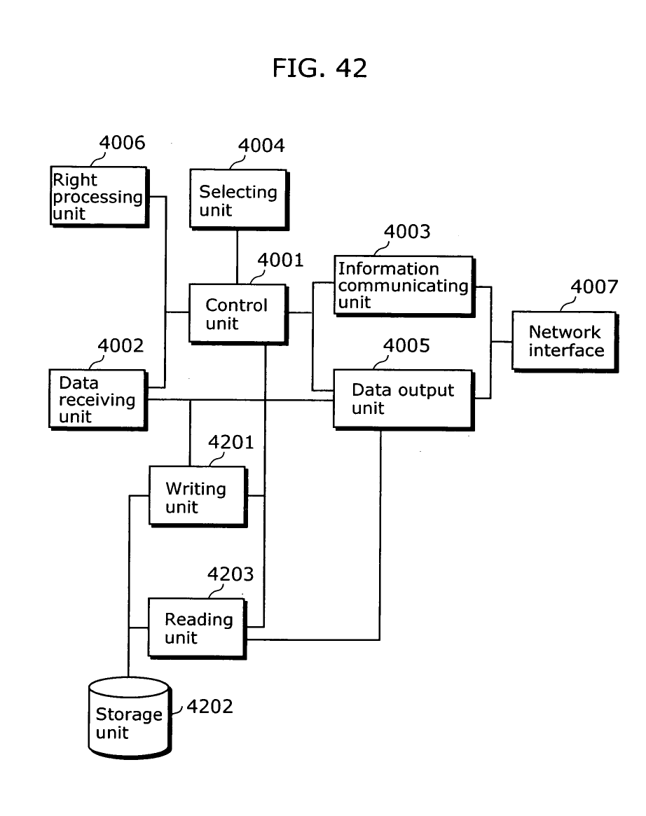

FIG. 42 is a block diagram showing the configuration of the broadcast receiving apparatus 3902 in the variation of the third embodiment of the present invention. The broadcast receiving apparatus 3902 shown in FIG. 42 includes a writing unit 4201, a storage unit 4202, a reading unit 4203 that reads multimedia data stored in the storage unit 4202, the control unit 4001, the data receiving unit 4002, the information communicating unit 4003, the selecting unit 4004, the data output unit 4005, the right processing unit 4006, and the network interface 4007.

Although the control unit 4001, the data receiving unit 4002, the information communicating unit 4003, the selecting unit 4004, the data output unit 4005, the right processing unit 4006, and the network interface 4007 are the same as described in the third embodiment, they differ in the following points. When the control unit 4001 causes the data receiving unit 4002 to receive, in advance, multimedia data for a broadcast TV-program in the Near VoD service, it receives the attributes from the video storing apparatuses 3903 and 3904, and at the same time reads the attributes of the broadcast receiving apparatus 3902. The attributes of the broadcast receiving apparatus 3902 is the same as the attribute information of the video storing apparatuses 3903 and 3904 in the third embodiment. Furthermore, the control unit 4001 transmits the attributes of the broadcast receiving apparatus 3902 to the selecting unit 4004, together with the attributes of the video storing apparatuses. The selecting unit 4004 selects one of the video storing apparatuses 3903 and 3904, or the storage unit 4202, based on the transmitted attributes.

The writing unit 4201 is the same as the writing unit 4107 of the video storing apparatuses 3903 and 3904 in the third embodiment. Furthermore, the storage unit 4202 is the same as the storage unit 4102 of the video storing apparatuses 3903 and 3904 in the third embodiment. Furthermore, the reading unit 4203 is the same as the reading unit 4108 of the video storing apparatuses 3903 and3904 in the third embodiment.

(2) Furthermore, it is possible that the broadcast receiving apparatus 3902 performs predetermined encryption on multimedia data and transmits the encrypted multimedia data to the video storing apparatuses 3903 and 3904. Furthermore, it is possible that the video storing apparatuses 3903 and 3904 decrypt the received and encrypted multimedia data, stores the data in the storage unit 4102, and further stores the data by performing predetermined encryption on the multimedia data.

Furthermore, when the broadcast receiving apparatus 3902, and the video storing apparatuses 3903 and 3904 transmit multimedia data to the terminals 3905 and 3906, it is possible that they perform predetermined encryption on the multimedia data, transmit the encrypted multimedia data, decrypt, in the terminals 3905 and 3906, the received and encrypted multimedia data, and reproduce the data.

(3) Furthermore, although the selecting unit 4004 of the broadcast receiving apparatus 3902 in the third embodiment selects a video storing apparatus based on a genre of multimedia data and the free space of the video storing apparatus, it is obvious that the conditions for selecting a video storing apparatus are not limited to these conditions. For example, it is possible that the broadcast receiving apparatus 3902 selects video receiving apparatuses in order. Furthermore, it is possible that the selection is based on priorities of the video storing apparatuses set by the user. Furthermore, it is possible to select a video storing apparatus only based on a genre of multimedia data. Furthermore, it is possible to select a video storing apparatus only based on a free space of a video storing apparatus. Furthermore, it is possible to select it according to use frequency of a video storing apparatus. Furthermore, it is possible to select a video storing apparatus by checking individual storing frequencies of genres, TV-program names, performers, and the like of multimedia data stored by the user's operation, with the genres, TV-program names, performers of multimedia data, and the like. Furthermore, it is possible to select a video storing apparatus by checking individual storing frequencies of genres, TV-program names, performers, and the like of multimedia data reproduced or outputted by the user's operation, with genres, TV-program names, performers, and the like of multimedia data. Furthermore, it is possible to select a pair of a terminal and a video storing apparatus according to data, for example, selecting the video storing apparatus 3903 for multimedia data having a high frequency to be used in the terminal 3905, and selecting the video storing apparatus 3904 for multimedia data having a high frequency to be used in the terminal 3906. Furthermore, it is possible to select a pair of a terminal and a video storing apparatus according to priorities of terminals set by the user.

(4) Furthermore, although the third embodiment describes that the broadcast receiving apparatus 3902 judges whether or not multimedia data of a content requested for viewing a TV-program in the Near VoD service is stored, by communicating with the video storing apparatuses 3902 and 3903, it is possible that the broadcast receiving apparatus 3902 stores multimedia data stored in the video storing apparatuses 3903 and 3904, and judges whether or not the data is stored based on the content of the stored multimedia data.

(5) Furthermore, although the Near VoD service is used in the third embodiment, it is possible to obtain the same advantage for rebroadcasting by storing a normal TV-program in advance.

(6) Furthermore, in the third embodiment, when multimedia data for a TV-program in the Near VoD service requested from a terminal is stored either in the video storing apparatus 3903 or 3904, the broadcast receiving apparatus 3902 issues, to the video storing apparatus that stores the data, a request for transmitting the multimedia data to the terminal that issues the request for viewing the TV-program, and notifies the terminal of information indicating that the multimedia data is to be transmitted from the video storing apparatus. However, it is possible that the broadcast receiving apparatus 3902 performs right processing such as billing with the video storing apparatus, notifies the video storing apparatus to the terminal, and issues a request for transmitting the multimedia data from the terminal to the video storing apparatus.

(7) Furthermore, in the third embodiment, when multimedia data for a TV-program in the Near VoD service requested from a terminal is stored either in the video storing apparatus 3903 or 3904, the broadcast receiving apparatus 3902 communicates with the video storing apparatus, and performs right processing following the use of the multimedia data, such as billing. However, it is possible that the broadcast receiving apparatus 3902 communicates with the terminal that issues the request for viewing the TV-program, and performs the right processing. Alternatively, it is possible that the broadcast receiving apparatus 3902 performs right processing without communicating with a video storing apparatus or a terminal.

Furthermore, although the right processing following the use of multimedia data, such as billing, is performed when a request for transmitting multimedia data is issued in the third embodiment, it is possible to perform the right processing after the multimedia data is used. Furthermore, it is possible to change the amount to be billed according to the number of times that the multimedia data is used, a use section, or the like.

(8) Furthermore, although single multimedia data is stored in a video storing apparatus in the third embodiment, it is possible to divide the multimedia data and distribute the divided data to plural video storing apparatuses. Alternatively, it is possible to concurrently store single multimedia data in the plural video storing apparatuses. With this, when plural terminals request identical multimedia data, it is possible to distribute loads in which the video storing apparatus transmits video to the terminal.

(9) Furthermore, the broadcast receiving apparatus 3902 further includes a coding unit that creates coded multimedia data, and it is possible that the broadcast receiving apparatus 3902 temporarily decodes multimedia data to be transmitted, newly creates multimedia data using the coding unit, and transmits the created multimedia data. Furthermore, it is possible that the video storing apparatuses 3903 and 3904 further include a decoding unit that decodes multimedia data, and a coding unit that creates coded multimedia data, and it is possible that the decoding unit temporarily decodes the received multimedia data, newly creates multimedia data and stores the created multimedia data, using the coding unit.

(10) It is possible that a part or all of the constituent elements making up each of the above-mentioned apparatuses is made from one system LSI (Large Scale Integration circuit). The system LSI is a super multi-function LSI that is manufactured by integrating plural elements in one chip, and is specifically a computer system which is configured by including a microprocessor, a ROM, a RAM, and so on. A computer program is stored in the RAM. The system LSI accomplishes its functions through the operation of the microprocessor in accordance with the computer program.

(11) It is possible that a part or all of the constituent elements making up each of the above-mentioned apparatuses is made from an IC card that can be attached to/detached from each apparatus, or a stand-alone module. The IC card or the module is a computer system made from a microprocessor, a ROM, a RAM, and so on. The IC card or the module may include the super multi-function LSI. The IC card or the module accomplishes its functions through the operation of the microprocessor in accordance with the computer program. The IC card or the module may also be tamper-resistant.

(12) The broadcast receiving apparatus and the video storing apparatus according to the present invention may operate in the aforementioned methods. Furthermore, the present invention may also be a computer program for executing such methods through a computer, or as a digital signal made from the computer program.

Furthermore, the broadcast receiving apparatus and the video storing apparatus of the present invention may be a computer-readable recording medium, such as a flexible disk, a hard disk, a CD-ROM, an MO, a DVD, a DVD-ROM, a DVD-RAM, a Blu-ray Disc (BD), or a semiconductor memory, on which the computer program or the digital signal is recorded. Furthermore, the broadcast receiving apparatus and the video storing apparatus of the present invention may also be the computer program or the digital signal recorded on such recording media.

Furthermore, the broadcast receiving apparatus and the video storing apparatus of the present invention may transmit the computer program or the digital signal via an electrical communication line, a wireless or wired communication line, a network represented by the Internet, a data broadcast, and so on.

Furthermore, the broadcast receiving apparatus and the video storing apparatus of the present invention compose a computer system including a microprocessor and a memory, with the memory storing the computer program and the microprocessor operating in accordance with the computer program.

Furthermore, the present invention may also be implemented in another independent computer system by recording the program or the digital signal on the recording medium and transferring the recording medium, or by transferring the program or the digital signal via the network, and the like.

(13) It is also possible to combine the third embodiment and the aforementioned variation.

### Fourth Embodiment

Since a configuration of a multimedia delivering system in the fourth embodiment is the same as that of the third embodiment shown in FIG. 39, the description is omitted hereinafter. Note that the broadcast receiving apparatus 3902 is a receiving apparatus for a cable television, and the receiving unit 3908 is a head end or a cable broadcast station in the present embodiment.

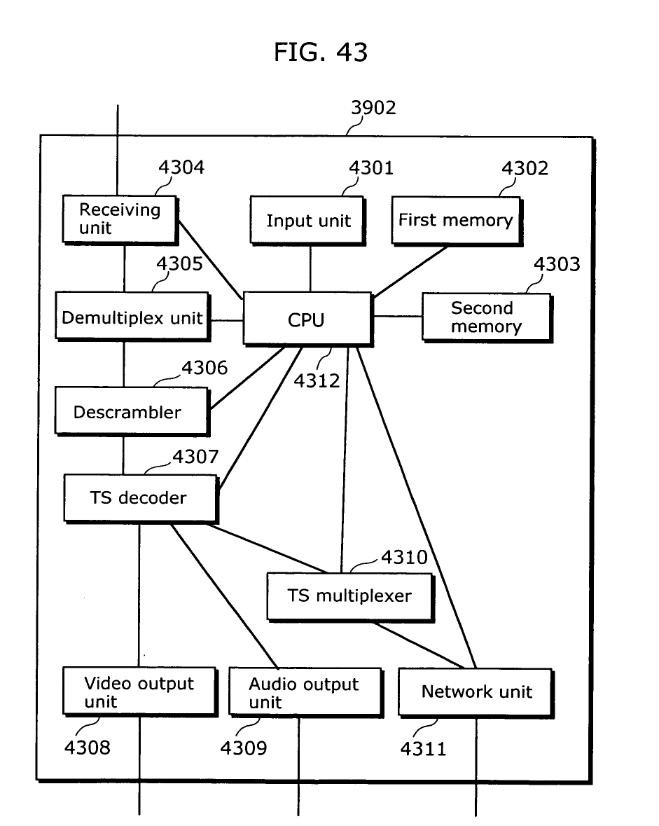

FIG. 43 is a block diagram showing a relationship between the constituent elements that compose the broadcast receiving apparatus 3902 according to the fourth embodiment of the present invention. The broadcast receiving apparatus 3902 in the present diagram includes an input unit 4301, a first memory 4302, a second memory 4303, a receiving unit 4304, a demultiplex unit 4305, a descrambler 4306, a TS decoder 4307, a video output unit 4308, an audio output unit 4309, a TS multiplexer 4310, a network unit 4311, and a CPU 4312.

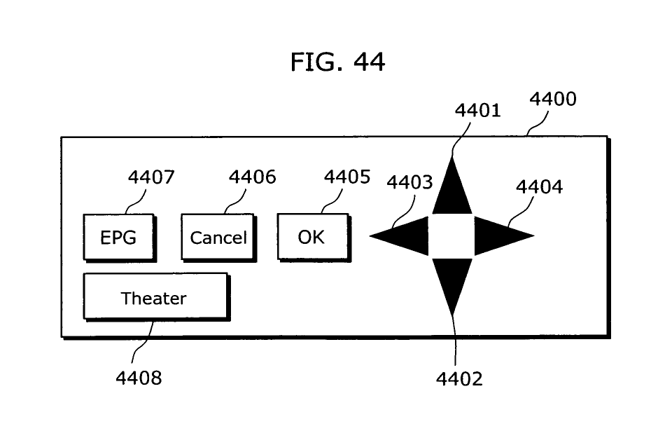

The input unit 4301 is configured of a front panel, remote control signal receiver, and the like, and accepts an instruction, such as a channel selection from a user. FIG. 44 shows an example of the input unit 4301 in the case where it is configured of a front panel in the fourth embodiment of the present invention. 4400 is a front panel configured of 8 buttons, namely, an up-cursor button 4401, a down-cursor button 4402, a left-cursor button 4403, a right-cursor button 4404, an OK button 4405, a cancel button 4406, an EPG button 4407, and a theater button 4408. When the user presses down a button, the identifier of such pressed button is notified to the CPU 4312.

The first memory 4302 is configured of a RAM, or the like, and is used when the CPU 4312 temporarily stores data.

The second memory 4303 is configured of a device that can hold information even when power is turned off, such as a flash memory, a hard disk, or the like, and stores a program executed by the CPU 4312. The second memory 4303 may use a detachable storage device such as an SD memory card and the like.

The receiving unit 4304 is connected to a cable from the broadcast station 3908, receives broadcast waves, tunes to the frequency specified by the CPU 4312, extracts an MPEG transport stream, and passes this to the demultiplex unit 4305.

The demultiplex unit 4305 receives the MPEG transport stream from the receiving unit 4304, extracts information specified by the CPU 4312, and passes this to the CPU 4312. Furthermore, the demultiplex unit 4305 passes the MPEG transport stream, as is, to the descrambler 4306.

The descrambler 4306 descrambles (decrypts) the scrambled MPEG transport stream provided by the demultiplex unit 4305, and passes this to the TS decoder 4307. The descrambler 4306 may be a module built-into the broadcast receiving apparatus 3902, and may also be implemented through the CableCARD™ introduced in North American cable receivers. The specifications of CableCARD are described in the CableCARD Interface Specification laid out by the CableLabs in United States, and thus the description is omitted herein.

The TS decoder 4307 receives, from the CPU 212, identifiers of section data such as audio data, video data, PSI/SI information, and so on. In addition, the TS decoder 507 extracts, from a descrambled stream received from the descrambler 4306, data corresponding to the identifiers of audio data, video data, section data such as PSI/SI information, and so on, and passes the extracted video data to the video output unit 4308, and the extracted audio data to the audio output unit 4309. Furthermore, it passes, to the TS multiplexer 4310, both the extracted video data and the audio data, and the section data.

The video output unit 4308, which includes a video output terminal, converts the received video data to video data that complies with the terminal and outputs this. An example of the terminal is a composite cable terminal, and so on.

The audio output unit 4309, which includes an audio output terminal, converts the received audio data to audio data that complies with the terminal and outputs this. Examples of the terminal are earphone terminals, a composite cable terminal, and so on.

The TS multiplexer 4310 configures an MPEG2 transport stream from the received video data, audio data, and section data, and passes the MPEG2 transport stream to the network unit 4311. The PSI/SI information can be rewritten as necessary.

The network unit 4311, which includes a network interface, converts the data received from the CPU 4312 into a signal that is in accordance with the physical media of the network to which the network interface is connected, and outputs this signal. Furthermore, the network unit 4311 receives a signal from the network interface, converts the signal into a packet defined by the IP network, and passes the packet to the CPU 4312.

The CPU 4312 controls the receiving unit 4304, the demultiplex unit 4305, the descrambler 4306, the TS decoder 4307, the TS multiplexer 4310, and the network unit 4311 by executing a program stored in the second memory 4303.

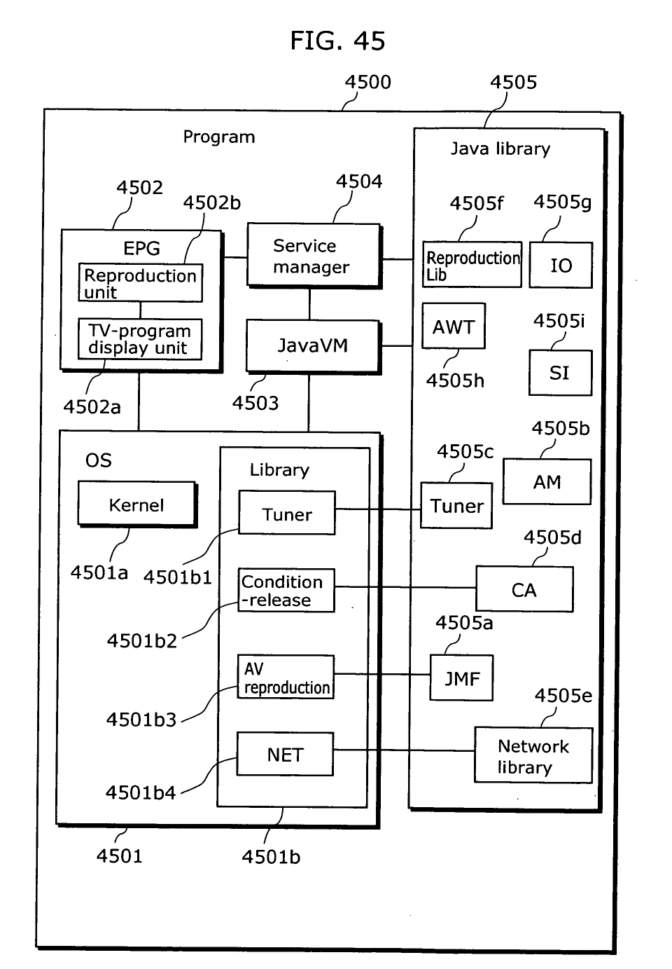

FIG. 45 is a structure diagram of a program to be held and executed by the broadcast receiving apparatus according to the fourth embodiment of the present invention. The diagram shows an example of a structure of the program stored in the second memory 4303 and executed by the CPU 4312.

The program 4500 is made up of plural subprograms, and specifically includes an OS 4501, an EPG 4502, a Java VM 4503, a service manager 4504, and a Java library 4505.

The OS 4501 is a subprogram activated on the CPU 4312 when power to the broadcast receiving apparatus 3902 is turned on. OS is the acronym of operating system, an example of which is Linux and the like. The OS 4501 is a generic name for publicly known technology made up of a kernel 4501a for executing a subprogram concurrently with another subprogram and of a library 4501b, and thus, the detailed description is omitted. In the present embodiment, the kernel 4501a of the OS 4501 executes the EPG 4502 and the VM 4503 as subprograms. Furthermore, the library 4501b provides these subprograms with plural functions required for controlling the constituent elements of the broadcast receiving apparatus 3902.

In the present embodiment, the library 4501b includes a tuner 4501b1, condition-release 4501b2, AV reproduction 4502b3, and NET 4501b4, as an example of functions.

The tuner 4501b1 receives tuning information including a frequency from other subprograms or a Tuner 4505c of the Java library 4505, and passes this to the receiving unit 4304. The receiving unit 4304 can perform demodulation based on the provided tuning information, and pass the demodulated data to the demultiplex unit 4305. As a result, the other subprograms and the Tuner 4305c of the Java library 4305 can control the receiving unit 4304 through the library 4501b.

The condition-release 4502b2 receives information from other subprograms or a CA 4505d of the Java library 4505, and passes this to the descrambler 4306.

The AV reproduction 4502b3 receives an audio packet ID and a video packet ID from the other subprograms or a JMF 4505a of the Java library 4505. It then provides the received audio packet ID and video packet ID to the TS decoder 4507. As a result, the TS decoder 4507 performs filtering based on the provided packet IDs, and implements the reproduction of audio/video.

The NET 4501b4 creates packets of a protocol lower than the application layer defined by the IP network, for the data received from the other subprograms or a network library 4505e of the Java library 4505. A protocol lower than the application layer refers to, for example, a TCP packet, a UDP packet, an IP packet, and so on. By passing this to the network unit 4311, messages and data are transmitted to other devices via the network 3907. Furthermore, when a message is received from other devices via the network 3907, the NET 4501b4 converts the message to an application layer protocol packet and passes this to the other subprograms or the network library 4505e of the Java library 4505. An application layer protocol refers to, for example, HTTP, RTP, and so on.

The EPG 4502 includes a TV-program display unit 4502a for displaying a list of TV-programs to the user as well as for accepting an input from the user, and a reproduction unit 4502b for selecting channels. Here, EPG is an abbreviation of Electric Program Guide. The EPG 4502 is activated by the kernel 4501a when power to the broadcast receiving apparatus 3902 is turned on. Inside the activated EPG 4502, the TV-program display unit 4502a and the reproduction unit 4502b are activated at the same time. When activated, the TV-program display unit 4502a waits for an input from the user through the input unit 4301 of the broadcast receiving apparatus 3902. Here, in the case where the input unit 4301 is made up of the front panel illustrated in FIG. 44, when the user presses down the EPG button 4407 on the input unit 4301, the CPU 4312 is notified of the identifier of such EPG button. The TV-program display unit 4502a of the EPG 4502, which is a subprogram running on the CPU 4312, accepts this identifier, creates program information display data, and outputs the data to a monitor, using a monitor output unit not shown in the figure. The monitor may be included in the broadcast receiving apparatus 3902, and may also be a television connected to the broadcast receiving apparatus 3902 via a composite cable, HDMI cable, or the like. The monitor 4610 displays the received TV-program information display data.

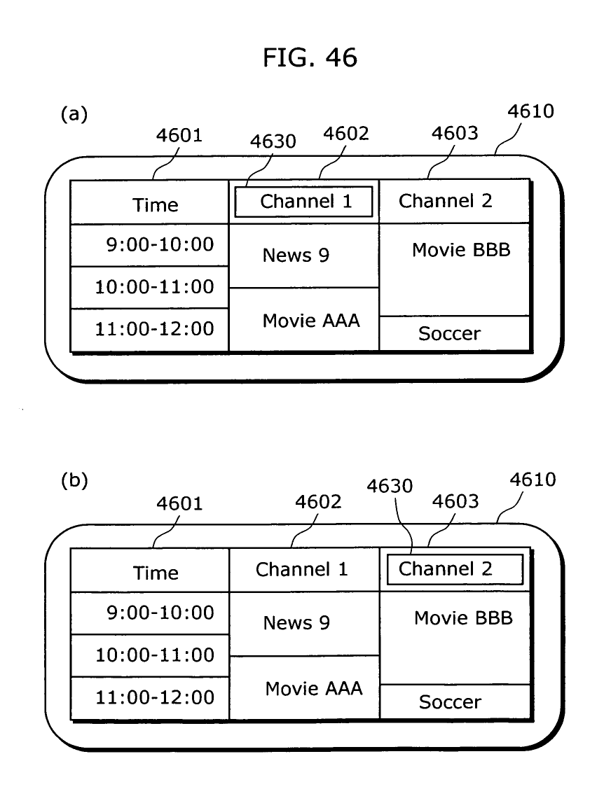

FIG. 46(a) and (b) show examples of a TV show table displayed on the monitor according to the fourth embodiment of the present invention. With reference to FIG. 46(a), TV program information is displayed on the monitor 4610 in a grid pattern. A column 4601 displays time information. A column 4602 displays a channel name “Channel 1” and TV-programs to be broadcasted during time periods corresponding to the respective times described in the column 4601. The monitor 4610 shows that, on “Channel 1”, a TV-program “News 9” is broadcast from 9:00 to 10:30, and “Movie AAA” is broadcast from 10:30 to 12:00. A column 4603 displays a channel name “Channel 2” and TV-programs to be broadcasted during time periods corresponding to the respective times described in the column 4603, as the column 4602 does. The monitor 4610 shows that, on “Channel 2”, a TV-program “Movie BBB” is broadcast from 9:00 to 11:00, and “Soccer” is broadcast from 11:00 to 12:00. 4630 is a cursor. The cursor 4630 moves at the press of the left-cursor 4403 or the right-cursor 4404 on the front panel 4400. When the right-cursor 4404 is pressed down in the state illustrated in FIG. 46(a), the cursor 4630 moves towards the right as shown in FIG. 46(b). Furthermore, when the left-cursor 4403 is pressed down in the state illustrated in FIG. 46(b), the cursor 4630 moves towards the left as shown in FIG. 46(a).

When the OK button 4405 on the front panel 4400 is pressed down in the state shown in FIG. 46(a), the TV program display unit 4502a notifies the reproduction unit 4502b of the identifier of “Channel I”. When the OK button 4405 on the front panel 4400 is pressed down in the state shown in FIG. 46(b), the TV program display unit 4502a notifies the reproduction unit 4502b of the identifier of “Channel 2”.

Furthermore, the TV-program display unit 4502a stores TV-program information to be displayed, in the second memory 4303 through the demultiplex unit 4305 at regular intervals. Generally, it takes time to obtain TV-program information from a broadcast station. It is possible to quickly display a TV show table by displaying the TV-program information stored, in advance, in the second memory 203, at the press of the EPG button 4407 of the input unit 4301.

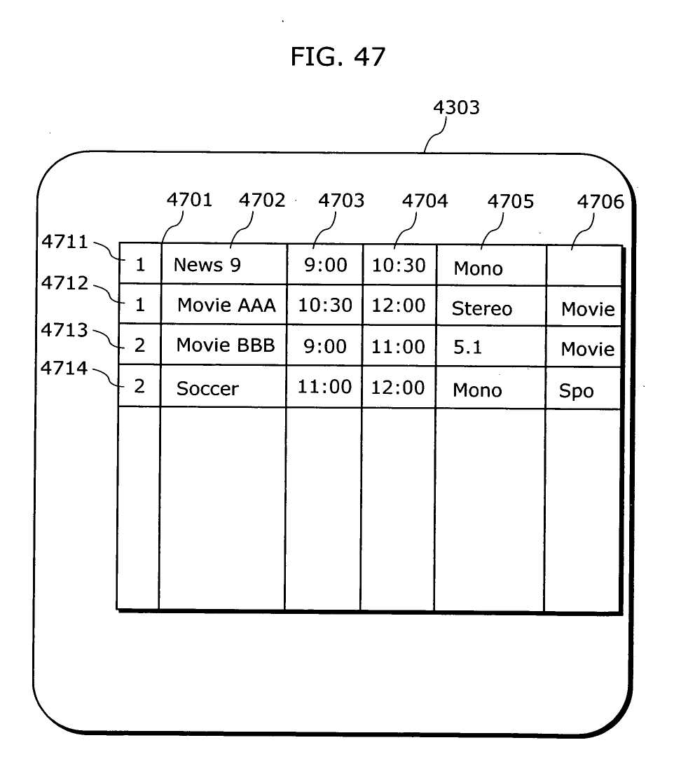

FIG. 47 is a diagram showing an example of TV-program information stored in the second memory 4303 according to the fourth embodiment of the present invention. The TV-program information is stored in tabular form. A column 4701 describes the identifiers of channels. A column 4702 describes TV-program names. A column 4703 describes the broadcast start times of the TV-programs, and a column 4704 describes the broadcast end times. A column 4705 describes the sound type of the programs, and indicates mono sound, stereo sound, and 5.1 channel sound as “mono”, “stereo”, and “5.1”, respectively. A column 4706 describes the type of the programs. A regular TV-program is described as an empty cell, a movie is described as “movie”, and a sports program is described as “spo”. Each of rows 4711 to 4714 describes information for one TV-program. In this example, one TV-program information is the set of the channel identifier, channel name, broadcast start time, broadcast end time, and TV-program sound type. For example, the row 4711 describes a set which includes “1” as the channel identifier, “News 9” as the TV-program name, “9:00” as the broadcast start time, “10:30” as the broadcast end time, “mono” as the sound-type, and “regular” as the TV-program type.

The reproduction unit 4502b reproduces a channel using the received identifier of the channel. In other words, it reproduces the video and audio making up the channel. The relationship between channel identifiers and channels is pre-stored in the second memory 4303 as channel information.

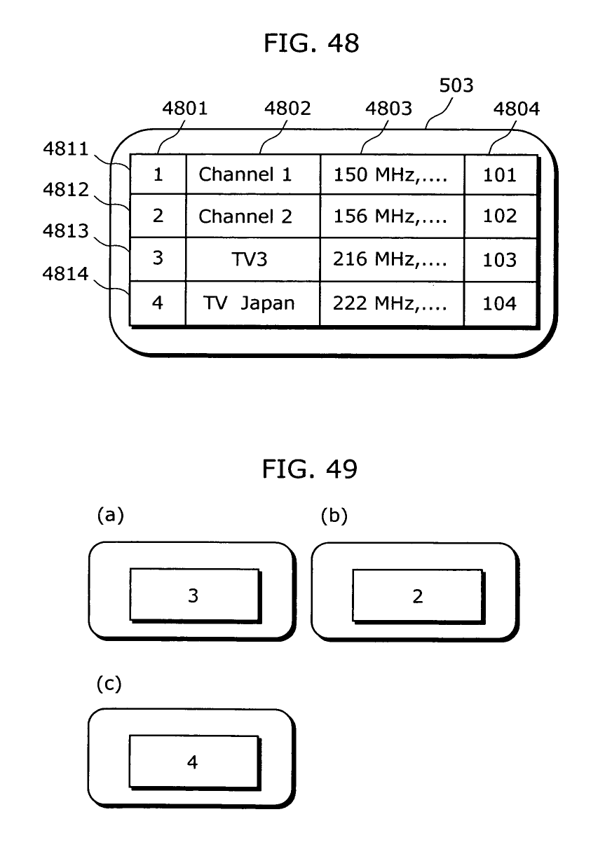

FIG. 48 is a diagram showing an example of channel information stored in the second memory 4303 according to the fourth embodiment of the present invention. The channel information is stored in tabular form. A column 4801 describes the identifiers of channels. A column 4802 describes channel names. A column 4803 describes tuning information. Here, the tuning information is represented by values to be provided to the receiving unit 4304, such as frequency, transmission rate, and coding ratio. A column 4804 describes program numbers. Program numbers are numbers used to identify PMTs defined by the MPEG-2 standard. A description about PMT is given later. Each of rows 4811 to 4814 indicates a set of the identifier, channel name, and tuning information of each channel. The row 4811 describes a set that includes “1” as an identifier, “Channel 1” as a channel name, a frequency of “150 MHz” as tuning information, and “101” as a program number. The reproduction unit 4502b passes the identifier of the received channel directly to the service manager in order to reproduce the channel.

Moreover, when the user presses down the up-cursor 4401 or the down-cursor 4402 on the front panel 4400 while the reproduction is taking place, the reproduction unit 4502b receives a notification about such pressing from the input unit 4501 through the CPU 4512, and changes the channel being reproduced accordingly. When the up-cursor 4401 is pressed down, a channel having the next lower channel identifier to that of the currently-reproduced channel is reproduced, and when the down-cursor 4402 is pressed down, a channel having the next higher channel identifier to that of the currently-reproduced channel is reproduced. First, the reproduction unit 4502b stores, in the second memory 4303, the identifier of the channel that is currently reproduced. FIG. 49(a), (b), and (c) is an example of information each indicating an identifier of a channel stored in the second memory 4303 according to the fourth embodiment of the present invention.

FIG. 49(a) shows that an identifier “3” is stored, and by referring to FIG. 48, it is shown that a channel having the channel name “TV 3” is currently being reproduced. When the user presses down the up-cursor 4401 in a state illustrated in FIG. 49(a), the reproduction unit 4502b refers to the channel information shown in FIG. 48, and passes the identifier “2” of a channel with the channel name of “Channel 2” to the service manager in order to switch reproduction to the channel with the channel name of “Channel 2” which is the channel having an identifier that is one value lower than that of the channel currently being reproduced in the table. At the same time, the reproduction unit 4502b rewrites the identifier stored in the second memory 4303 to the channel identifier “2”.

FIG. 49(b) shows the state in which the channel identifier has been rewritten. When the user presses down the down-cursor 4402 in a state illustrated in FIG. 49(a), the reproduction unit 4502b refers to the channel information shown in FIG. 48, and passes the identifier “4” of a channel with the channel name of “TV Japan” to the service manager in order to switch reproduction to the channel with the channel name of “TV Japan” which is the channel having an identifier that is one value higher than that of the channel currently being reproduced in the table. At the same time, the reproduction unit 4502b rewrites the identifier stored in the second memory 4303 to the channel identifier “4”.

FIG. 49(c) shows the state in which the channel identifier has been rewritten. The channel identifier is saved even when power to the broadcast receiving apparatus 3902 is cut-off since it is stored in the second memory 4303.

Furthermore, upon being activated when power to the broadcast receiving apparatus 3902 is turned on, the reproduction unit 4502b reads the channel identifier stored in the second memory 4303. Then, the reproduction unit 4502b passes such channel identifier to the service manager. Thus, when power is turned on, the broadcast receiving apparatus 3902 is able to start the reproduction of the last channel that has been reproduced during its previous operation.

The Java VM 4503 is a Java virtual machine that sequentially analyzes and executes programs written in the Java™ language. Programs written in the Java language are compiled into intermediate codes known as byte codes which are not dependent on hardware. A Java virtual machine is an interpreter that executes such byte code. Some Java virtual machines pass the byte code to the CPU 4312 after translating the byte code into an execution format which can be interpreted by the CPU 4312, and execute it. The Java VM 4503 is activated, with a Java program to be executed being specified by the kernel 4501a. In the present embodiment, the kernel 4501a specifies the service manager 4504 as the Java program to be executed. Details of the Java language are described in many publications such as “Java Language Specification (ISBN 0-201-63451-1)”. Here, such details are omitted. Furthermore, the detailed operation of the Java VM itself is described in many publications such as “Java Virtual Machine Specification (ISBN 0-201-63451-X)”. Here, such details are omitted.

The service manager 4504, which is a Java program written in the Java language, is sequentially executed by the Java VM 4503. It is possible for the service manager 4504 to call and be called by another subprogram not written in the Java language, through the Java Native Interface (JNI). The JNI is also described in many publications such as in the book “Java Native Interface” and so on. Here, such details are omitted.

The service manager 4504 accepts the identifier of a channel from the reproduction unit 4502b, through the JNI.

The service manager 4504 first passes the identifier of the channel to the Tuner 4505c in the library 4505, and requests for tuning. The Tuner 4505c refers to the channel information stored in the second memory 4303, and obtains the tuning information. Now, when the service manager 4504 passes the identifier “2” of the channel to the Tuner 4505c, the Tuner 4505c refers to the column 4812 shown in FIG. 48, and obtains the corresponding tuning information “156 MHz”. The Tuner 4505c passes the tuning information to the receiving unit 4504 through the tuner 4501b1 of the library 4501b of the OS 4501. The receiving unit 4504 performs demodulation on the signal transmitted from the broadcast station, based on the provided tuning information, and passes the result to the demultiplex unit 4505.

The service manager 4504 requests the CA 4505d inside the Java library 4505 to perform descrambling. The CA 4505d provides the descrambler 4306 with information required for descrambling, through the condition-release 4501b2 of the library 4501b in the OS 4501. On the basis of such provided information, the descrambler 4306 descrambles the signal provided by the receiving unit 4304, and passes the result to the TS decoder 4307.

A case where video and audio is reproduced by outputting the video and audio from the video output unit 4308 and the audio output unit 4309, respectively and a case where multimedia data is outputted from the network unit 4311 are to be described individually, since each processing is different.

First, the case where video and audio is reproduced is to be described. The service manager 4504 provides the identifier of the channel to the JMF 4505a inside the Java library 4505, and requests for the reproduction of the video and audio.

First, the JMF 4505a obtains, from a PAT and a PMT, packet IDs used to specify the video and audio to be reproduced. PAT and PMT are tables stipulated by the MPEG-2 standard that shows the TV-program line-up included in an MPEG-2 transport stream. PAT and PMT are embedded in the payloads in packets included in an MPEG-2 transport stream, and sent together with audio and video. Refer to the Specification for details. Here, only the outline shall be described. PAT, which is an abbreviation of Program Association Table, is stored and sent in packets with the packet ID “0”. In order to obtain the PAT, the JMF 4505a specifies, to the demultiplex unit 4305, the packet ID “0”, through the library 4501b of the OS 4501. The demultiplex unit 4305 performs filtering based on the packet ID “0” and, by passing the result to the CPU 4312, the JMF 4505a collects the PAT packets.

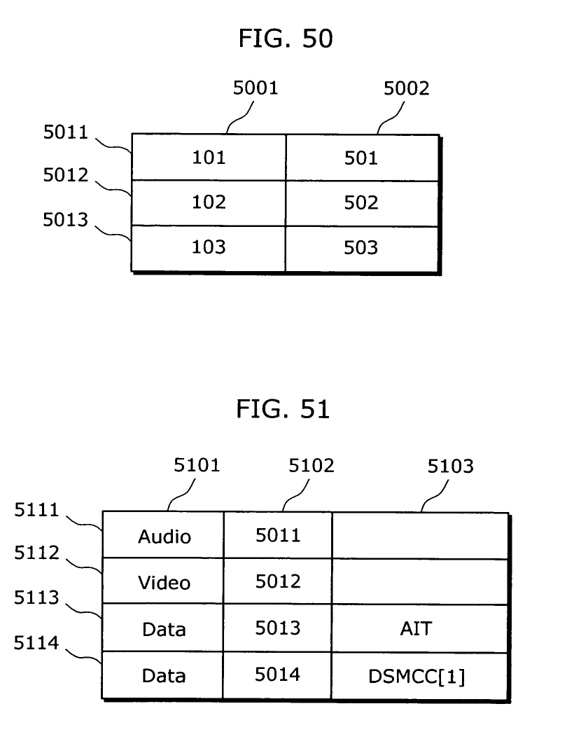

FIG. 50 schematically shows an example of the collected PAT information according to the fourth embodiment of the present invention. A column 5001 describes program numbers. A column 5002 describes packet IDs. The packet IDs shown in the column 5002 are used to obtain the PMT. Each of rows 5011 to 5013 is a pair of the program number of a channel and a corresponding packet ID. Here, three channels are defined. The row 5011 defines a pair of the program number “101” and the packet ID “501”. Now, when the channel identifier provided to the JMF 4505a is “2”, the JMF 4505a refers to the column 4812 in FIG. 48, so as to obtain the corresponding program number “102”, and then refers to the column 5012 in the PAT shown in FIG. 50, so as to obtain the packet ID “502” corresponding to the program number “102”. PMT, which is an abbreviation of Program Map Table, is stored and sent in packets of the packet ID stipulated in the PAT. In order to obtain the PMT, the JMF 4505a specifies, to the demultiplex unit 4305, a packet ID, through the library 4501b of the OS 4501. Here, it is assumed that the packet ID specified is “502”. The demultiplex unit 4305 performs filtering based on the packet ID “502” and, by passing the result to the CPU 4312, the JMF 4505a collects the PMT packets.

FIG. 51 schematically shows an example of the collected PMT information according to the fourth embodiment of the present invention. A column 5101 describes stream types. A column 5102 describes packet IDs. Information specified in the respective stream types is stored and sent in the payloads of packets with the packet IDs specified in the column 5102. A column 5103 describes supplementary information. Each of columns 5111 to 5114 is a pair of a packet ID and the type of information being transmitted, which is known as an elementary stream. The column 5111, which is a pair of the stream type “audio” and the packet ID “5011”, indicates that audio data is stored in the payload of the packet with the packet ID “5011”. The JMF 4505a obtains, from the PMT, the packet IDs of the video and audio to be reproduced. Referring to FIG. 51, the JMF 4505a obtains the audio packet ID “5011” from the row 5111, and the video packet ID “5012” from the row 5112.

Next, the JMF 4505a passes the obtained audio packet ID and video packet ID to the AV reproduction 4501b3 of the library 4501b of the OS 4501. Upon receiving this, the AV reproduction 4501b3 provides the received audio packet ID and video packet ID to the TS decoder 4307. The TS decoder 4307 performs filtering based on such provided packet IDs. Here, the packet with the packet ID “5011” is passed to the audio output unit 4309, and the packet with the packet ID “5012” is passed to the video output unit 4308. Then, the audio output unit 4309 converts (for example, digital-analog conversion) the provided packet, as necessary, and outputs the packet. The video output unit 4308 converts (for example, digital-analog conversion) the provided packet, as necessary, and outputs the packet.

Finally, the service manager 4504 provides the identifier of the channel to the AM 4505b inside the Java library 4505, and requests for data broadcast reproduction. Here, data broadcast reproduction refers to extracting a Java program included in the MPEG-2 transport stream, and having it executed by the Java VM 4503. As a method of embedding a Java program into an MPEG-2 transport stream, a method referred to as DSMCC, which is described in the MPEG Standard ISO/IEC 13818-6, is being used. Here, detailed description of DSMCC shall be omitted. The DSMCC format defines a method of encoding, in packets within an MPEG-2 transport stream, a file system made up of directories and files used by a computer. Furthermore, information about the Java program to be executed is embedded and sent in packets in the MPEG-2 transport stream in a format referred to as AIT. AIT is an abbreviation of Application Information Table defined in the 10th chapter of the DVB-MHP Standard (formally as, ETSI TS 101 812 DVB-MHP Specification V1.0.2).

First, in order to obtain the AIT, the AM 4505b obtains the PAT and PMT as in the case of the JMF 4505a, so as to obtain the packet ID of the packet that stores the AIT. Now, when “2” is the identifier of the provided channel and the PAT shown in FIG. 50 and the PMT shown in FIG. 51 are being transmitted, the AM 4505b obtains the PMT shown in FIG. 51 according to the same procedure followed by the JMF 4505a. The AM 4505b extracts, from the PMT, the packet ID of the elementary stream having a stream type of “Data” and which has “AIT” as supplementary information. With reference to FIG. 51, the elementary stream in the row 5113 corresponds to such elementary stream, and therefore the AM 4505b obtains the packet ID “5013” from it.

The AM 4505b provides the packet ID of the AIT to the demultiplex unit 4305, through the library 4501b of the OS 4501. The demultiplex unit 4305 performs filtering based on such provided packet ID, and passes the result to the CPU 4312. As a result, the AM 4505b can collect the packets of AIT.

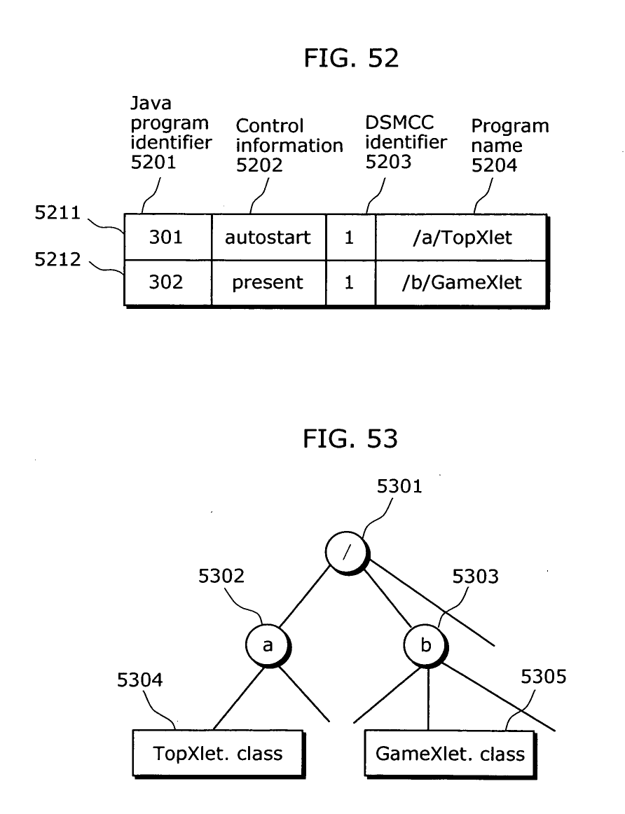

FIG. 52 schematically shows an example of the collected AIT information according to the fourth embodiment of the present invention. A column 5201 describes the identifiers of Java programs. A column 5202 describes control information of the Java programs. The control information includes “autostart”, “present”, and “kill”. “autostart” means that the broadcast receiving apparatus 3902 automatically executes the program promptly. “present” means that the program is not executed automatically. “kill” means that the program is to be terminated. A column 5203 describes DSMCC identifiers for extracting packet IDs including a Java program in the DSMCC format. A column 5204 describes program names of the Java programs. Each of rows 5211 and 5212 is a set of information about a Java program. The Java program defined in the row 5211 is a set of an identifier “301”, control information “autostart”, a DSMCC identifier “1”, and a program name “a/TopXlet”. The Java program defined in the row 5212 is a set of an identifier “302”, control information “present”, a DSMCC identifier “1”, and a program name “b/GameXiet”. Here, the two Java programs have the same DSMCC identifier which indicates that two Java programs are included within a single file system encoded in the DSMCC format. Here, although only four items of information are stipulated for the respective Java programs, more items of information are specified actually. Refer to the DVB-MHP standard for details.

The AM 4505b finds the “autostart” Java program from within the AIT, and extracts the corresponding DSMCC identifier and Java program name. Referring to FIG. 52, the AM 4505b extracts the Java program in the row 5211, and obtains the DSMCC identifier “1” and the Java program name “a/TopXlet”. Next, using the DSMCC identifier obtained from the AIT, the AM 4505b obtains, from the PMT, the packet ID of packets that store Java programs in the DSMCC format. More specifically, the AM 4505b obtains, from the PMT, the packet ID of the elementary stream whose stream type is “Data” and having a matching DSMCC identifier in the supplementary information.

Now, assuming that such DSMCC identifier is “1” and the PMT is the one shown in FIG. 51, the elementary stream in the row 5114 matches, and the packet ID “5014” is to be extracted.

The AM 4505b provides the demultiplex unit 4305 with the packet ID of the packet in which data is embedded in the DSMCC format, through the library 4501b of the OS 4501. Here, the packet ID “5014” is provided. The demultiplex unit 4305 performs filtering based on such provided packet ID, and passes the result to the CPU 4312. As a result, the AM 4505b can collect the required packets. The AM 4505b reconstructs the file system from the collected packets, according to the DSMCC format, and stores this in the first memory 4302 or the second memory 4303. Extracting the data of a file system and the like, and storing this in the first memory 4302 or the second memory 4303 shall hereafter be referred to as download.

FIG. 53 shows an example of a downloaded file system according to the fourth embodiment of the present invention. In the diagram, a circle denotes a directory and a square denotes a file. 5301 denotes a root directory, 5302 denotes a directory “a”, 5303 denotes a directory “b”, 5304 denotes a file “TopXlet.class”, and 5305 denotes a file “GameXlet.class”.

Here, although an example of downloading a file system from an MPEG2 transport stream is described, the OCAP specification also stipulates downloading using an IP network, and so on. Furthermore, the OCAP specification also stipulates a method for identifying the location of a file system using information referred to as XAIT, instead of AIT, and a method for downloading the file system.

Next, the AM 4505b passes, to the Java VM 4503, the Java program to be executed from within the file system downloaded into the first memory 4302 or the second memory 4303. Here, when the name of the Java program to be executed is “a/TopXlet”, the file “a/TopXlet.class”, having “.class” added to the end of the Java program name, is the file to be executed. “/” is a division of a directory and file name and, by referring to FIG. 53, the file 5304 is the Java program to be executed. Next, the AM 4505b passes the file 5304 to the Java VM 4503.

The Java VM 4503 executes the Java program passed to it.

Next, the process of outputting multimedia data from the network unit 4311 is to be described.

First, the service manager 4504 provides the identifier of the channel to the network library 4505e inside the Java library 4505, and requests for transmitting the data. The network library 4505e first obtains the PAT and PMT in the same manner as the JMF 4505a and AM 4505b, and obtains packet IDs for the video data, audio data, and respective section data relating to the TV-program to be transmitted. Now, when “2” is the identifier of the provided channel and the PAT shown in FIG. 50 and the PMT shown in FIG. 51 are being transmitted, the AM 4505b obtains the PMT shown in FIG. 51 according to the same procedure followed by the JMF 4505a. The data to be transmitted are all the data described in the PMT in FIG. 51.

The network library 4505e provides these packet IDs to the TS decoder 4307 via the library 4501b of the OS 4501 and causes these to be outputted to the TS multiplexer 4310. The TS decoder 4307 performs filtering based on such provided packet IDs, and passes the result to the TS multiplexer 4310.

The network library 4505e provides, to the TS multiplexer 4310 through the library 4501b of the OS 4501, the number of types of data to be transmitted, and causes the configuration of an MPEG2 transport stream from the data passed on from the TS decoder 4307. The TS multiplexer 4310 passes the configured MPEG2 transport stream to the CPU.

In addition, the network library 4310e provides the address of the transmission destination to the NET 4501b4 of the library 4501b of the OS 4501. Next, the network library 4501b4 converts the MPEG-2 transport stream received from the TS multiplexer 4310 into a format that is in accordance with the protocol of the application layer to be transmitted, and passes this sequentially to the NET 4501b4. An application layer protocol refers to, for example, HTTP, RTP, and so on. With this, the NET 4501b4 refers to the transmission destination address, and converts the data passed on to it into packets for the IP network and passes these to the network unit 4311. The network unit 4311 converts the data passed on to it into a signal that is in accordance with the physical media of the network connected to, and outputs this signal.

Upon receiving an identifier of an other channel, the service manager 4504 stops the execution or the output to the network, though the respective libraries included in the Java library 4505, of the video/audio and Java program currently being reproduced and performs the reproduction of video/audio, and execution of a Java program or the output of the Java program to the network, based on the newly received channel identifier.

Furthermore, the service manager 4504 also includes a function for receiving the identifier of a channel from a Java program executed on the Java VM 4503, aside from the reproduction unit 4502b. Specifically, a Java language class for obtaining the identifier of the channel, and the method thereof, are provided. Upon receiving an identifier of an other channel, the service manager 4504 stops the execution or the output to the network, though the respective libraries included in the Java library 4505, of the video/audio and Java program currently being reproduced, and performs the reproduction of video/audio, and execution of a Java program or the output of the Java program to the network, based on the newly received channel identifier.

Furthermore, although the reproduction and output to the network, of a general TV-program is described above, the same processing is performed on a Near VoD service.

The Java library 4505 is a collection of plural Java libraries stored in the second memory 4303. In the present embodiment, the Java library 4505 includes the JMF 4505a, the AM 4505b, the Tuner 4505c, the CA 4505d, the network library 4505e, a reproduction Lib 4505f, an IO 4505g, an AWT 4505h, and the like.

The functions of the JMF 4505a, the AM 4505b, the Tuner 4505c, and the CA 4505d have already been described, and thus the description is omitted.

The reproduction Lib 4505f provides the class and method of the Java language (hereafter called Java API) for passing, to the Java program, the identifier of the channel currently being reproduced, which is stored in the second memory 4303. By using this Java API, the Java program is able to recognize the channel that is currently being reproduced.

The IO 4505g provides, to the Java program, Java APIs for the writing of data to the second memory 4303 by the Java program, or a Java API for the reading of such data which has been written, from the second memory 4503. By using this API, the Java program is able to store arbitrary data in the secondary memory 4303. Since such stored data is not erased even when power to the broadcast receiving apparatus 3902 is turned off, the data can be read again after power to the broadcast receiving apparatus 3902 is turned on.

The AWT 4505h provides Java APIs for drawing or for the reception of a key input notification from the input unit 4301, by the Java program. To be more specific, these correspond to the java.awt package, java.awt.event package, and other java.awt subpackages described in “The Java class Libraries Second Edition, Volume 2” (ISBN0-201-31003-1). Here, the detailed description shall be omitted. The SI 4505i provides Java APIs for the obtaining of channel information and electronic program information by the Java program. To be more specific, there are the Java TV Specification and the like. Furthermore, the MPEG section filter API for obtaining raw binary data from an MPEG-2 transport stream currently being broadcast is defined in the OCAP Specification, and the Java application can understand and handle unique electronic program data that has been transmitted.

The network library 4505e communicates with the video storing apparatuses 3903 and 3904, and the terminals 3905 and 3906 which are connected to the network 3907, through the NET 4501b4 of the library 4501b of the OS 4501. Furthermore, between the network library 4505e and the video storing apparatuses 3903 and 3904, following communication is performed for: transmitting and receiving the attributes of the video storing apparatuses; transmitting a request for storing multimedia data and the multimedia data; inquiring whether or not particular multimedia data is stored; requesting transmission of the stored multimedia data; and right processing following the use of the multimedia data. Furthermore, between the network library 4505e and the terminals 3905 and 3906, following processing is performed: accepting a request for transmitting multimedia data; and transmitting the multimedia data; or notifying a video storing apparatus to which the multimedia data is transmitted.

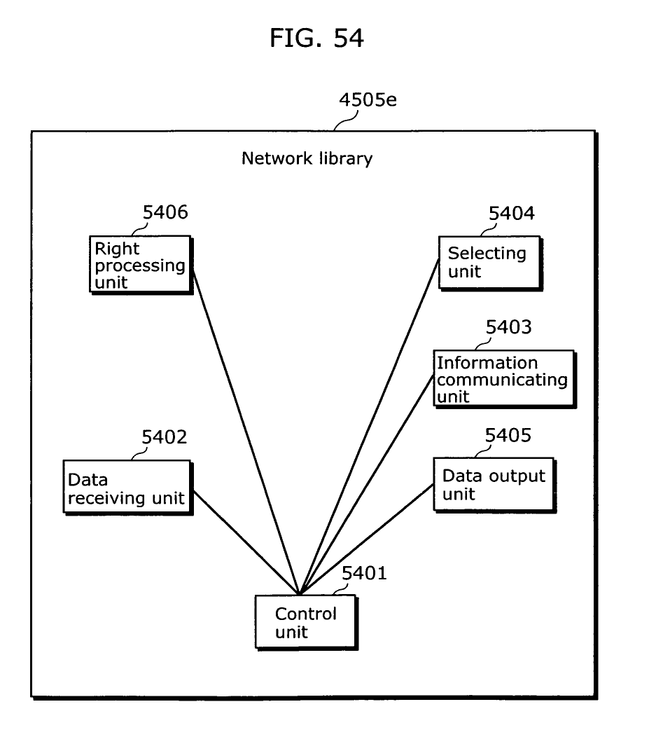

FIG. 54 is a block diagram showing an example of an internal configuration of the network library 4505e according to the fourth embodiment of the present invention. The network library 4505e includes a control unit 5401, a data receiving unit 5402, an information communicating unit 5403, a selecting unit 5404, a data output unit 5405, and a right processing unit 5406. Note that the network library 4505e may include other functions relating to the IP network.

The control unit 5401 provides, to a downloaded Java application, the functions which the network library 4505e implements. In other words, the Java application can execute network functions by calling the Java APIs provided by the control unit 5401. When the Java API is called, the control unit 5401 performs processes using the data receiving unit 5402, the information communicating unit 5403, the selecting unit 5404, the data output unit 5405, the right processing unit 5406, and the rest of the Java library 4505 and the library 4501b of the OS 4501, as necessary.

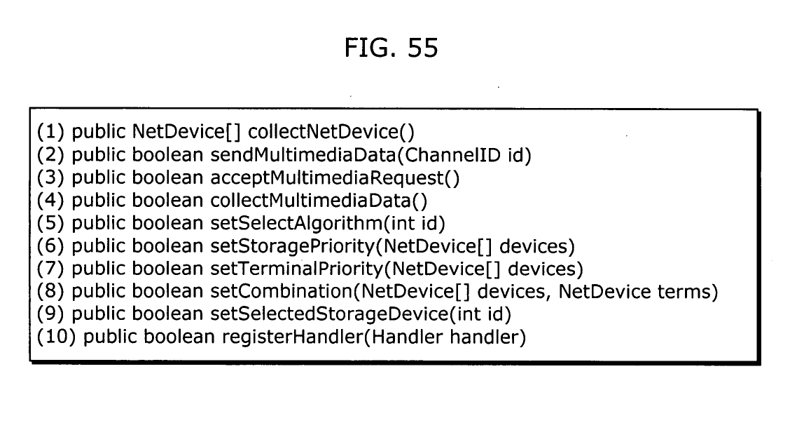

FIG. 55 is a diagram showing an example of Java APIs provided by the control unit 5401 according to the fourth embodiment of the present invention.

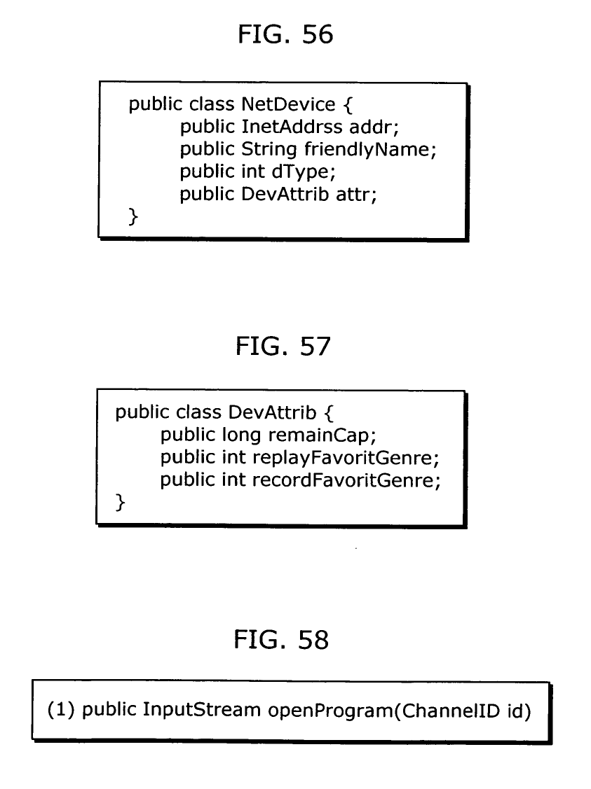

The method collectNetDevice( ) in FIG. 55 (1) collects information on an external device connected to the network 3907, and returns, as such information, the array of NetDevice objects. More specifically, the control unit 5401 calls the method collectNetDevice( ) of the information communicating unit 5403 to be described later, and returns the return value. With this method, it is possible to obtain information on the device connected to the network. FIG. 56 shows an example of the structure of a NetDevice class. In FIG. 56, addr represents the network address of the device, friendlyName represents the nickname given to the device, dType represents the type of the device, 0 represents the broadcast receiving apparatus, 1 represents the video storing apparatus, and 2 represents the terminal in the present invention. Since such information can be carried out according to the method defined in UPnP DA, the detailed description shall be omitted. Furthermore, attr is an object of DevAttrib class and represents the attributes of a video storing apparatus. FIG. 57 shows an example of the structure of a DevAttrib class according to the fourth embodiment of the present invention. In FIG. 57, remainCap represents the capacity of free space in which multimedia data is stored, replayFavoritGenre represents a genre having the highest use frequency from among the contents reproduced or outputted to a network, such as 0 indicating a movie and 1 indicating a sport. recordFavoritGenre represents a genre having the highest use frequency from among the contents recorded by the user's operation.

The method sendMultimediaData( ) in FIG. 55 (2) specifies an identifier of a channel for transmitting multimedia data to the video storing apparatus 3903 or 3904. When successful, it returns true, and in the case of failure, it returns false.

The method acceptMultimediaRequest( ) in FIG. 55 (3), upon being called, first activates a new process or a new thread and continues to operate on the new process or the new thread. The method accepts a request for transmitting multimedia data from the terminal, and checks whether or not the video storing apparatus 3903 or 104 stores the multimedia data. When the data is stored, it issues a request for transmitting the data from the video storing apparatus to the terminal, the terminal that issues the request is notified of information indicating that the multimedia data is transmitted from the video storing apparatus, and when the data is not stored, it receives the multimedia data from a broadcast station and transmits the data to the terminal. For the normal end, true is returned, and for the abnormal end, false is returned. Note that it is possible to end the operation once a single request is accepted, without continuing to operate. These methods are to be described in details later, since they operate using the API for the data receiving unit 5402, the information communicating unit 5403, the selecting unit 5404, the data output unit 5405, and the right processing unit 5406.

The method collectMultimediaData( ) in FIG. 55 (4) retrieves for multimedia contents provided as the Near VoD service, using the Java library 4505, receives the part of or entire of a TV-program by requesting the service manager 4504 once per TV-program, and transmits the TV-program to the video storing apparatus by calling the method sendMultimediaData( ). When successful, it returns true, and in the case of failure, it returns false.

The method setSelectAlgorithm( ) in FIG. 55 (5) sets an algorithm used when the selecting unit 5404 selects a video storing apparatus to be an algorithm provided by the argument id. When successful, it returns true, and in the case of failure, it returns false. The value of id and each algorithm are defined in advance. The present method is carried out by calling the method setSelectAlgorithm( ) provided by the selecting unit 5404.

The method setStoragePriority( ) in FIG. 55 (6) sets a priority of a video storing apparatus when the selecting unit 5404 selects a video storing apparatus based on the priority, and the priority becomes high in order of the array represented by the argument devices. When successful, it returns true, and in the case of failure, it returns false. The present method is carried out by calling the method setStoragePriority( ) provided by the selecting unit 5404. Note that the present method may be set, using an array of a pair of a video storing apparatus and its priority as an argument.

The method setTerminalPriority( ) in FIG. 55 (7) sets a priority of a terminal when the selecting unit 5404 selects a video storing apparatus based on the priority of the terminal, and the priority becomes high in order of the array represented by the argument devices. When successful, it returns true, and in the case of failure, it returns false. The present method is carried out by calling the method setTerminalPriority( ) provided by the selecting unit 5404. Note that the present method may be set, using an array of a pair of a terminal and a value of its priority as an argument.

The method setCombination( ) in FIG. 55 (8) sets a pair of a video storing apparatus and a terminal when the selecting unit 5404 selects a video storing apparatus based on the priority of the terminal. The pair is set in each array having the same index by providing the argument devices with the video storing apparatus and the argument terms with the terminal. The present method is carried out by calling the setCombination( ) provided by the selecting unit 5404.

The method setSelectedStorageDevice( ) in FIG. 55 (9) sets the video storing apparatus having the index provided by the argument id to be the selected video storing apparatus. Since the present method is carried out by calling the method setSelectedStorageDevice( ) provided by the selecting unit 5404, the details is to be described later.

The method registerhandler( ) in FIG. 55 (10) registers, into the system, a handler which is provided through an argument handler, and returns true when successful and false in the case of a failure. By registering the handler, the Java application can receive a callback from the network library 4505e.

The data receiving unit 5402 controls the TS decoder 4307 and the TS multiplexer 4310 of the broadcast receiving apparatus 3902 through the library 4501 of the OS 4501, configures, as a MPEG2 transport stream, the video, audio, and the section data in which filtering has been performed, and reads the configured MPEG2 transport stream.

The data receiving unit 5402 provides Java APIs to the control unit 5401 and the downloaded Java application. FIG. 58 is a diagram showing an example of Java APIs provided by the data receiving unit 5402. The method openProgram( ) in FIG. 58 (1) returns an object of Input Stream that reads the MPEG2 transport stream configured by the TS multiplexer 510 based on the identifier of the channel specified by the argument. Note that it returns null in the case of failure.

The information communicating unit 5403 controls the network unit 4311 of the broadcast receiving apparatus 3902 through the NET450b4 of the library 4501 of the OS 4501, and receives and transmits a message to and from the specified external device that is connected to the network 3907 and that has been specified.

The information communicating unit 5403 provides Java APIs to the control unit 5401 and the downloaded Java application.

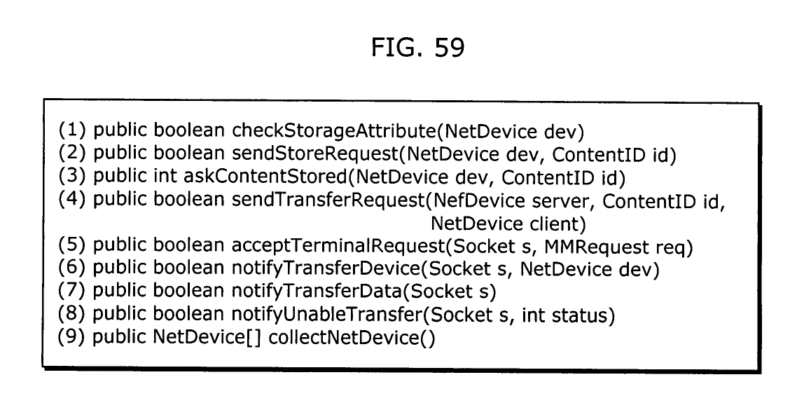

FIG. 59 is a diagram showing an example of the Java APIs provided by the information communicating unit 5403 according to the fourth embodiment of the present invention.

The method checkStorageAttribute( ) in FIG. 59 (1) transmits a request for transmitting the attributes to a video storing apparatus specified by an argument, receives the reply, and sets the attributes as the object of the NetDevice class indicated by the argument dev. When successful, it returns true, and in the case of failure, it returns false.

The method sendStoreRequest( ) in FIG. 59 (2) transmits a request for storing data to the video storing apparatus specified by the argument dev, and receives the reply. When successful, it returns true, and in the case of communication failure or rejection of the request, it returns false. The argument id is an identifier of the multimedia data issued by the control unit 5401, and is transmitted to a video storing apparatus with the transmission request.

The method askContentStored( ) in FIG. 59 (3) transmits an inquiry about whether or not the video storing apparatus specified by the argument dev stores the multimedia data specified by the argument id, and receives the reply. When receiving a reply indicating that the data is stored, it returns true, and when receiving a reply indicating that the data is not stored or in the case of communication failure, it returns false.

The method sendTransferRequest( ) in FIG. 59 (4) transmits, to the video storing apparatus specified by the argument server, a request for transmitting the multimedia data specified by the argument id to the terminal specified by the argument client, and receives the reply. When receiving OK, it returns true, and when receiving NG or in the case of communication failure, it returns false.

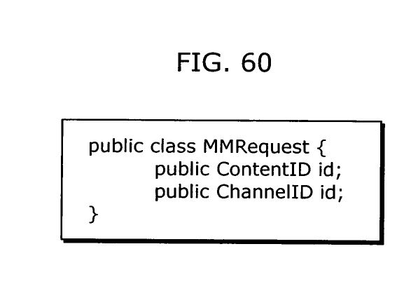

The method acceptTerminalRequest( ) in FIG. 59 (5) receives a request from the terminal connected using the Socket object specified by the argument s, and stores the identifier of the multimedia data of which the terminal requests the transmission to the argument req. When successful, it returns true, and in the case of failure, it returns false. FIG. 60 is a structure diagram of an MMRequest class according to the fourth embodiment of the present invention.

The method notifyTransferDevice( ) in FIG. 59 (6) notifies the terminal connected using the Socket object specified by the argument s of information indicating that the multimedia data is to be transmitted from the video storing apparatus specified by the argument dev, through the Socket object specified by the argument s. When successful, it returns true, and in the case of failure, it returns false.

The method notifyTransferData( ) in FIG. 59 (7) notifies, through the Socket object specified by the argument s, the terminal connected using the Socket object of information indicating that the multimedia data is to be transmitted from the video storing apparatus specified by the argument dev. When successful, it returns true, and in the case of failure, it returns false.

The method notifyUnableTransfer( ) in FIG. 59 (8) notifies the terminal connected using the Socket object specified by the argument s of information indicating that the requested multimedia data can not be transmitted due to a reason represented by the argument status, through the Socket object.

The method collectNetDevice( ) in FIG. 59 (9) collects information on external devices connected to the network 3907, and returns, as such information, the array of the NetDevice objects. Since this processing can be carried out according to the method defined in UPnP DA, the detailed description shall be omitted.

The selecting unit 5404 selects one of the video storing apparatuses connected to the network 3907, based on such as the attributes of the video storing apparatuses and the attributes of the multimedia data, in accordance with the set algorithm.

The selecting unit 5404 provides Java APIs to the control unit 5401 and the downloaded Java application.

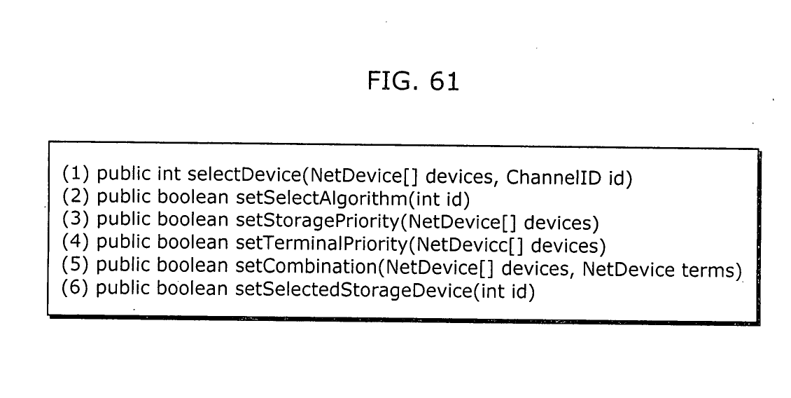

FIG. 61 is a diagram showing an example of Java APIs provided by the control unit 5404 according to the fourth embodiment of the present invention.

The method selectDevice( ) in FIG. 61 (1) selects one video storing apparatus, based on the attributes of the video storing apparatuses stored in the argument devices and the attributes of the multimedia data that can be obtained by referring the identifier of the channel indicated by the argument id and the TV-program information stored in the second memory 4303 shown in FIG. 47, from among the video storing apparatuses indicated by the argument devices, in accordance with the algorithm set in a method setAlgorithm( ) to be described later. When successful, it returns the selected video storing apparatus with its index in the array devices, and in the case of failure, it returns a negative value. The algorithms to be selected includes an algorithm for: selecting a video storing apparatus having a large space; selecting a video storing apparatus by allocating video storing apparatuses for each genre of multimedia data; selecting a video storing apparatus having a high frequency with which multimedia data categorized as the same genre as that of the multimedia data is recoded by the user's operation; selecting a video storing apparatus according to a priority of the video storing apparatus which is set by the method setStoragePriority( ) to be described later; selecting a terminal based on the priority of the terminal set by the method setTerminalPriority( ) to be described later, from the combinations of the terminals and video storing apparatuses set by the method setCombination( ) to be described later, and selecting the video storing apparatus combined with the selected terminal; or selecting the video storing apparatus specified by the method setSelectedStorageDevice( ) to be described later by informing, when there are plural video storing apparatuses, the Java application program with a callback function, providing the list to the user, and accepting inputs from the user.

The method setSelectAlgorithm( ) in FIG. 61 (2) sets an algorithm provided when the selecting unit 5404 selects a video storing apparatus to be an algorithm provided by the argument id. When successful, it returns true, and in the case of failure, it returns false. The value of id and each algorithm are defined in advance.

The method setStoragePriority( ) in FIG. 61 (3) sets a priority of a video storing apparatus when the selecting unit 5404 selects a video storing apparatus based on the priority, and the priority becomes high in order of the array represented by the argument devices. When successful, it returns true, and in the case of failure, it returns false. Note that the present method may be set, using an array of a pair of a video storing apparatus and its priority as an argument.

The method setTerminalPriority( ) in FIG. 61 (4) sets a priority of a terminal when the selecting unit 5404 selects a video storing apparatus based on the priority of the terminal, and the priority becomes high in order of the array represented by the argument devices. When successful, it returns true, and in the case of failure, it returns false. Note that the present method may be set, using an array of a pair of a terminal and a value of its priority as an argument.

The method setCombination( ) in FIG. 61 (5) sets a pair of a video storing apparatus and a terminal when the selecting unit 5404 selects a video storing apparatus based on the priority of the terminal. The pair is set in each array having the same index by providing the argument device with the video storing apparatus and the argument terms with the terminal.

The method setSelectedStorageDevice( ) in FIG. 61 (6) sets the video storing apparatus having the index provided by the argument id to be the selected video storing apparatus. The present method notifies the Java application program with the callback function, and is called by the Java application program that accepts the input of the user, when the method selectDevice( )selects a video storing apparatus by the input of the user, using the set algorithm. The callback function is represented by, for example, Handler.notify(NetDevices[ ]devices,Objectobj), assuming that the handler object of the Java application is Handler. With this, the Java application program provides the user with the list of the video storing apparatuses given by the arguments, and accepts the input of the user. Since the index of the array devices is obtained from the accepted input, and the instances of the control unit 5401 or the selecting unit 5404 is given using the argument obj, the method setSelectedStorageDevice( ) is called and set. The aforementioned handler object Handler is registered by the method registerHandler( ) provided by the control unit 5401. Note that the selecting unit 5404 may have the same registerhandler( ) method and expose it to the Java application program.

The data output unit 5405 controls the network unit 4311 of the broadcast receiving apparatus 3902 through the NET4501b4 of the library 4501 of the OS 4501, and transmits the multimedia data received by the data receiving unit 5402, to an external device that is connected to the network 3907 and that has been specified.

The data output unit 5405 provides Java APIs to the control unit 5401 and the downloaded Java application.

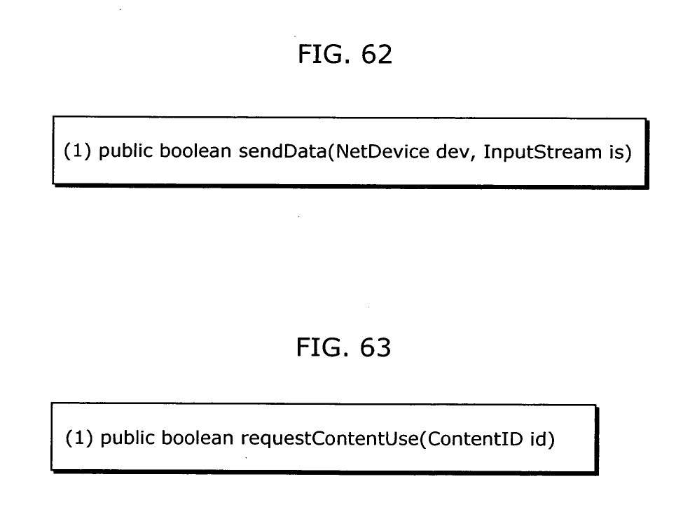

FIG. 62 is a diagram showing an example of Java APIs provided by the data output unit 5405 according to the fourth embodiment of the present invention.

The method sendData( ) in FIG. 62 (1) transmits, to the device which id specified by the argument dev and connected to the network 3907, the data read from the Input Stream object specified by the argument is, until EOF is read from the argument is. When successful, it returns true, and in the case of failure, it returns false.

The right processing unit 5406 requests the service manager 4504 to perform right processing following the use of multimedia data including billing.

The right processing unit 5406 provides Java APIs to the control unit 5401 and the downloaded Java application.

FIG. 63 shows an example of Java APIs provided by the right processing unit 5406 according to the fourth embodiment of the present invention.

The method requestContentUse( ) in FIG. 63 (1) requests the service manager 4504 to perform right processing on the content specified by the argument id, and when the use of the content is permitted, it returns true, and if not or in the case of the processing failure, it returns false.

The processing of the method sendMultimediaData( ) and the method acceptMultimediaRequest( ) provided by the control unit 5401 is to be described hereinafter.

First, the processing of the method sendMultimediaData( ) shall be described. Upon calling the sendMultimediaData( ), first, the method collectNetDevice( ) provided by the control unit 5401 searches for the video storing apparatus connected to the network 3907. Next, the method checkStorageAttribute( ) provided by the information communicating unit 5403 is called for each video storing apparatus so that the attributes of each video storing apparatus are checked. Next, the method selectDevice( ) provided by the selecting unit 5404 is called, so that a video storing apparatus is selected. Furthermore, an identifier that identifies this multimedia data is issued. By calling, for the selected video storing apparatus, the method sendStoreRequest( ) provided by the information communicating unit 5403, a storage request is transmitted together with the identifier of multimedia data and TV-program information of the multimedia data. Next, calling the method openProgram( ) provided by the data receiving unit 5402, an Input Stream object is obtained that reads the multimedia data. Furthermore, calling the method sendData( ) provided by the data output unit 5405, the received multimedia data is transmitted to the selected video storing apparatus. When the processing is successful, the identifier of the issued multimedia data is stored in the second memory 4303, together with the attributes of the multimedia data.

Note that after executing the collectNetDevice( ), these information may be stored in the second memory 4303, and the information stored in the second memory 503 may be read after that.

Next, the processing of the method acceptMultimediaRequest( ) shall be described. The method acceptMultimediaRequest( ), upon being called, generates another new process or a new thread and operates on the process or the new thread. First, it creates a Socket object that accepts a connection from a terminal, and waits for a connection request. Upon receiving the connection request from the terminal, the method acceptTerminalRequest( ) provided by the information communicating unit 5403 is called, and a request is received from the terminal. Next, the identifier of the requested multimedia data is identified based on the request from the terminal, or based on the identifier of the channel received from the terminal and information stored in the second memory 4303. Next, the video storing apparatus connected to the network is searched by calling the method collectNetDevice( ) provided by the control unit 5401, or based on the information stored in the second memory 4303. Then, calling the method askContentStored( ) provided by the information communicating unit 5403 for each video storing apparatus, whether or not the video storing apparatus stores the multimedia data is inquired. When there is a video storing apparatus that stores the data, calling the method sendTransferRequest( ) provided by the information communicating unit 5403, a request for transmitting, to the requested terminal, the multimedia data is issued to the video storing apparatus. Note that the requested terminal is identified based on the Socket object through which the method communicates with the terminal, and a result of the method collectNetDevice( ) provided by the control unit 5401 or information stored in the second memory 4303. Note that right processing is performed by calling the method requestContentUse( ) provided by the right processing unit 5406 as necessary. Next, the requested terminal is notified of the video storing apparatus that stores the data by calling the method notifyTransferDevice( ) provided by the information communicating unit 5403. Furthermore, when a video storing apparatus that stores the multimedia data is not found, a reception of a TV-program is requested by passing the identifier of the channel to the request transmitting unit 4504. Next, as in the aforementioned method sendMultimediaData( ), the InputStream is generated that reads the multimedia data to be received, by calling the method openprogram( ) provided by the data receiving unit 5402. When the method openProgram( ) returns null, the method notifyUnableTransfer( ) provided by the information communicating unit 5403 is called so as to notify that the data transmission to the terminal is not possible, and the system returns to a request waiting state. When the method openProgram( ) returns the instance of the InputStream object, the terminal is notified of information that the multimedia data is to be transmitted from the broadcast receiving apparatus 3902 by calling the method notifyTransferDevice( ) provided by the information communicating unit 5403. Next, by calling the method sendData( ) provided by the data output unit 5405, the multimedia data is transmitted to the terminal. When the data transmission ends, the system returns to a connection request waiting state. Note that upon accepting the connection request, further, the system may generate another new thread or new process, operate on the new thread or the new process for the following processing, and the original thread or the process may return to a connection request waiting state. In this case, the processing on the thread or process ends without returning to the connection request waiting state.

With the aforementioned structure, the Java application program can receive multimedia data of a TV-program provided from a Near VoD service prior to the use, and store the multimedia data in the video storing apparatus. Note that the storage may be carried out at predetermined intervals, and at a date and time set by the user. Furthermore, the storage may be carried out at predetermined intervals set by the user. Furthermore, the storage may be carried out by the user's operation. Furthermore, the storage may be carried out according to an instruction from a broadcast station.

Next, the configuration of the video storing apparatuses 3903 and 3904 is to be described.

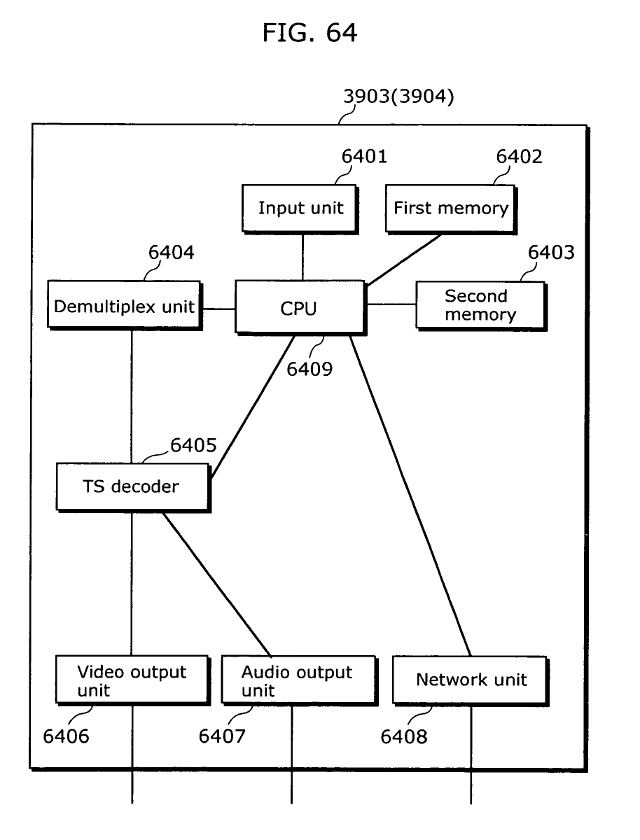

FIG. 64 is a block diagram showing an example of the configuration of the video storing apparatuses 3903 and 3904 according to the fourth embodiment of the present invention. The video storing apparatuses 3903 and 3904 in the diagram includes an input unit 6401, a first memory 6402, a second memory 6403, a demultiplex unit 6404, a TS decoder 6405, a video output unit 6406, an audio output unit 6407, a network unit 6408, and a CPU 6409. Note that the video storing apparatuses 3903 and 3904 of the fourth embodiment not only store multimedia data but also reproduce the multimedia data received from the broadcast receiving apparatus 3902 and the stored multimedia data, by the operation of the user.

The input unit 6401, the first memory 6402, and the second memory 6403 are the same as the input unit 4301, the first memory 4302, and the second memory 4303 of the broadcast receiving apparatus 3902 in the fourth embodiment. Note that the video storing apparatuses 3903 and 3904 store multimedia data in the second memory 6403. Furthermore, the video storing apparatuses 3903 and 3904 stores not only multimedia data but also TV-program information, at the same time, obtained from an EPG, such as the identifier, a title, a date and time to be broadcasted, and a broadcast channel of the multimedia data, as metadata.

The demultiplex unit 6404 receives an MPEG transport stream from the CPU 6409, extracts information specified by the CPU 6409, and passes the extracted information to the CPU 6409. In addition, the demultiplex unit 6404 passes the MPEG transport stream to the TS decoder 6405 as it is.

The TS decoder 6405 receives identifiers of audio data and video data from the CPU 6409. In addition, the TS decoder 6405 extracts data corresponding to the received identifiers of audio data and video data, from the stream received from the demultiplex unit 6404. The TS decoder 6405 passes the extracted video data to the video output unit 6406, and the extracted audio data to the audio output unit 6407.

The video output unit 6406 and the audio output unit 6407 are the same as the video output unit 4308 and the audio output unit 4309 of the broadcast receiving apparatus 3902 in the aforementioned embodiments.

The network unit 6408, which includes a network interface, converts the data received from the CPU 6409 into a signal that is in accordance with the physical media of the network to which the network interface is connected, and outputs this signal. Furthermore, the network unit 6408 receives a signal from the network interface, converts the signal into a packet defined by the IP network, and passes the packet to the CPU 6409.

The CPU 6409 controls the demultiplex, unit 6404, the TS decoder 6405, and the network unit 6408 by executing a program stored in the second memory 6403.

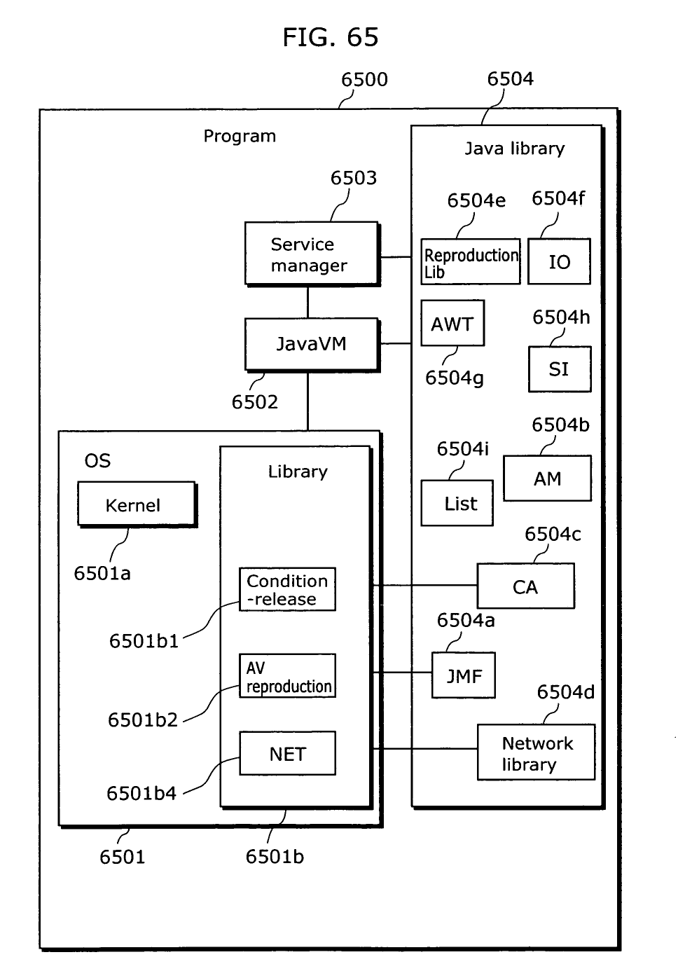

FIG. 65 is a structure diagram of a program to be held and executed by the video storing apparatuses 3903 and 3904 according to the fourth embodiment of the present invention. The diagram shows an example of a structure of the program stored in the second memory 6403 and executed by the CPU 6409.

The program 6500 is made up of plural subprograms, and specifically includes an OS 6501, a Java VM 6502, a service manager 6503, and a Java library 6504.

The OS 6501 is a subprogram activated on the CPU 6409 when power to the video storing apparatuses 3903 and 3904 are turned on. OS is the acronym of operating system, an example of which is Linux and the like. The OS 6501 is a generic name for publicly known technology made up of a kernel 6501a for executing a subprogram concurrently with another subprogram and of a library 6501b, and thus, the detailed description is omitted. In the present embodiment, the kernel 6501a of the OS 6501 executes the Java VM 6503 as subprograms. Furthermore, the library 6501b provides these subprograms with plural functions required for controlling the constituent elements held by the video storing apparatuses 3903 and 3904.

In the present embodiment, the library 6501b includes a condition-release 6501b1, AV reproduction 6501b2, and NET 6501b3, as an example of functions.

The condition-release 6501b1 receives information from other subprograms or a CA 6504c of the Java library 6504, and permits the reproduction of the multimedia data received from the network and the multimedia data stored in the second memory 2703 by decrypting the encrypted data received from the network, and validating the AV reproduction 6501b2.

The AV reproduction 6501b2 receives an audio packet ID and a video packet ID from the other subprograms or a JMF 6504a of the Java library 6504. It then provides the received audio packet ID and video packet ID to the TS decoder 6405. As a result, the TS decoder 6405 performs filtering based on the provided packet IDs, and implements the reproduction of audio/video.

The NET 6501b4 creates packets of a protocol lower than the application layer defined by the IP network, for the data received from the other subprograms or a network library 6504d of the Java library 6504. A protocol lower than the application layer refers to, for example, a TCP packet, a UDP packet, an IP packet, and so on. By passing this to the network unit 6408, messages and data are transmitted to other devices via the network 3907. Furthermore, when a message is received from other devices via the network 3907, the NET 6501b4 converts the message to an application layer protocol packet and passes this to the other subprograms and the network library 6504d of the Java library 6504. An application layer protocol refers to, for example, HTTP, RTP, and so on.

The Java VM 6502 is the same as the Java VM 4503 of the broadcast receiving apparatus 3902 of the aforementioned embodiments.

The service manager 6503 is the same as the service manager 4604 of the broadcast receiving apparatus 3902 of the aforementioned embodiment except for the following different points. The service manager 4604 receives a channel identifier from the reproduction unit 4602b; passes the identifier to the Tuner 4605c and causes the Tuner 4605c to perform tuning; performs descrambling by requesting the CA 4605d, and requests the reproduction of video and audio by providing the channel identifier to the JMF 4605a. Whereas, the service manager 6503 receives the content identifier from a List 6504i inside the Java library 6504; passes the content identifier to the IO 6504f inside the Java library 6504 and reads the stream stored in the second memory 6403 or passes the content identifier as well as information on the apparatus storing such content identifier, to the network library 6504d and receives a stream from the apparatus; then requests for the reproduction of video and audio by providing the content identifier to the JMF 6504a inside the Java library 6504. The List 6504i shall be described later.

Furthermore, the service manager 6503 receives multimedia data from the broadcast receiving apparatus 3902 and stores the multimedia data in the second memory 6403 by requesting the network library 6504d inside the Java library 6504 to wait for a storage request from the broadcast receiving apparatus 3902 and to receive and store data.

Furthermore, the service manager 6503 transmits, to the terminal, the multimedia data stored in the second memory 6403, by requesting the network library 6504d inside the Java library 6504 to transmit multimedia data from the broadcast receiving apparatus 3902, accept the data transmission request from the terminal 3905 or 3906, and transmit data corresponding to the request.

The Java library 6504 is a collection of plural Java libraries stored in the second memory 6403. In the present embodiment, the Java library 6504 includes the JMF 6504a, the AM 6504b, the CA 6504c, the network library 6504d, a reproduction Lib 6504e, the List 6504i, and the like.

The JMF 6504a, the AM 6504b, the reproduction Lib 6504e, the IO 6504f, AWT 6504g, and an SI 6504h are the same as the JMF 4505a, the AM 4505b, the reproduction Lib 4505f, the IO 4505g, AWT 4505h, and the SI 4505i inside the Java library 4505 of the broadcast receiving apparatus 3902 of the aforementioned embodiments.

The CA 6504c manages right processing of the multimedia data, such as copy control and billing of the multimedia data transmitted through the network 3907 and the multimedia data stored in the second memory 2703. Copy control is to rewrite data as necessary with reference to copy control information included in the section information of the transmitted transport stream. Furthermore, billing and the like is performed by communicating with the broadcast receiving apparatus 3902 through the network library 6504d.

The List 6504i displays a list of multimedia contents stored in the EPG and the second memory 6403 of the broadcast receiving apparatus 3902, and a list of multimedia contents stored in the video storing apparatus connected to the network 3907, selects one of the multimedia contents from the list, by the user's operation accepted by the input unit 6401, and requests the service manager 6503 to reproduce the selected content. When the content is stored in the broadcast receiving apparatus 3902 or an other video storing apparatus connected to the network 3907, the information of the device is also passed to the service manager 6503. The list of the contents stored in the second memory 6403 can be obtained by reading information though the IO 6504f. Furthermore, the list of the contents stored in the EPG of the broadcast receiving apparatus 3902 and the other video storing apparatus connected to the network 3907 can be obtained though the network library 6504d. Since these information can be implemented according to the method defined in UPnP AV, the detailed description shall be omitted.

The network library 6504d communicates with the broadcast receiving apparatus 3902, other video receiving apparatuses, and the terminals 3905 and 3906 which are connected to the network 3907, through the NET 6501b4 of the Library 6501b. Furthermore, between the network library 6504d and the broadcast receiving apparatus 3902, following communication is performed for: transmitting the attributes of the video storing apparatus; receiving a request for storing multimedia data and the multimedia data; receiving an inquiry about whether or not the multimedia data is stored and transmitting the reply; accepting the request for transmitting the stored multimedia data; and performing right processing following the use of the multimedia data. Furthermore, among the network library 6504d, the terminals 3905 and 3906, and the other broadcast receiving apparatuses, following processing is performed: transmitting and receiving a list of multimedia data; transmitting multimedia data; and receiving multimedia data.

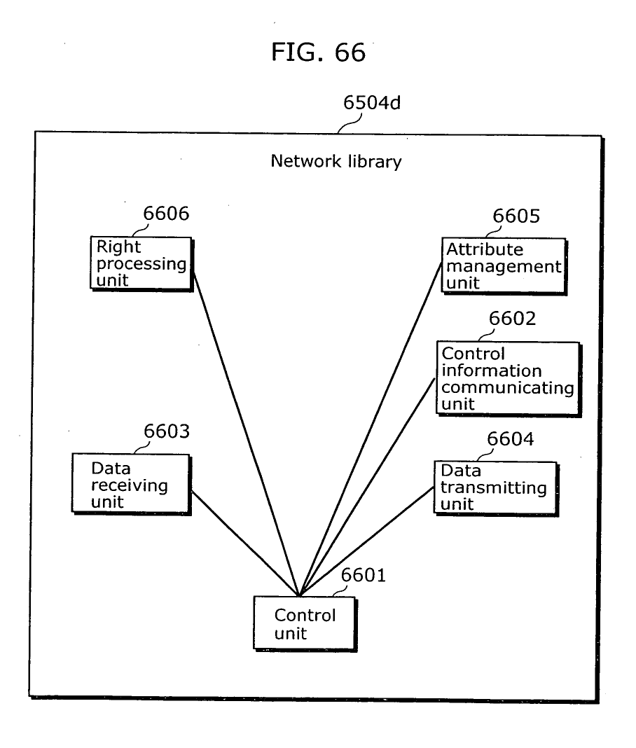

FIG. 66 is a block diagram showing an example of an internal configuration of the network library 6504d according to the fourth embodiment of the present invention. The network library 6504d includes a control unit 6601, a control information communicating unit 6602, a data receiving unit 6603, a data transmitting unit 6604, an attribute management unit 6605, and a right processing unit 6606. Note that the network library 6504d may include other functions relating to the IP network.

The control unit 6601 provides, to a downloaded Java application, the functions which the network library 6504d implements. In other words, the Java application can execute a network functions by calling the Java APIs provided by the control unit 6601. When the Java API is invoked, the control unit 6601 performs processes using the control information communicating unit 6602, the data receiving unit 6603, the data transmitting unit 6604, the attribute management unit 6605, the right processing unit 6606, and the rest of the Java library 6504 and the library 6501b of the OS 6501, as necessary.

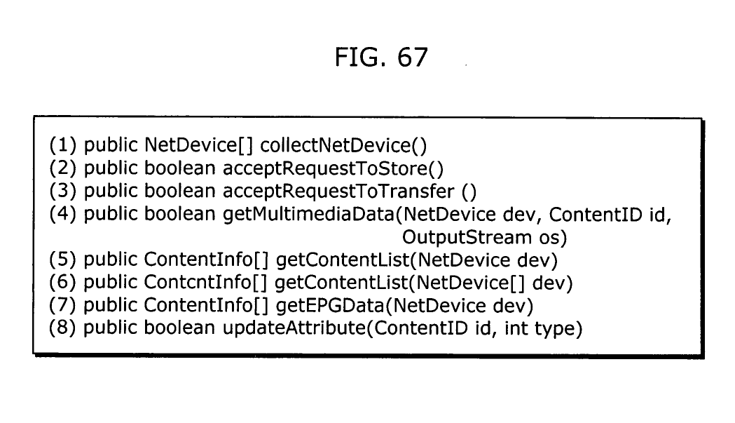

FIG. 67 shows an example of Java APIs provided by the control unit 6601 included in the internal configuration of the network library 6504d according to the fourth embodiment of the present invention.

The method collectNetDevice( ) in FIG. 67 (1) collects information on an external device connected to the network 3907, returns, as such information, the array of NetDevice objects, and in the case of failure, it returns null. This method is performed using the method collectNetDevice( ) of the control information communicating unit 6602 to be described later.

The method acceptRequestToStore( ) in FIG. 67 (2), upon being called, first activates a new process or a new thread and continues to operate on the new process or the new thread. The method accepts, from the broadcast receiving apparatus 3902, a request for transmitting the attributes; accepting a request for storing multimedia data; receives the multimedia data; and stores the multimedia data in the second memory 6403. For the normal end, true is returned, and for the abnormal end, false is returned.

Note that it is possible to end the operation once a single request is accepted, without continuing to operate. Note that the Java application may pass a device connected to the network 3907 with the argument, and receives and stores the data from the device by communicating with that device. Details of this process shall be described later.

The method acceptRequestToTransfer( ) in FIG. 67 (3), upon being called, first activates a new process or a new thread and continues to operate on the new process or the new thread. The method returns a reply when accepting an inquiry about whether or not particular multimedia data from the broadcast receiving apparatus 3902 is stored, and transmits the multimedia data to a particular terminal when accepting a request for transmitting, to the terminal, the particular multimedia data from the broadcast receiving apparatus 3902. Furthermore, the method accepts a request for transmitting multimedia data from an external device, such as the terminals 3905 and 3906, and transmits the multimedia data. For the normal end, true is returned, and for the abnormal end, false is returned. Note that it is possible to end the operation once a single request is accepted, without continuing to operate. Details of this process shall be described later.

The method getMultimediaData( ) in FIG. 67 (4) accepts a device connected to the network 3907, an identifier of a content, and an output stream from the Java application or other sub-program, receives the multimedia data identified by the identifier from the device, and writes the data in the output stream. For the normal end, true is returned, and for the abnormal end, false is returned. With this method, the Java application program can receive the multimedia data held by the other device connected to the network 3907, and reproduce the data. Details of this process shall be described later.

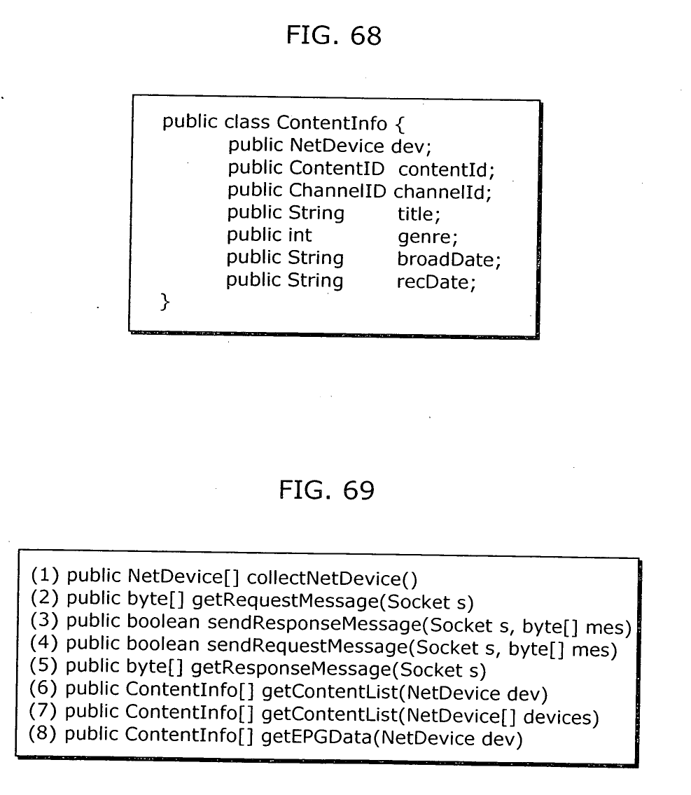

The method getContentList( ) in FIG. 67 (5) and (6) receives, from the Java application program or other sub-program, a video storing apparatus connected to the network 3907, obtains a list of the contents stored by the video storing apparatus, and returns the array of the ContentInfo objects. When successful, it returns this array, and in the case of failure, it returns null. In this method, there are cases where a NetDevice object is given as an argument, and cases where the array of the NetDevice objects is given. FIG. 68 is a diagram showing the structure of a ContentInfo class used for the network library 6504d according to the fourth embodiment of the present invention. In FIG. 68, dev represents the video storing apparatus, contentId represents an identifier of the content, channelId represents an identifier of a channel of which the content has been broadcasted, title represents a title of the content, genre represents a genre of the content, broadDate represents a date and time when the content has been broadcasted, recDate represents a date and time when the content has been recorded. This processing is performed by calling the method getContentList( ) provided by the control information communicating unit 6602 to be described later.

The method getEPGData( ) in FIG. 67 (7) obtains EPG information from a specified device, and returns the array of the ContentInfo object. When the method fails in detecting that the device specified by the argument dev is the broadcast receiving apparatus 3902, it returns null. This processing is performed by calling the method getEPGData( ) provided by the control information communicating unit 6602 to be described later.

The method updateAttribute( ) in FIG. 67 (8) updates attribute information as the processing specified by the argument type is performed to the content specified by the argument id. When successful, it returns true, and in the case of failure, it returns false. The method is performed by calling the method updateAttribute( ) provided by the attribute management unit 6605 to be described later.

The control information communicating unit 6602 controls the network unit 6408 through the NET 6501b4 of the library 6501b of the OS 6501, and receives and transmits a message to and from an external device that is connected to the network 3907 and that has been specified.

The control information communicating unit 6602 provides Java APIs to the control unit 6401 and the downloaded Java application program.

FIG. 69 shows an example of Java APIs provided by the control information communicating unit 6602 included in the internal configuration of the network library 6504d according to the fourth embodiment of the present invention.

The method collectNetDevice( ) in FIG. 69 (1) is the same as the collectNetDevice( ) provided by the information communicating unit 5403 of the network library 4505e in the broadcast receiving apparatus 102 according to the aforementioned present embodiment.

The method getRequestMessage( ) in FIG. 69 (2) receives a message through the socket given by the argument s, and returns a byte sequence of the received data. When successful, it returns the byte sequence, and it returns null in the case of failure. The present method is used when receiving a request from an external device.

The method sendResponseMessage( ) in FIG. 69 (3) transmits a message given by the argument mes through the socket given by the argument s. When successful, it returns true, and it returns false in the case of failure. The present method is used when transmitting a reply in response to a request from an external device.

The method sendRequestMessage( ) in FIG. 69 (4) transmits the message given by the argument mes through the socket given by the argument s. When successful, it returns true, and it returns false in the case of failure. The present method is used when transmitting a request to an external device.

The method getResponseMessage( ) in FIG. 69 (5) receives a message through the socket given by the argument s, and returns a byte sequence of the received data. When successful, it returns the byte sequence, and it returns null in the case of failure. The present method is used when receiving a reply in response to a request transmitted to an external device, from the external device.

The method getContentList( ) in FIG. 69 (6) and (7) obtains a list of the contents stored by the video storing apparatus given by the argument dev or plural video storing apparatuses given by the argument devices, and returns the array of the ContentInfo objects. When successful, it returns this array, and in the case of failure, it returns null. Since the list of the contents stored by each of the video storing apparatuses is obtained according to a method defined in UPnP AV, the detailed description shall be omitted.

The method getEPGData( ) in FIG. 69 (8) obtains EPG information from a broadcast receiving apparatus given by the argument dev, and returns the array of the ContentInfo objects. When successful, it returns this array, and in the case of failure, it returns null. Since the EPG information is obtained according to a method defined in UPnP AV, the detailed description shall be omitted.

The data receiving unit 6603 controls the network unit 6408 through the NET 6501b4 of the library 6501b of the OS 6501, and receives, via the network 3907, multimedia data from a broadcast receiving apparatus or a video storing apparatus which is connected to the network 3907.

The data receiving unit 6603 provides Java APIs to the control unit 6601 and the downloaded Java application program.

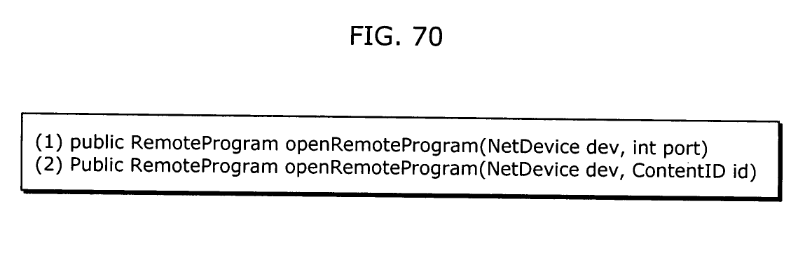

FIG. 70 shows an example of Java APIs provided by the data receiving unit 6603 included in the internal configuration of the network library 6504d according to the fourth embodiment of the present invention.

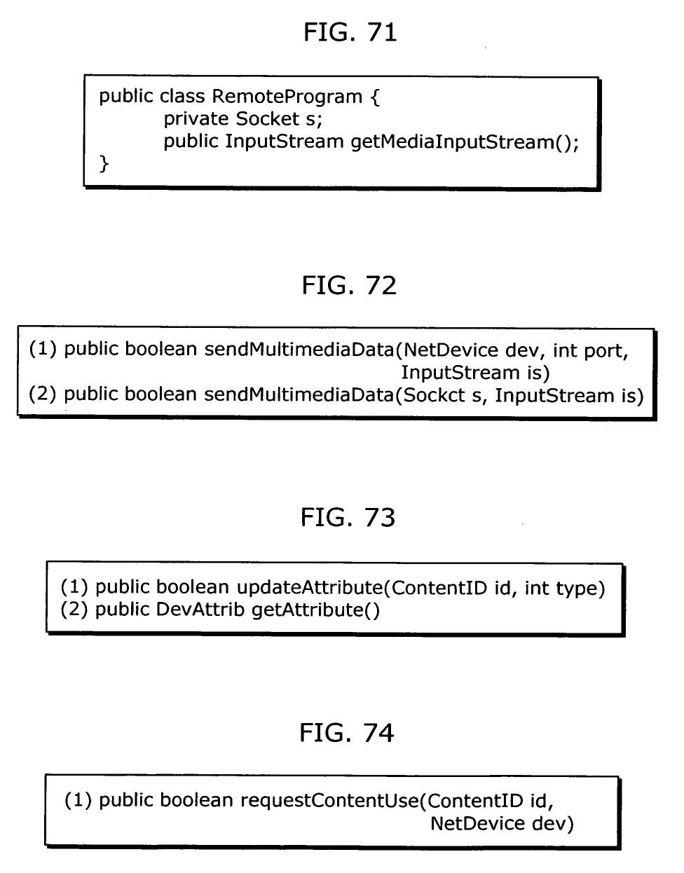

The method openRemoteProgram in FIG. 70 (1) establishes a communication path through which the multimedia data can be received from a port specified by the argument port for a device given by the argument dev, and returns the RemoteProgram object. When successful, it returns the object, and in the case of failure, it returns null. FIG. 71 shows an example of the structure of a RemoteProgram class according to the fourth embodiment of the present invention. In FIG. 71, s represents a socket to be used for the communication. The method getMediaInputStream( ) returns the InputStream object that reads the multimedia data.

The method openRemoteProgram in FIG. 70 (2) establishes a communication path through which the multimedia data stored by a device given by the argument dev and that has an identifier given by the argument id can be received, and returns the RemoteProgram object. When successful, it returns the object, and in the case of failure, it returns null. The present method first generates the Socket object for the communication with the specified device, and connects to the device. Then, it creates a transmission request message including the given identifier, and transmits the message to the device by calling the method sendRequestMessage( ) provided by the control information communicating unit 6602. Then, it receives the reply message by calling the getResponseMessage( ) provided by the control information communicating unit 6602. When the reply message is OK, the method analyzes the message. Furthermore, when a particular port number is specified, it creates a new Socket object, creates the RemoteProgram object with specifying the new Socket object, and returns the created RemoteProgram object. When a particular port is not specified, it creates the RemoteProgram object with specifying the Socket object used for the communication, and returns the created RemoteProgram object. When the reply message is NG, it returns null.

The data transmitting unit 6604 controls the network unit 6408 through the NET 6501b4 of the library 6501b of the OS 6501, and outputs the specified multimedia data to an external device that is connected to the network 3907 and that has been specified.

The data transmitting unit 6604 provides Java APIs to the control unit 6601 and the downloaded Java application program.

FIG. 72 shows an example of Java APIs provided by the data transmitting unit 6604 included in the internal configuration of the network library 6504d according to the fourth embodiment of the present invention. The method sendMultimediaData( ) in FIG. 72 (1) sends data to a port given by the argument port for the device specified by the argument dev, and method sendMultimediaData( ) in FIG. 72 (2) transmits the read data through the Socket object specified by the argument s while reading the data from the InputStream object given by the argument is until the data reaches the EOF. When successful, it returns true, and in the case of failure, it returns false.

The attribute management unit 6605 manages attributes of a video storing apparatus. The attributes of the video storing apparatus are stored in the second memory 6403, and the attribute management unit 6605 reads and writes the attributes using the IO 6404f within the Java library 6504.

The attribute management unit 6605 provides Java APIs to the control unit 6601 and the downloaded Java application program.

FIG. 73 shows an example of Java APIs provided by the attribute management unit 6605 included in the internal configuration of the network library 6504d according to the fourth embodiment of the present invention.

The method updateAttribute( ) in FIG. 73 (1) updates attribute information as the processing specified by the argument type is performed to the content specified by the argument id. When successful, it returns true, and in the case of failure, it returns false. When a value of type is 0, it represents storage, and when the value is 1, it represents reproduction or transmission to a network. The present method reads, from the second memory 6403, information of a content stored with attribute information, and updates the attribute information by checking a genre of the content and a free space of an area for multimedia data in the second memory 6403. Then, it writes the updated attribute information in the second memory 6403.

The method getAttribute( ) in FIG. 73 (2) reads the attribute information from the second memory 6403, stores the necessary data in the DevAttrib object, and returns the DevAttrib object. In the case of failure, it returns null.

The right processing unit 6606 performs right processing on the broadcast receiving apparatus 3902, regarding the use of a content having an identifier given by the argument id.

The right processing unit 6606 provides Java APIs to the control unit 6601 and the downloaded Java application program.

FIG. 74 shows an example of Java APIs provided by the right processing unit 6606 included in the internal configuration of the network library 6504d according to the fourth embodiment of the present invention.

The method requestContentUse( ) in FIG. 74 (1) requests the device given by the argument dev to permit the use of the content specified by the argument id, and when the use of the content is permitted, it returns true, and if not or in the case of the processing failure, it returns false, respectively. Then, it creates a request message, and transmits the message by calling the method sendRequestMessage( ) provided by the control information communicating unit 6602. Furthermore, it receives a reply message by calling the getResponseMessage( ) provided by the control information communicating unit 6602. When the reply message indicates OK, it returns true, and when the message indicates NG, it returns false.

The method acceptRequestToStore( ), the method acceptRequestToTransfer( ), and the method getMultimediaData( ) which are provided by the control unit 6601 are to be described hereinafter.

The method acceptRequestToStore( ), upon being called, generates another new process or new thread and operates on the new process or the new thread. First, it generates a Socket object through which a connection from the broadcast receiving apparatus 3902 can be accepted, and waits for a connection request. When receiving a connection request from the broadcast receiving apparatus 3902, the method receives a request message by calling the method getRequestMessage( ) provided by the control information communicating unit 6602. When the received request message is an inquiry of attributes, the system reads attribute information by calling the method getAttribute( ) provided by the attribute management unit 6605, returns the attribute information by calling the method sendResponseMessage( ) provided by the control information communicating unit 6602, and returns to a connection request waiting state. When the received request message is a request for storing multimedia data, first, an identifier of the multimedia data and TV-program information are retrieved from the request message. Next, by calling the method openRemoteProgram( ) provided by the data receiving unit 6603, an Input Stream to be used for receiving data is created. Next, multimedia data is stored by writing the identifier, the TV-program information, and the multimedia data received from the InputStream, in the second memory 6403 through the IO 6504f of the Java library 6504. Furthermore, the attribute information is updated by calling the method updateAttribute( ) provided by the attribute management unit 6605. When the processing ends, the system returns to a connection request waiting state. Note that upon accepting the connection request, further, the system may generate another new thread or new process, operate on the new thread or the new process for the following processing, and the original thread or the process may return to a connection request waiting state. In this case, the processing on the new thread or the new process ends without returning to the connection request waiting state. The method acceptRequestToStore( ) may use the NetDevice object as an argument, and this argument may specify the broadcast receiving apparatus 3902. In this case, in addition to the aforementioned processing, when a device connected to the Socket object to be waited for is not the device given by the argument, the connection request is not accepted.

The method acceptRequestToStore( ), upon being called, generates another new process or new thread and operates on the new process or the new thread. First, it creates the Socket object that accepts a connection from a device connected to the network 3907, and waits for a connection request. When receiving a connection request, the method receives a request message by calling the method getRequestMessage( ) provided by the control information communicating unit 6602. When the received message is an inquiry from the broadcast receiving apparatus 3902 about whether or not particular multimedia data is stored, the identifier of the multimedia data is retrieved from the request message. Next, a list of stored contents are read through the IO 6504f inside the Java library 6504, and whether or not the multimedia data is stored is judged by checking the list with the retrieved identifier. Then, it returns a judgment result by calling the getResponseMessage( ) provided by the control information communicating unit 6602, and returns to a connection request waiting state. When the received message is a request from the broadcast receiving apparatus 3902 for transmitting particular multimedia data, first, the identifier of the multimedia data to be transmitted and the identifier of the destination are retrieved from the request message. Next, the method obtains the InputStream through which the multimedia data can be read through the IO 6504f. Next, the multimedia data is transmitted to the terminal by calling the method sendMultimediaData( ) provided by the data transmitting unit 6604. When the data transmission ends, the attribute information is updated by calling the updateAttribute( ) provided by the attribute management unit 6605 and returns to a connection request waiting state. When the received request message is a request for transmitting multimedia data from a terminal and the like, first, an identifier of multimedia data to be transmitted is retrieved from the request message. Next, the method obtains the InputStream through which the multimedia data can be read through the IO 6504f. Next, the multimedia data is transmitted to the terminal by calling the method sendMultimediaData( ) provided by the data transmitting unit 6604. When the data transmission ends, the attribute information is updated by calling the updateAttribute( ) provided by the attribute management unit 6605 and returns to a connection request waiting state. Note that upon accepting the connection request, further, the system may generate another new thread or new process, operate on the new thread or the new process for the following processing, and the original thread or the process may return to a connection request waiting state. In this case, the processing on the thread or process ends without returning to the connection request waiting state.

The method getMultimediaData( ), upon being called, generates the Socket object through which the method connects to a device given by the argument dev, and connects to the device. Next, it creates a transmission request message of the multimedia data specified by the argument id, in a manner including the value of id, and transmits the multimedia data to the device by calling the method sendRequestMessage( ) provided by the control information communicating unit 6602. Next, by calling the method openRemoteProgram( ) provided by the data receiving unit 6603, an Input Stream object through which the multimedia data can be received is generated. Then, it reads the data through the InputStream, and writes the data in the OutputStream given by the argument cs. When the entire received data is written, the processing ends. With the present method, it is possible to reproduce and store multimedia data by receiving the multimedia data corresponding to a content in the content list obtained by the method getContentList( ) or the method getEPGData( ).

Since the terminals 3905 and 3906 are made up of only constituent elements for reproducing multimedia data from among the constituent elements of the video storing apparatuses 3903 and 3904, the detailed description is omitted.

### Variation of the Fourth Embodiment

Although the fourth embodiment of the present invention is described, it should be obvious that the present invention is not limited to such above-mentioned embodiment. The present invention also includes such cases as described below.

(1) The broadcast receiving apparatus 3902 may further store multimedia data in the second memory 4303, and the selecting unit 5404 of the network library 4505e in the Java library 4505 may select one of the broadcast receiving apparatus 3902 and a video storing apparatus connected to the network 3907. Furthermore, when receiving a request for viewing a TV-program in the Near VoD service from a terminal, the broadcast receiving apparatus 3902 may further check whether or not multimedia data of the content is stored in the video storing apparatus connected to the network 3907 and the storage unit of the broadcast receiving apparatus 3902, and when it is stored in the storage unit of the broadcast receiving apparatus 3902, the multimedia data may be transmitted to a terminal that issues a request for viewing the multimedia data.

(2) Furthermore, it is possible that the broadcast receiving apparatus 3902 performs predetermined encryption on multimedia data and transmits the encrypted multimedia data to the video storing apparatuses 3903 and 3904. Furthermore, it is possible that the video storing apparatuses 3903 and 3904 decrypt the received and encrypted multimedia data, stores the data in the storage unit 4102, and further stores the data by performing predetermined encryption on the multimedia data.

Furthermore, when the broadcast receiving apparatus 3902, and the video storing apparatuses 3903 and 3904 transmit multimedia data to the terminals 3905 and 3906, it is possible that they perform predetermined encryption on the multimedia data, transmit the encrypted multimedia data, decrypt, in the terminals 3905 and 3906, the received and encrypted multimedia data, and reproduce the data.

(3) Furthermore, although the aforementioned embodiment describes an example of an algorithm selected by the selecting unit 5404 of the network library 4505e in the Java library 4505 of the broadcast receiving apparatus 3902, it is obvious that the present invention is not limited to selection of such algorithm. For example, it is possible that the broadcast receiving apparatus 3902 selects video receiving apparatuses in order. Furthermore, it is possible to select them based on a use frequency of a video storing apparatus. Furthermore, it is possible to select a video storing apparatus by checking individual storing frequencies of genres, TV-program names, performers, and the like of multimedia data stored by the user's operation, with the genres, TV-program names, performers of multimedia data, and the like. Furthermore, it is possible to select a video storing apparatus by checking individual storing frequencies of genres, TV-program names, performers, and the like of multimedia data reproduced or outputted by the user's operation, with genres, TV-program names, performers, and the like of multimedia data. Furthermore, it is possible to select a pair of a terminal and a video storing apparatus according to data, for example, selecting the video storing apparatus 3903 for multimedia data having a high frequency to be used in the terminal 3905, and selecting the video storing apparatus 3904 for multimedia data having a high frequency to be used in the terminal 3906.

(4) Furthermore, although the aforementioned embodiment describes that the broadcast receiving apparatus 3902 judges whether or not multimedia data of a content requested for viewing a TV-program in the VoD service is stored by communicating with the video storing apparatuses 3903 and 3904, it is possible that the broadcast receiving apparatus 3902 stores multimedia data stored in the video storing apparatuses 3903 and 3904, and judges whether or not the data is stored based on the content of the stored multimedia data.

(5) Furthermore, in the fourth embodiment, when multimedia data for a TV-program in the Near VoD service that is requested for viewing from a terminal is stored either in the video storing apparatus 3903 or 3904, the broadcast receiving apparatus 3902 issues, to the video storing apparatus that stores the data, a request for transmitting the multimedia data to the terminal that issues the request for viewing the TV-program, and notifies the terminal of information indicating that the multimedia data is to be transmitted from the video storing apparatus. However, it is possible that the broadcast receiving apparatus 3902 performs right processing, such as billing, with the video storing apparatus, notifies the video storing apparatus to the terminal, and issues a request for transmitting the multimedia data from the terminal to the video storing apparatus.

(6) Furthermore, in the fourth embodiment, when multimedia data for a TV-program in the Near VoD service requested from a terminal is stored either in the video storing apparatus 3903 or 3904, the broadcast receiving apparatus 3902 communicates with one of the video storing apparatuses, and performs right processing following the use of the multimedia data, such as billing. However, it is possible that the broadcast receiving apparatus 3902 communicates with the terminal that issues the request for viewing the TV-program, and performs the right processing. Alternatively, it is possible that the broadcast receiving apparatus 3902 performs right processing without communicating with a video storing apparatus or a terminal.

Furthermore, although the right processing following the use of multimedia data, such as billing, is performed when a request for transmitting multimedia data is issued in the present embodiment, it is possible to perform the right processing after the multimedia data is used. Furthermore, it is possible to change the amount to be billed according to the number of times that the multimedia data is used, a use section of the multimedia data, or the like.

(7) Furthermore, although single multimedia data is stored in a video storing apparatus in the fourth embodiment, it is possible to divide the multimedia data and distribute the divided data to plural video storing apparatuses. Alternatively, it is possible to concurrently store single multimedia data in the plural video storing apparatuses. With this, when plural terminals request identical multimedia data, it is possible to distribute loads in which the video storing apparatus transmits video to the terminal.

(8) Furthermore, the broadcast receiving apparatus 3902 further includes a coding unit that creates coded multimedia data, and it is possible that the broadcast receiving apparatus 3902 temporarily decodes multimedia data to be transmitted, newly creates multimedia data using the coding unit, and transmits the created multimedia data. Furthermore, it is possible that the video storing apparatuses 3903 and 3904 further include a decoding unit that decodes multimedia data, and a coding unit that creates coded multimedia data, and it is possible that the decoding unit temporarily decodes the received multimedia data, newly creates multimedia data and stores the created multimedia data, using the coding unit.

(9) Furthermore, although the Near VoD service is used in the fourth embodiment, it is possible to obtain the same advantage for rebroadcasting by storing a normal TV-program in advance.

(10) It is possible that a part or all of the constituent elements making up each of the above-mentioned apparatuses is made from one system LSI (Large Scale Integration circuit). The system LSI is a super multi-function LSI that is manufactured by integrating plural elements in one chip, and is specifically a computer system which is configured by including a microprocessor, a ROM, a RAM, and so on. A computer program is stored in the RAM. The system LSI accomplishes its functions through the operation of the microprocessor in accordance with the computer program.

(11) It is possible that a part or all of the constituent elements making up each of the above-mentioned apparatuses is made from an IC card that can be attached to/detached from each apparatus, or a stand-alone module. The IC card or the module is a computer system made from a microprocessor, a ROM, a RAM, and so on. The IC card or the module may include the super multi-function LSI. The IC card or the module accomplishes its functions through the operation of the microprocessor in accordance with the computer program. The IC card or the module may also be tamper-resistant.

(12) The broadcast receiving apparatus and the video storing apparatus according to the present invention may operate in the aforementioned methods. Furthermore, the present invention may also be a computer program for executing such methods through a computer, or as a digital signal made from the computer program.

Furthermore, the broadcast receiving apparatus and the video storing apparatus of the present invention may be a computer-readable recording medium, such as a flexible disk, a hard disk, a CD-ROM, an MO, a DVD, a DVD-ROM, a DVD-RAM, a Blu-ray Disc (BD), or a semiconductor memory, on which the computer program or the digital signal is recorded. Furthermore, the broadcast receiving apparatus and the video storing apparatus of the present invention may also be the computer program or the digital signal recorded on such recording media.

Furthermore, the broadcast receiving apparatus and the video storing apparatus of the present invention may transmit the computer program or the digital signal via an electrical communication line, a wireless or wired communication line, a network represented by the Internet, a data broadcast, and so on.

Furthermore, the broadcast receiving apparatus and the video storing apparatus of the present invention compose a computer system including a microprocessor and a memory, with the memory storing the computer program and the microprocessor operating in accordance with the computer program.

Furthermore, the present invention may also be implemented in another independent computer system by recording the program or the digital signal on the recording medium and transferring the recording medium, or by transferring the program or the digital signal via the network, and the like.

(13) It is also possible to combine the above-described embodiment and the aforementioned variation.

### INDUSTRIAL APPLICABILITY

The multimedia delivering system, the broadcast receiving apparatus, the video storing apparatus, and the reception terminal according to the present invention solves a problem of shortage of tuners when viewing a TV-program provided from a VoD, Near VoD service, and the like, by appropriately distributing and storing, in advance, the multimedia data of the TV-program to the broadcast receiving apparatus, the video storing apparatus, and the reception terminal, in an environment in which a request for viewing different TV-programs issued concurrently from plural terminals using a home network. Furthermore, the present invention is useful as a method to be implemented in: the broadcast receiving apparatus that receives a broadcast from a Near VoD service or a service closer to the Near VoD service, such as a cable television; the video storing apparatus; and the reception terminal, since the method can produce advantageous effects that enable: reducing cost by reducing necessary storage space for storing data in each of the broadcast receiving apparatus, the video storing apparatus, and the reception terminal; and distributing loads of the broadcast receiving apparatus and the video storing apparatus for delivering video to the reception terminal.

Furthermore, in an environment in which a request for delivering data of multimedia contents according to a request of the user, such as a VoD service can be concurrently issued from plural terminals using a home network, the multimedia delivering system, the broadcast receiving apparatus, and the video storing apparatus according to the present invention can produce the following advantageous effects of: reducing bandwidth consumption required at one time by appropriately distributing and storing, in advance, the multimedia data to the broadcast receiving apparatus and the video storing apparatus and by allocating the bandwidth consumption for transferring the multimedia data between the broadcast receiving apparatus and a broadcast station; reducing cost by reducing necessary storage space for storing data in the broadcast receiving apparatus and the video storing apparatus; and distributing loads of the broadcast station, the broadcast receiving apparatus and the video storing apparatus when using the VoD service. Thus, the present invention is useful as an apparatus for receiving a service that provides an on-demand service, such as cable television, and as an apparatus and a method for storing multimedia data.

1. A broadcast receiving apparatus that is connected to a network and that receives multimedia data from a device installed in a broadcast station, the multimedia data including at least one of video and audio, said broadcast receiving apparatus comprising:
a data receiving unit operable to receive the multimedia data from the device installed in the broadcast station;
an information communicating unit operable to communicate, via the network, with plural video storing apparatuses each of which stores multimedia data;
a selecting unit operable to select one of the video storing apparatuses; and
a data output unit operable to output, via the network, the multimedia data received by said data receiving unit,
wherein said information communicating unit is operable to transmit, to the video storing apparatus selected by said selecting unit, a request for storing the multimedia data, and
said data output unit is operable to output, to the video storing apparatus selected by said selecting unit, the multimedia data received by said data receiving unit.

2. The broadcast receiving apparatus according to claim 1,
wherein said selecting unit is operable to select the video storing apparatus based on attributes of the multimedia data.

3. The broadcast receiving apparatus according to claim 2,
wherein said selecting unit is operable to select the video storing apparatus based on a genre of a content of the multimedia data.

4. The broadcast receiving apparatus according to claim 1,
wherein said information communicating unit is further operable to receive attributes of the video storing apparatus connected to the network, and
said selecting unit is operable to select the video storing apparatus based on the attributes of the video storing apparatus received by said information communicating unit.

5. The broadcast receiving apparatus according to claim 4,
wherein said information communicating unit is further operable to receive use frequency information indicating a frequency with which the video storing apparatus connected to the network is used, and
said selecting unit is operable to select the video storing apparatus based on the use frequency information received by said information communicating unit.

6. The broadcast receiving apparatus according to claim 1,
wherein said information communicating unit is further operable to receive attributes of the video storing apparatus connected to the network, and
said selecting unit is operable to select the video storing apparatus based on attributes of the multimedia data and the attributes of the video storing apparatus received by said information communicating unit.

7. The broadcast receiving apparatus according to claim 6,
wherein said information communicating unit is operable to receive use frequency information indicating a frequency: with which the video storing apparatus connected to the network is used; and for each genre of a content of the multimedia data that has been used, and
said selecting unit is operable to select the video storing apparatus based on the genre of the content of the multimedia data and the use frequency information.

8. The broadcast receiving apparatus according to claim 1, further comprising:
a storage unit operable to store multimedia data; and
a writing unit operable to write data in said storage unit,
wherein said selecting unit is operable to select one of said storage unit and the plural video storing apparatuses connected to the network, and
said writing unit is operable to write the multimedia data in said storage unit, when said selecting unit selects said storage unit.

9. The broadcast receiving apparatus according to claim 1, further comprising
a request transmitting unit operable to transmit, to the device installed in the broadcast station, a request for transmitting multimedia data,
wherein said data receiving unit is operable to receive the multimedia data requested by said request transmitting unit.

10. The broadcast receiving apparatus according to claim 1, further comprising
a TV-program selecting unit operable to select a particular TV-program from among TV-programs to be broadcasted,
wherein said data receiving unit is operable to receive multimedia data of the TV-program selected by said TV-program selecting unit.

11. The broadcast receiving apparatus according to claim 1, further comprising
a Java execution unit operable to execute a Java (trademark) application program,
wherein said data receiving unit is operable to accept an identifier of the multimedia data from the Java application program executed by said Java execution unit, and to receive the multimedia data indicated by the accepted identifier, and
said selecting unit is operable to select the video storing apparatus, upon accepting the identifier of the multimedia data from the Java application program executed by said Java execution unit.

12. The broadcast receiving apparatus according to claim 11,
wherein said selecting unit is operable to select the video storing apparatus based on attributes of the multimedia data.

13. The broadcast receiving apparatus according to claim 11,
said information communicating unit is further operable to receive attributes of the video storing apparatus connected to the network, and
said selecting unit is operable to select the video storing apparatus based on the attributes of the video storing apparatus received by said information communicating unit.

14. The broadcast receiving apparatus according to claim 11,
said information communicating unit is further operable to receive attributes of the video storing apparatus connected to the network, and
said selecting unit is operable to select the video storing apparatus based on attributes of the multimedia data and the attributes of the video storing apparatus received by said information communicating unit.

15. The broadcast receiving apparatus according to claim 11, further comprising:
a storage unit operable to store multimedia data; and
a writing unit operable to write data in said storage unit,
wherein said selecting unit is operable to select one of said storage unit and the plural video storing apparatuses connected to the network, and
said writing unit is operable to write the multimedia data in said storage unit, when said selecting unit selects said storage unit.

16. The broadcast receiving apparatus according to claim 11, further comprising
a request transmitting unit operable to accept an identifier of the multimedia data from the Java application program executed by said Java execution unit, and
to transmit, to the broadcast station, a request for transmitting the multimedia data indicated by the identifier,
wherein said data receiving unit is operable to receive the multimedia data requested by said request transmitting unit.

17. The broadcast receiving apparatus according to claim 11, further comprising
a TV-program selecting unit operable to select a particular TV-program from among TV-programs to be broadcasted,
wherein said TV-program selecting unit is operable to pass the identifier of the multimedia data to the Java application program according to a request of the Java application program, the multimedia data corresponding to the selected TV-program, and the Java application program being executed by said Java execution unit.

18. A broadcast receiving method to be implemented in a broadcast receiving apparatus that is connected to a network and that receives multimedia data from a device installed in a broadcast station, the multimedia data including at least one of video and audio, said method comprising:
a data receiving step of receiving the multimedia data from the device installed in the broadcast station;
an information communicating step of communicating, via the network, with plural video storing apparatuses each of which stores multimedia data;
a selecting step of selecting one of the video storing apparatuses; and
a data output step of outputting, via the network, the multimedia data received in said data receiving step,
wherein said information communicating step includes transmitting a request for storing the multimedia data to the video storing apparatus selected in said selecting step, and
said data output step includes outputting, to the video storing apparatus selected in said selecting step, the multimedia data received in said data receiving step.

19. A video storing apparatus which is connected, via a network, to a broadcast receiving apparatus that receives multimedia data from a broadcast station, and which stores the multimedia data, the multimedia data including at least one of video and audio, said video storing apparatus comprising:
a Java execution unit operable to execute a Java application program;
a storage unit operable to store the multimedia data;
an information communicating unit operable to communicate with the broadcast receiving apparatus connected via the network;
a data receiving unit operable to receive the multimedia data from the broadcast receiving apparatus via the network; and
a data transmitting unit operable to transmit, via the network, the multimedia data stored in said storage unit;
wherein said information communicating unit is operable to transmit, to the broadcast receiving apparatus, attribute information indicating attributes of the video storing apparatus, when address information for communicating with the broadcast receiving apparatus is passed from the Java application program and said information communicating unit receives an inquiry of the attributes from the broadcast receiving apparatus,
said data receiving unit is operable to receive the multimedia data from the broadcast receiving apparatus and store the received multimedia data in said storage unit, when the address information for communicating with the broadcast receiving apparatus is passed from the Java application program, and said information communicating unit receives, from the broadcast receiving apparatus, a request for storing the multimedia data, and
said data transmitting unit is operable to transmit the multimedia data to a device indicated by information, when the address information for communicating with the broadcast receiving apparatus is passed from the Java application program, and said information communicating unit receives, from the broadcast receiving apparatus, the information and a request for transmitting the multimedia data stored in said storage unit, the information indicating the device connected to the network, and the device being a transmission destination to which the multimedia data is to be transmitted.

20. The video storing apparatus according to claim 19, further comprising
a right processing unit operable to perform right processing following use of the multimedia data, when said information communicating unit receives a request for transmitting the multimedia data.

21. A data processing method to be implemented in a video storing apparatus: which is connected, via a network, to a broadcast receiving apparatus that receives multimedia data from a broadcast station; and which includes a Java execution unit that executes a Java application program, and a storage unit that stores the multimedia data, the multimedia data including at least one of video and audio, said data processing method comprising:
an information communicating step of communicating with the broadcast receiving apparatus connected via the network;
a data receiving step of receiving the multimedia data from the broadcast receiving apparatus via the network; and
a data transmitting step of transmitting, via the network, the multimedia data stored in the storage unit,
wherein said information communicating step includes transmitting, to the broadcast receiving apparatus, attribute information indicating attributes of the video storing apparatus, when address information for communicating with the broadcast receiving apparatus is passed from the Java application program, and an inquiry of the attributes is received from the broadcast receiving apparatus,
said data receiving step includes receiving the multimedia data from the broadcast receiving apparatus and storing the received multimedia data in the storage unit, when the address information for communicating with the broadcast receiving apparatus is passed from the Java application program, and a request for storing the multimedia data is received from the broadcast receiving apparatus, and
said data transmitting step includes transmitting the multimedia data to a device indicated by information, when the address information for communicating with the broadcast receiving apparatus is passed from the Java application program, and the information and a request for transmitting the multimedia data stored in the storage step is received from the broadcast receiving apparatus, the information indicating the device connected to the network, and the device being a transmission destination to which the multimedia data is to be transmitted.

22. The broadcast receiving apparatus according to claim 1, wherein said broadcast receiving apparatus is connected to the network, and receives the multimedia data from the device installed in the broadcast station, the broadcast station providing a Video On Demand (VoD) service, said apparatus further comprising:
a request transmitting unit operable to transmit, to the device installed in the broadcast station, a request for transmitting multimedia data; and an information communicating unit operable to communicate with the video storing apparatus that stores the multimedia data, via the network,
when said information communicating unit receives a request of the VoD service from a terminal operated by a user, said information communicating unit is operable to obtain information indicating whether or not the video storing apparatus stores multimedia data requested in the VoD service by communicating with the video storing apparatus via the network, and when said information communicating unit obtains the information indicating that the video storing apparatus stores the multimedia data, said information communicating unit is operable to transmit, to the video storing apparatus that has transmitted the information, a request for transmitting the multimedia data requested in the VoD service to the terminal operated by the user, and
when said information communicating unit obtains the information indicating that the video storing apparatus does not store the multimedia data, said request transmitting unit is operable: to transmit, to the device installed in the broadcast station, a request for transmitting the multimedia data requested in the VoD service; to receive the multimedia data requested in the VoD service; and to transmit, to the terminal operated by the user, the received multimedia data requested in the VoD service.

23. The broadcast receiving apparatus according to claim 22, further comprising
a right processing unit operable to perform right processing following use of the multimedia data, when said request transmitting unit transmits a request for transmitting the multimedia data stored in the video storing apparatus.

24. The broadcast receiving apparatus according to claim 22, further comprising:
a Java execution unit operable to execute a Java application program,
wherein said information communicating unit is operable to obtain the information indicating whether or not the video storing apparatus stores the multimedia data requested in the VoD service by communicating with the video storing apparatus via the network, when said information communicating unit accepts an identifier of the multimedia data from the Java application program executed by said Java execution unit.

25. The broadcast receiving apparatus according to claim 24, further comprising
a right processing unit operable to perform right processing following use of the multimedia data, when said request transmitting unit transmits a request for transmitting the multimedia data stored in the video storing apparatus.

26. A multimedia delivering system comprising a broadcast receiving apparatus and a video storing apparatus, in which said broadcast receiving apparatus is connected to said video storing apparatus via a network, said broadcast receiving apparatus receiving multimedia data from a device installed in a broadcast station, the multimedia data including at least one of video and audio, and said video storing apparatus storing the multimedia data,
wherein said broadcast receiving apparatus includes: a data receiving unit operable to receive the multimedia data from the device installed in the broadcast station;
an information communicating unit operable to communicate, via the network, with plural video storing apparatuses each of which stores multimedia data;
a selecting unit operable to select one of the video storing apparatuses; and
a data output unit operable to output, via the network, the multimedia data received by said data receiving unit,
said information communicating unit is operable to transmit, to the video storing apparatus selected by said selecting unit, a request for storing the multimedia data,
said data output unit is operable to output, to the video storing apparatus selected by said selecting unit, the multimedia data received by said data receiving unit,
said video storing apparatus includes:
a Java execution unit operable to execute a Java application program;
a storage unit operable to store the multimedia data;
an information communicating unit operable to communicate with the broadcast receiving apparatus connected via the network;
a data receiving unit operable to receive the multimedia data from the broadcast receiving apparatus via the network;
a data transmitting unit operable to transmit, via the network, the multimedia data stored in said storage unit;
said information communicating unit is operable to transmit, to the broadcast receiving apparatus, attribute information indicating attributes of the video storing apparatus, when address information for communicating with the broadcast receiving apparatus is passed from the Java application program and said information communicating unit receives an inquiry of the attributes from the broadcast receiving apparatus,
said data receiving unit is operable to receive the multimedia data from the broadcast receiving apparatus and store the received multimedia data in said storage unit, when the address information for communicating with the broadcast receiving apparatus is passed from the Java application program, and said information communicating unit receives, from the broadcast receiving apparatus, a request for storing the multimedia data, and
said data transmitting unit operable to transmit the multimedia data to a device indicated by information, when the address information for communicating with the broadcast receiving apparatus is passed from the Java application program, and said information communicating unit receives, from the broadcast receiving apparatus, the information and a request for transmitting the multimedia data stored in said storage unit, the information indicating the device connected to the network, and the device being a transmission destination to which the multimedia data is transmitted.
